(19) United States
(12) Patent Application Publication
(10) Pub. No.: US 2013/0339219 A1
(43) Pub. Date: Dec. 19, 2013

(54) Interactive Finance And Asset Management System

(71) Applicants: Nicole Hamilton Bernheimer, Brooklyn, NY (US); Ronald Flack Raymond, New York,, NY (US)

(72) Inventors: Nicole Hamilton Bernheimer, Brooklyn, NY (US); Ronald Flack Raymond, New York,, NY (US)

(73) Assignee: FEEL MY MONEY, LLC, New York, NY (US)

(21) Appl. No.: 13/918,867

(22) Filed: Jun. 14, 2013

Related U.S. Application Data
(60) Provisional application No. 61/660,150, filed on Jun. 15, 2012.

(51) Int. Cl. G06Q 40/02

(52) U.S. Cl. CPC G06Q 40/025
USPC 705/38

(57) ABSTRACT

A computer implemented method and system provides an asset management application (AMP) for monitoring and managing assets, and interactable interface elements on a graphical user interface (GUI) for enabling configuration and access of asset information and computations on the GUI. The AMP receives inputs associated with an asset, for example, an adjustable or a fixed rate loan on the asset. The AMP determines one or more financial components of expenditure and financial outcomes of a sale of an asset over a configurable duration of time based on the received inputs and/or the user's and/or the asset's geographical location. The AMP dynamically renders one or more interactive graphical models of the financial components of expenditure and the financial outcomes that are configurably accessible and modifiable on the GUI using the interactable interface elements. The AMP facilitates communication of the interactive graphical models and updates thereof between users and financial entities.

### CROSS REFERENCE TO RELATED APPLICATIONS

This application claims the benefit of provisional patent application No. 61/660,150 titled “Interactive Finance Management System”, filed on Jun. 15, 2012 in the United States Patent and Trademark Office.

The specification of the above referenced patent application is incorporated herein by reference in its entirety.

### BACKGROUND

Many financial decisions require tax and interest considerations that can be particularly challenging to understand and yet can have a large impact on financial decisions. The recession and subprime crisis during the past few years have shed a light on risks associated with overextending mortgages and credit card debt, and the difficulty in selling property or getting out of debt. The recession has put a focus on frugality and living within one's means either through necessity or through awareness of the risks of market instability. This has led to an awareness of setting day to day spending limits, managing cash flows regularly, estimating major life expenses, forecasting retirement needs, and running updated checks for avoiding a cascade effect that results in a cash crunch.

In recent years, many consumers have taken out loans that they cannot understand and cannot afford. Many consumers find it difficult to understand the financial aspects related to a loan, for example, amortization for a mortgage loan, that is, the way that principal and interest work, the way an adjustable rate mortgage changes over the period of the loan, etc. Moreover, many other financial aspects of loans are ambiguous and misinterpreted by consumers.

Furthermore, loan quotes obtained by consumers at the time of a loan application are difficult for consumers to understand. There are many elements associated with a loan quotation, for example, points and fees that consumers wish to understand. However, conventional finance management platforms lack a method for simplifying the concepts to allow consumers to understand them. Furthermore, financial entities have to spend a lot of time explaining and comparing financial loan elements, terms, scenarios, etc., to consumers. It is a lengthy process for both financial entities as well as consumers to understand the complexities of a loan transaction and perform comparisons related to financial loan elements, terms, and scenarios. Moreover, some financial entities use challenging financial aspects to confuse consumers for their benefit.

Conventional finance management platforms host financial data centrally on a network in a secured, privacy protected space. However, these finance management platforms do not organize, segregate, and represent the financial data in a manner that can be understood by consumers to allow consumers to compare financial data, for example, loan options and details, other financial products and terms, etc., over time. Moreover, the conventional finance management platforms do not categorize the financial data based on factors such as geographical location to allow consumers to estimate financial expenditure for different geographical locations and make associated financial decisions. Furthermore, conventional finance management platforms generally perform financial calculations over a fixed duration of time irrespective of specific consumer requirements, and perform calculations for a time frame that cannot be configured by a consumer. These finance management platforms also cannot compare financial options and quotes over time and represent the results of the calculations in an understandable manner. There is a need for enabling consumers to perform a comparative analysis to make effective financial decisions and determine the selling price of an asset at a user selected point in time.

Hence, there is a long felt but unresolved need for a computer implemented method and system that monitors and manages a user's assets and enables the user to visualize, understand, and compare different financial components of expenditure incurred or to be incurred over a configurable duration of time, thereby providing transparency and financial understanding for the user's critical financial decisions in financial budgets, loans, plans, and investments. Moreover, there is a need for an asset management application that determines financial components of expenditure over a configurable duration of time, determines an estimate of a selling price of an asset at a configurable point in time selected by the user, renders the determined financial components and estimates as interactive graphical models that can be easily interpreted and used by the user for comparison, and enables effective communication between the users and financial entities to allow the users to be well informed and to allow the financial entities to provide improved services and to complete a transaction.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The computer implemented method and system disclosed herein address the above stated needs for monitoring and managing a user's assets and for enabling the user to visualize, understand, and compare different financial components of expenditure incurred or to be incurred over a configurable duration of time, thereby providing transparency and financial understanding for the user's critical financial decisions in financial budgets, loans, plans, and investments. As used herein, the term “user” refers to an individual or an entity that manages finances and makes financial decisions. The user is, for example, an individual who requires a financial loan, a property buyer who requires or who has purchased a property asset under a mortgage loan, a student who requires or who has taken a student loan, etc. Also, as used herein, the term “financial loan” refers to an arrangement where a lender lends money or property to a borrower, and the borrower agrees to repay the money or return the property, along with an interest, at a predetermined future point in time. Examples of a financial loan are a mortgage loan, an educational loan such as a student loan, an automobile loan, a business loan, etc., and any other type of loan. Also, as used herein, the term “asset” refers to an economic resource capable of being owned or controlled to produce positive economic value. Examples of an asset are land, property, a building, machinery, real estate, a financial investment, precious metal, etc.

The computer implemented method and system disclosed herein also address the above stated needs for determining financial components of expenditure over a configurable duration of time, determining an estimate of a selling price of an asset at a configurable point in time selected by the user, rendering the determined financial components and estimates as interactive graphical models that can be easily interpreted and used by the user for comparison, and enabling effective communication between the users and financial entities to allow the users to be well informed and to allow the financial entities to provide improved services and to complete a transaction. As used herein, the term “financial entities” refers to individuals or financial institutions that provide financial services and are involved in financial transactions with users. The financial entities are, for example, banks, mortgage loan companies, investment firms, credit unions, insurance agencies, brokerages, etc., financial professionals such as bankers, lenders, financial advisors, insurance agents, etc. Also, as used herein, the term “financial components of expenditure” refers to computed values of a user's expenditure derived from inputs associated with an asset, financial information, asset information, etc., received from the user. The financial components of expenditure comprise, for example, an amount of loan required, a monthly loan payment, a payment over a configurable duration of time, an amount of asset tax, an amount of an interest rate deduction for a loan, an amount of tax deduction from tax deductible housing cooperative fees, an amount of equity available to the user at a point in the configurable duration of time, an amount of the equity spent by the user at a point in the configurable duration of time, a break-even point, an amount of income needed at a configurable stage in the configurable duration of time to enable the user to repay the loan within a term of the loan, a fixed rate loan payment over the term of the loan, an adjustable rate loan payment over the term of the loan, loans available in different geographical locations, time of refinancing of the loan, etc. As used herein, the term “configurable duration of time” refers to time instants, time periods, or points in time that can be configured by a user on a graphical user interface (GUI). The configurable duration of time comprises, for example, a user selected date and time range, a day, a month, a year, a period of days, a period of weeks, a period of months, a period of years, etc. Also, as used herein the term, “configurable stage” in the configurable duration of time refers to any time instant, for example, a day, a month, a year, etc., in the configurable duration of time that can be selected and modified by a user for determining a corresponding estimate. For example, if a user wants to determine an estimate of income required to be able to pay off a loan at a particular time instant within a year, the user may select a day or a month within that year on the GUI and view the corresponding estimate.

The computer implemented method and system for monitoring and managing a user's assets provides an asset management application executable by at least one processor configured to monitor and manage the user's assets. The asset management application is accessible by a user device, for example, a personal computer, a laptop, a tablet computing device, a mobile phone, a personal digital assistant, etc., via a graphical user interface (GUI) provided by the asset management application. In an embodiment, the asset management application is implemented on a web based platform accessible by the user device via a network, for example, the internet. In another embodiment, the asset management application is configured as a software application, for example, a mobile application downloadable on a user device, for example, a mobile phone, a tablet computing device, etc. The asset management application provides multiple interactable interface elements on the GUI for enabling configuration and access of asset information and computations on the GUI via the user device. As used herein, the term “interactable interface elements” refers to design paradigms or interface components on the GUI configured to perform a combination of processes, for example, a data retrieval process from the financial information received from the user, processes that transform retrieved data into visual entities, for example, interactive graphical models of the financial components of expenditure on the GUI, processes that enable real time user interactions with the interactive graphical models, etc. The interactable interface elements comprise, for example, clickable or draggable slider elements such as a slider wheel icon, a slider window, floating windows, etc. As used herein, the term “interactive graphical model” refers to an interactive amortization graph that visually represents inputs associated with an asset, financial information, asset information, etc., received by the asset management application and one or more of the financial components of expenditure determined by the asset management application over a configurable duration of time. The asset management application also monitors and manages the user's personal finances. As used herein, the term “personal finances” refers to finances that involve monetary decisions of an individual or a family based on financial requirements. A user's personal finances comprise, for example, mortgages on property, loans on education, etc.

The asset management application receives inputs associated with one or more assets from the user device via the GUI. In an embodiment, the inputs comprise, for example, provisions of an adjustable rate loan on the asset or a fixed rate loan on the asset. The inputs associated with the asset further comprise, for example, a selection of a fixed rate loan or an adjustable rate loan, parameters defining a term of the loan such as a loan start date and a loan end date, a price of the asset, a down payment, a term of the fixed rate loan or the adjustable rate loan, an interest rate for the fixed rate loan or the adjustable rate loan, an amount of asset tax, a tax bracket, state of the asset, city of the asset, county of the asset, fees of the asset, condominium (condo) fees of a property asset or a housing cooperative (coop) fees of the property asset, tax information, prospective financial parameters, etc. As used herein, the term “prospective financial parameters” refers to prospective financial information, for example, a prospective time instant selected by a user on the GUI to allow the user to understand what would happen to his/her finances at that time instant or how much the user would earn or receive at that time instant.

The asset management application determines one or more of multiple financial components of expenditure over a configurable duration of time based on one or more of the received inputs associated with the asset and/or a geographical location of the asset and/or the user. The asset management application dynamically renders one or more interactive graphical models of the determined financial components of expenditure to the user device, for example, via the GUI. The dynamically rendered interactive graphical models of the determined financial components of expenditure are configurably accessible and modifiable on the GUI by the user via the user device using one or more of the interactable interface elements. The asset management application receives at least one input on the dynamically rendered interactive graphical models of the determined financial components of expenditure from the user device via the GUI and dynamically updates the determined financial components of expenditure based on the received input. In an embodiment, the asset management application tracks changes made to the inputs associated with the asset on the GUI by the user via the user device over the configurable duration of time. In this embodiment, the asset management application then redetermines the financial components of expenditure based on the tracked changes. In this embodiment, the asset management application then dynamically updates the tracked changes and the redetermined financial components of expenditure to the dynamically rendered interactive graphical models.

The asset management application receives loan quotes received by the user from one or more external sources via the GUI. In an embodiment, the asset management application lists the available loan quotes and contact information of the external sources on the GUI. The user selects one or more of the received loan quotes on the GUI. The asset management application receives selections of one or more of the received loan quotes from the user device via the GUI. The asset management application determines one or more of the financial components of expenditure for the received loan quotes based on the received selections. The asset management application dynamically renders an interactive graphical model of each of the determined financial components of expenditure for each of the received loan quotes for performing a comparative analysis of the determined financial components of expenditure for the received loan quotes. The asset management application performs a comparative analysis of associated financial components of expenditure over the configurable duration of time using the dynamically rendered interactive graphical models of the associated financial components of expenditure and dynamically renders a comparative analytical report based on the comparative analysis.

The asset management application determines an estimate amount for selling an asset, for example, a property asset at a configurable point in time selected by the user via the user device using one or more of the interactable interface elements positioned on the dynamically rendered interactive graphical models of the determined financial components of expenditure. The interactable interface elements positioned on associated dynamically rendered interactive graphical models of the determined financial components of expenditure simultaneously displace over the configurable duration of time on the GUI for performing a comparative analysis of the determined financial components of expenditure. In an embodiment, the asset management application categorizes the determined financial components of expenditure, for example, based on the geographical location.

In an embodiment, the asset management application toggles display of the dynamically rendered interactive graphical models of the determined financial components of expenditure on the GUI based on a selectable index associated with each of the determined financial components of expenditure. As used herein, the term “selectable index” refers to an indicator of financial information or asset information represented by an interface element, for example, a checkbox on the GUI to allow the user to view different graphical models based on a selection of a piece of financial information or asset information and compare the associated financial components of expenditure. For example, the selectable index is a loan interest rate index for a fixed rate loan and an adjustable rate loan or an index associated with current and refinanced loans.

The asset management application stores user information, advisory information, the received inputs associated with the asset, the determined financial components of expenditure, and the dynamically rendered interactive graphical models of the determined financial components of expenditure in a database. The asset management application also facilitates retrieval of the stored user information, advisory information, the received inputs associated with the asset, the determined financial components of expenditure, and the dynamically rendered interactive graphical models of the determined financial components of expenditure from the database.

In an embodiment, the asset management application facilitates communication of one or more financial scenarios, for example, loan offers for loan products, the interactive graphical models, etc., also facilitating manipulation of the communicated interactive graphical models, etc., between the user and one or more financial entities and/or other users via a network, for example, the internet. The asset management application transmits one or more notifications on asset information and supplementary financial information to the user device via the GUI and/or a network. The asset information comprises information associated with an asset such as a property, for example, local issues such as zoning or community board information, etc., that may affect property value, assets on sale in a particular geographical location, market rate trends, appreciation and depreciation respective to the asset, predictions for asset prices, newly available rates, cost of refinancing, duration of return on investments, etc. Also, as used herein, the term “supplementary financial information” refers to relevant information used to enhance a user's understanding of the financial components of expenditure, to enable a user to perform a comparative analysis of the financial components of expenditure over a configurable duration of time, etc. The supplementary financial information comprises, for example, informative articles explaining basic concepts of a loan, amortization, equity, discount points, interest rates, etc.

In an embodiment, the asset management application generates alerts based on events associated with the received inputs associated with the asset, the determined financial components of expenditure, and the dynamically rendered interactive graphical models of the determined financial components of expenditure stored in the database. The asset management application also transmits the generated alerts to the user device via the GUI and/or a network.

Disclosed herein are also a computer implemented method and system for monitoring and managing a user's asset with respect to financial outcomes of a sale of the user's asset. As used herein, the term “financial outcomes of a sale” refers to computations associated with the sale of an asset, for example, closing costs, amount gained by a user on selling his/her asset, etc. In this computer implemented method, after the asset management application receives inputs associated with an asset from the user device via the GUI, the asset management application determines one or more financial outcomes of a sale of the asset at a configurable point in time based on one or more of the received inputs associated with the asset and/or a geographical location of the asset. The asset management application dynamically renders one or more interactive graphical models of the determined financial outcomes of the sale of the asset. The dynamically rendered interactive graphical models of the determined financial outcomes of the sale of the asset are configurably accessible and modifiable on the GUI via the user device using one or more of the interactable interface elements. The asset management application receives at least one input on the dynamically rendered interactive graphical models of the determined financial outcomes of the sale of the asset from the user device via the GUI. The asset management application dynamically updates the determined financial outcomes of the sale of the asset based on the received input.

Disclosed herein are also a computer implemented method and a system for monitoring and managing a user's assets by facilitating communication of the interactive graphical models between users and financial entities. In this computer implemented method, after rendering of the interactive graphical models of the determined financial components of expenditure to the user device, for example, via the GUI, the asset management application facilitates communication of the dynamically rendered interactive graphical models of the determined financial components of expenditure and updates thereof between the user and one or more financial entities and/or other users via a network, for example, the internet.

The computer implemented method and system disclosed herein therefore provides a visualization of how much money a user has, what the user can afford, and the cause and effect on the user's money in financial budget, investment and spending decisions. The computer implemented method and system disclosed herein enables the user to view, for example, mortgages over time, amortization, equity, etc., and compare them over time, particularly with different types of loans, for example, adjustable rate mortgage loans, fixed rate mortgage loans, etc., and understand loans.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1A illustrates a computer implemented method for monitoring and managing a user's assets.

FIG. 1B illustrates an embodiment of the computer implemented method for monitoring and managing a user's assets.

FIG. 1C illustrates another embodiment of the computer implemented method for monitoring and managing a user's assets.

FIG. 2 exemplarily illustrates a computer implemented system for monitoring and managing a user's assets.

FIG. 3 exemplarily illustrates the architecture of a computer system employed by an asset management application for monitoring and managing a user's assets.

FIG. 4 exemplarily illustrates a screenshot of a graphical user interface provided by the asset management application, displaying a home page of the asset management application.

FIG. 5A exemplarily illustrates a screenshot of a graphical user interface provided by the asset management application for receiving inputs associated with an asset from a user to determine financial components of expenditure.

FIG. 5B exemplarily illustrates a screenshot of a graphical user interface provided by the asset management application, showing an interactive graphical model of a financial component of expenditure.

FIGS. 6A-6B exemplarily illustrate screenshots of a graphical user interface provided by the asset management application, showing tracking and updating of changes made to the received inputs associated with an asset to the interactive graphical model shown in FIG. 5B.

FIGS. 7A-7B exemplarily illustrate screenshots of a graphical user interface provided by the asset management application, displaying interactable interface elements enabling a user to view selling price of an asset at a configurable point in time.

FIG. 8 exemplarily illustrates a screenshot of a graphical user interface provided by the asset management application for enabling a user to save a financial scenario associated with a loan process.

FIG. 9 exemplarily illustrates a screenshot of a graphical user interface provided by the asset management application, displaying asset information saved by a user.

FIGS. 10A-10C exemplarily illustrate screenshots of a graphical user interface provided by the asset management application, displaying interactable interface elements enabling a user to graphically toggle between dynamically rendered interactive graphical models of financial components of expenditure.

FIGS. 11A-11H exemplarily illustrate screenshots of a graphical user interface provided by the asset management application for performing a comparative analysis of one or more financial components of expenditure for monitoring and managing a user's assets.

FIG. 12 exemplarily illustrates a screenshot of a graphical user interface provided by the asset management application, displaying a flow chart of a mortgage process for enhancing a user's understanding.

FIG. 13 exemplarily illustrates a screenshot of a graphical user interface provided by the asset management application for monitoring a user's assets.

FIGS. 14A-14B exemplarily illustrate screenshots of a graphical user interface provided by the asset management application, displaying interactable interface elements that enable a user to graphically visualize financial components of expenditure determined by the asset management application for a particular mortgage value.

### DETAILED DESCRIPTION OF THE INVENTION

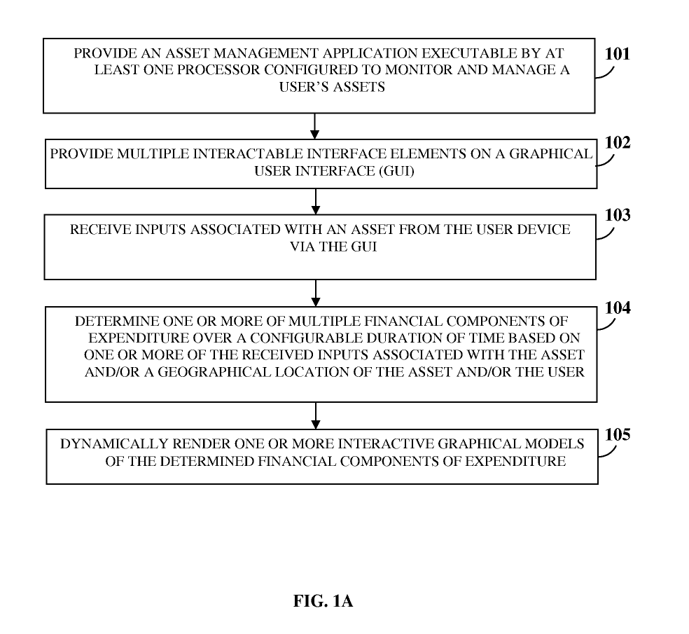

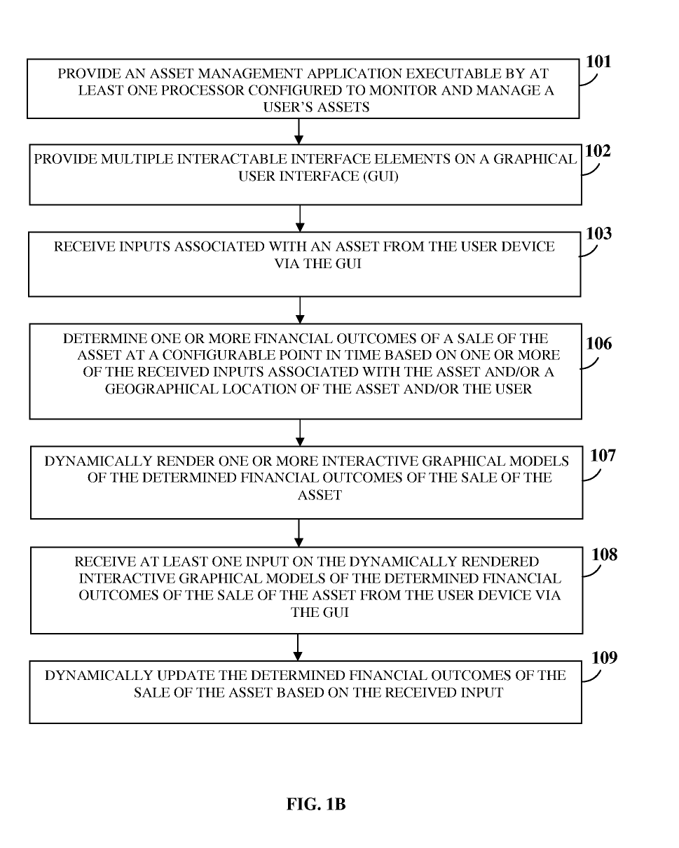

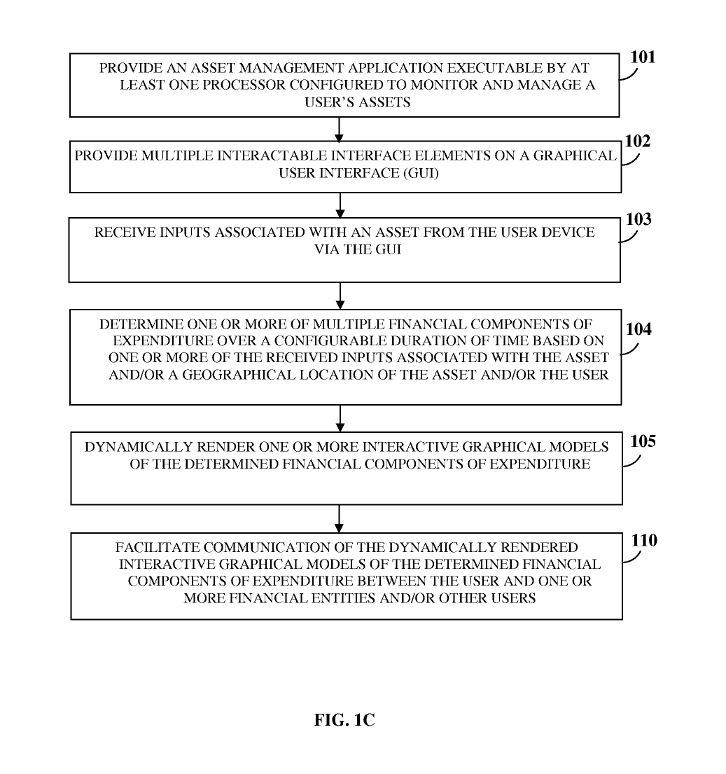

FIG. 1A illustrates a computer implemented method for monitoring and managing a user's assets. As used herein, the term “user” refers to an individual or an entity that manages finances and makes financial decisions. The user is, for example, an individual who requires a financial loan, a property buyer who requires or who has taken out a mortgage loan for purchasing a property, a student who requires or who has taken out a student loan, etc. Also, as used herein, the term “financial loan” refers to an arrangement where a lender lends money or property to a borrower, and the borrower agrees to repay the money or return the property, along with an interest, at a predetermined future point in time. Examples of a financial loan are a mortgage loan, an educational loan also referred to as a student loan, an automobile loan, a business loan, etc., and any other type of loan. Also, as used herein, the term “asset” refers to an economic resource capable of being owned or controlled to produce positive economic value. Examples of an asset are land, property, a building, machinery, real estate, a financial investment, precious metal, etc. The computer implemented method disclosed herein also monitors and manages the user's personal finances. As used herein, the term “personal finances” refers to finances that involve monetary decisions of an individual or a family based on financial requirements. A user's personal finances comprise, for example, mortgages on property, loans on education, etc.

As exemplarily illustrated in FIG. 1A, the computer implemented method disclosed herein provides 101 an asset management application executable by at least one processor configured to monitor and manage the user's assets. In an embodiment, the asset management application is a web application implemented on a web based platform, for example, a website hosted on a server or a network of servers. In another embodiment, the asset management application is configured as a software application, for example, a mobile application downloadable by a user on a user device, for example, a mobile phone, a tablet computing device, etc.

The asset management application is accessible by a user device via a graphical user interface (GUI) provided by the asset management application, for example, over a network. The user device is, for example, a personal computer, a mobile communication device such as a cellular phone, a tablet computing device, a personal digital assistant, a laptop, a client device, an interactive network enabled communication device, a web browser, any other suitable computing equipment, combinations of multiple pieces of computing equipment, etc. The network is, for example, the internet, an intranet, a wired network, a wireless network, a network that implements Wi-Fi® of the Wireless Ethernet Compatibility Alliance, Inc., an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a long-term evolution (LTE) mobile communication network, a public telephone network, etc., a local area network, a wide area network, an internet connection network, an infrared communication network, etc., or a network formed from any combination of these networks.

The asset management application provides 102 multiple interactable interface elements on the GUI for enabling configuration and access of asset information and computations on the GUI via the user device. As used herein, the term “interactable interface elements” refers to design paradigms or interface components on the GUI configured to perform a combination of processes, for example, a data retrieval process from the inputs associated with the asset received from the user, processes that transform retrieved data into visual entities, for example, interactive graphical models of financial components of expenditure on the GUI, processes that enable real time user interactions with the interactive graphical models, etc. The interactable interface elements comprise, for example, clickable or draggable slider elements such as a slider wheel icon, a slider window, a floating window, etc. Also, as used herein, the term “interactive graphical model” refers to an interactive amortization graph that visually represents the inputs associated with the asset, financial information, asset information, etc., received by the asset management application and one or more financial components of expenditure determined by the asset management application over a configurable duration of time. Also, as used herein, the term “amortization” refers to a method where a loan is repaid over predetermined period of time, allowing both a lender and a borrower to know when the loan will be retired and what the payments will be each month. At each monthly payment, the asset management application determines an interest rate on an outstanding loan balance. As the outstanding loan balance decreases, the amount that goes toward interest decreases accordingly. For example, if a mortgage loan is amortized, a portion of each monthly payment goes towards loan interest and a portion goes towards the outstanding principal balance. Mortgages are amortized, for example, over 15, 20, 25 and 30 year periods. This uniformity in loan term allows lenders to more easily buy and sell mortgage loans to one another and to one or more financial entities. As used herein, the term “financial entities” refers to individuals or financial institutions that provide financial services and are involved in financial transactions with users. Examples of financial entities are banks, mortgage loan companies, investment firms, credit unions, insurance agencies, brokerages, etc., financial professionals such as bankers, lenders, financial advisors, insurance agents, etc. At the beginning of a mortgage loan amortization period, the monthly payment comprises mostly the interest with a lesser amount going towards the outstanding principal balance. During the latter half of the loan term, more of the monthly payment contains a payment toward the outstanding loan balance and less to the interest. This pattern arises as the asset management application determines the interest rate on the outstanding loan balance. The larger the outstanding balance, the higher the interest attributed to the monthly payment. Also, as used herein, the term “configurable duration of time” refers to time instants, time periods, or points in time that can be configured by a user on the GUI. The configurable duration of time comprises, for example, a user selected date and time range, a day, a month, a year, a period of days, a period of weeks, a period of months, a period of years, etc. Also, as used herein, the term “financial components of expenditure” refers to computed values of a user's expenditure derived from inputs associated with an asset, financial information, asset information, etc., received from the user.

The interactable interface elements enable the user to configure and access asset information and computations on the GUI via the user device. The interactable interface elements are configured to receive user interactions performed on the GUI via clickable slider elements, for example, a slider wheel icon, a slider window, a floating window, etc. The clickable slider elements, for example, the slider wheel icon, the slider window, etc., enable the user to traverse interactive graphical models rendered by the asset management application on the GUI. The floating window is an on-screen window that can be dragged to any position within the GUI or even outside a parent window on the GUI. In an embodiment, the asset management application activates floating windows on the interactive graphical models rendered and displayed by the asset management application on the GUI, when the user hovers a pointer of a computer mouse on the interactive graphical models for accessing a particular financial component of expenditure determined by the asset management application.

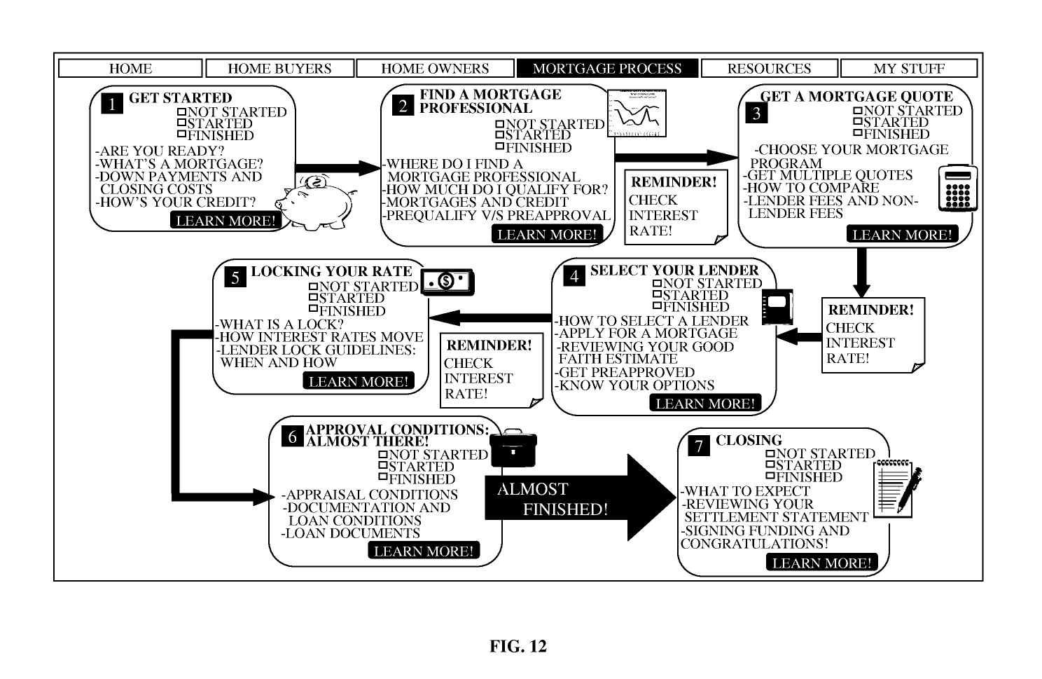

In an embodiment, the asset management application provides a clickable image or a representation of a process flow of a financial scenario, for example, a mortgage process on the GUI that allows a user to navigate through the financial scenario by clicking selective sections on the clickable image. For example, the GUI displays a screen that shows an image of a mortgage process flow to obtain a mortgage and allows the user to click on any section of the image of the mortgage process flow and access a screen that performs and/or illustrates and/or describes that part of the mortgage process, as exemplarily illustrated in FIG. 12.

The asset management application receives 103 inputs associated with an asset from the user device via the GUI. In an embodiment, the asset management application receives one or more inputs associated with one or more assets from the user device via the GUI. The inputs associated with the asset comprise, for example, provisions or a selection of a fixed rate loan on an asset or an adjustable rate loan on an asset, parameters defining a term of a loan such as a loan start date and a loan end date, a price of an asset, a down payment, a term of the fixed rate loan or the adjustable rate loan, an interest rate for the fixed rate loan or the adjustable rate loan, an amount of asset tax, a tax bracket, state of the asset, city of the asset, county of the asset, fees of the asset, condominium (condo) fees of a property asset or housing cooperative (coop) fees of the property asset, tax information, prospective financial parameters, etc. As used herein, the term “fixed rate loan” refers to a loan where an interest rate, and therefore a monthly payment, does not change throughout the life of the loan. The fixed rate loan is, for example, a fixed rate mortgage loan, a fixed rate student loan, etc. Also, as used herein, the term “adjustable rate loan” refers to a loan where the monthly payment may change based upon a predetermined set of interest rate guidelines. The adjustable rate loan is, for example, an adjustable rate mortgage (ARM) loan, an adjustable rate student loan, etc. An ARM comprises an index and a margin. An index can be any commonly available security, for example, the 1-year constant maturity treasury (CMT), the one-year London interbank offered rate (LIBOR), etc. The margin is the amount, in percent, that is added to the index to determine the new rate at the time of adjustment. A one-year ARM is adjusted once per year and a six-month ARM is adjusted once every six months. At the adjustment period, the margin is added to the index in order to arrive at a new interest rate that the lender applies to the outstanding mortgage balance. For example, if the one-year LIBOR is 1.00 percent and the margin is 2.50 percent, then the new, adjusted interest rate would be 1.00+2.50, or 3.50 percent. An ARM also contains consumer protections referred to as “interest rate caps” or “caps”. A cap is a limit placed upon an ARM that determines how high or how low an ARM rate may be at each adjustment period as well as a lifetime cap that limits how high and how low an ARM rate may be over the life of the loan. The fixed rate loan and the adjustable rate loan are completely amortized, that is, the loan will be gradually paid off over a predetermined time period.

A loan start date is, for example, a start point for a mortgage payment, where the user can configurably select a loan start date on the GUI to trigger the asset management application to dynamically render an interactive graphical model based on the start date selected by the user. A loan end date is, for example, an end point for a mortgage payment, where the user can configurably select an end date on the GUI to trigger the asset management application to dynamically render an interactive graphical model based on the end date selected by the user. Also, as used herein, the term “prospective financial parameters” refers to prospective financial information, for example, a prospective time instant selected by a user on the GUI to allow the user to understand what would happen to his/her finances at that time instant or how much the user would earn or receive at that time instant. For example, the asset management application enables a user to select prospective time instants on the GUI to determine how much the user would gain if the user sold his/her property asset or home at the selected prospective time instants.

In an example where the user wishes to understand about a mortgage on a property asset, the asset management application receives a selection of a fixed rate mortgage loan or an adjustable rate mortgage loan, a mortgage start date, a mortgage end date, a price of a property asset, a percentage of down payment or an amount of down payment, a term of the fixed rate mortgage loan or the adjustable rate mortgage loan, an interest rate for the fixed rate mortgage loan or the adjustable rate mortgage loan, an amount of property tax, a tax bracket, state of the property asset, city of the property asset, and/or county of the property asset, condominium (condo) fees of the property asset, and/or a housing cooperative fees of the property asset, from the user via the GUI.

The asset management application determines 104 one or more of multiple financial components of expenditure for the user over a configurable duration of time based on one or more of the received inputs associated with the asset and/or a geographical location of the asset and/or the user. For example, the asset management application determines one or more financial components of expenditure over a configurable duration of time based on one, two or more of the received inputs associated with the asset, or based on a geographical location of the asset and/or the user, or based on both the received inputs and the geographical location of the asset and/or the user. The financial components of expenditure comprise, for example, an amount of loan required, a monthly loan payment, a payment over a configurable duration of time, an amount of asset tax, an amount of an interest rate deduction for a loan, an amount of tax deduction from tax deductable housing cooperative fees, an amount of equity available to the user at a point in the configurable duration of time, an amount of equity spent by the user at a point in the configurable duration of time, a break-even point, an amount of income needed at a configurable stage in the configurable duration of time to enable the user to repay the loan within a term of the loan, a fixed rate loan payment over the term of the loan, an adjustable rate loan payment over the term of the loan, loans available in different geographical locations, time of refinancing of the loan, etc. As used herein, the term “configurable stage” in the configurable duration of time refers to any time instant, for example, a day, a month, a year, etc., in the configurable duration of time that can be selected and modified by a user for determining a corresponding estimate. For example, if a user wants to determine an estimate of the income required to be able to pay off a loan at a particular time instant within a year, the user may select a day or a month within that year on the GUI and view the corresponding estimate.

Consider an example where a user wishes to determine a monthly loan payment for a property, the total interest over a period of 30 years, and the total cost in 30 years. In this example, the user enters a home price of $300,000, 20% percent of down payment, an interest rate of 3.52%, and a monthly condo fee of $200 for a 30 year fixed rate mortgage on the GUI of the asset management application. The user further enters a monthly expense of $1000 on the GUI. The asset management application determines the financial components of expenditure as follows: The asset management application determines the mortgage payment for the property asset as $1080.39, the monthly payment as $2280.39, the total interest over 30 years as $148,939.41, and the total cost in 30 years as $448,940.40.

On determining the financial components of expenditure, the asset management application dynamically renders 105 one or more interactive graphical models of the determined financial components of expenditure to the user device, for example, via the GUI. The asset management application dynamically generates one or more interactive graphical models of the determined financial components of expenditure and displays the generated interactive graphical models, for example, on the GUI. For example, the asset management application dynamically renders an interactive graphical model that visually represents monthly mortgage payments by considering property tax based on location, that is, state, city, zip code, and/or county inputted manually by the user, principal, and interest payments over a length of a mortgage on the GUI. The dynamically rendered interactive graphical models of the determined financial components of expenditure are configurably accessible and modifiable on the GUI by the user via the user device using one or more of the interactable interface elements. For example, the user may click on a slider wheel icon displayed on the GUI and move the slider wheel icon to any point in time on an interactive graphical model to access the determined financial components of expenditure for that point in time. In another example, the user may hover a pointer of a computer mouse on an interactive graphical model and activate a floating window on the interactive graphical model to view payment incurred at a particular point in time. The user may therefore view how principal, interest, and equity change over time.

The asset management application displays an interactable interface element, for example, a slider wheel icon on the interactive graphical model, which the user can slide over multiple years to determine the change in principal, interest, etc., over the years. Consider an example where in the first month and the first year, the asset management application determines the principal amount as $376.39 and the interest payment as $704. If the user slides the slider wheel icon on the GUI to the 5th year on the interactive graphical model on the GUI, the asset management application dynamically determines and displays the principal amount as $448.71 and the interest payment as $631.68 on the interactive graphical model on the GUI. The interactive graphical model for an adjustable rate mortgage (ARM) displays various scenarios, for example, how the loan can adjust, for example, if the index associated with the ARM adjusts to a maximum interest rate limit, or if the index associated with the ARM remains stable over a period of time.

In an embodiment, the asset management application receives at least one input on the dynamically rendered interactive graphical models of the determined financial components of expenditure from the user device via the GUI. The asset management application dynamically updates the determined financial components of expenditure based on the received input. Consider an example where the asset management application renders an interactive graphical model with interactable interface elements such as a slider wheel icon and a slider window positioned on the interactive graphical model, displaying the amortization graph over a configured duration of a loan term. If the user slides the slider wheel icon from year 1 month 1 to year 10 month 1, then the asset management application dynamically updates the values of the financial components of expenditure displayed in the slider window according to the financial components of expenditure determined based on the new position of the slider wheel icon.

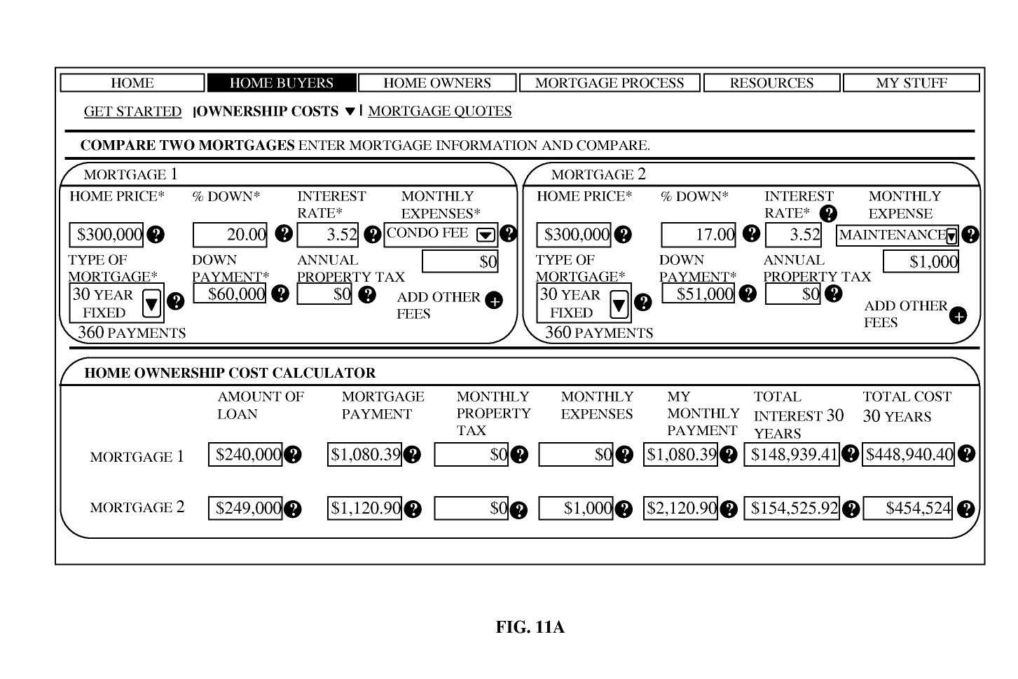

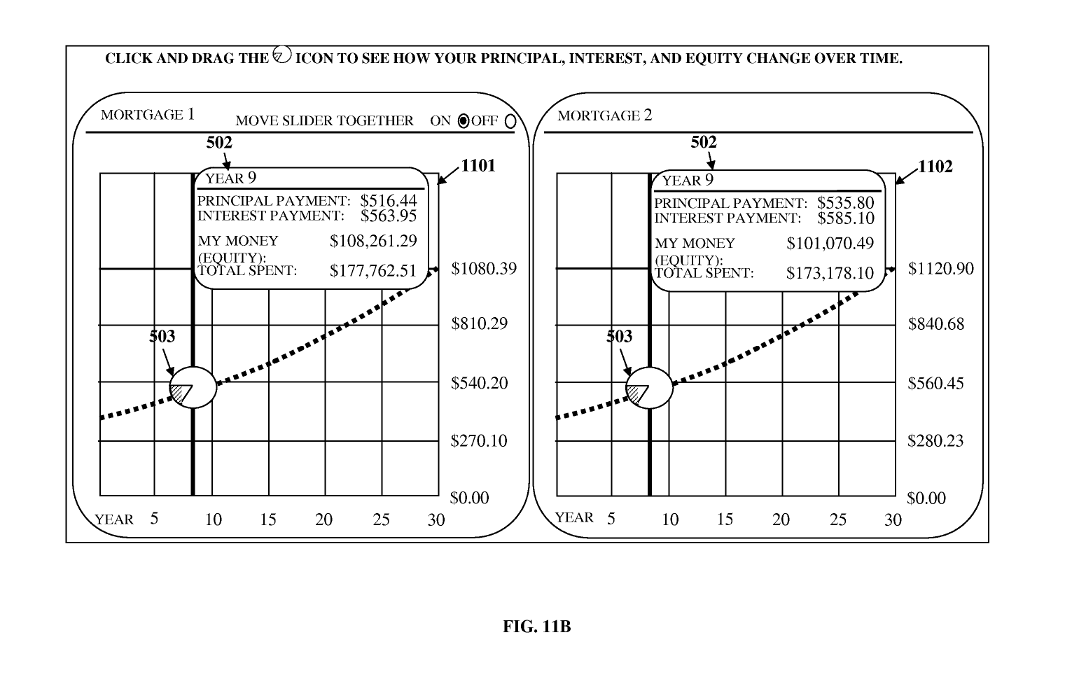

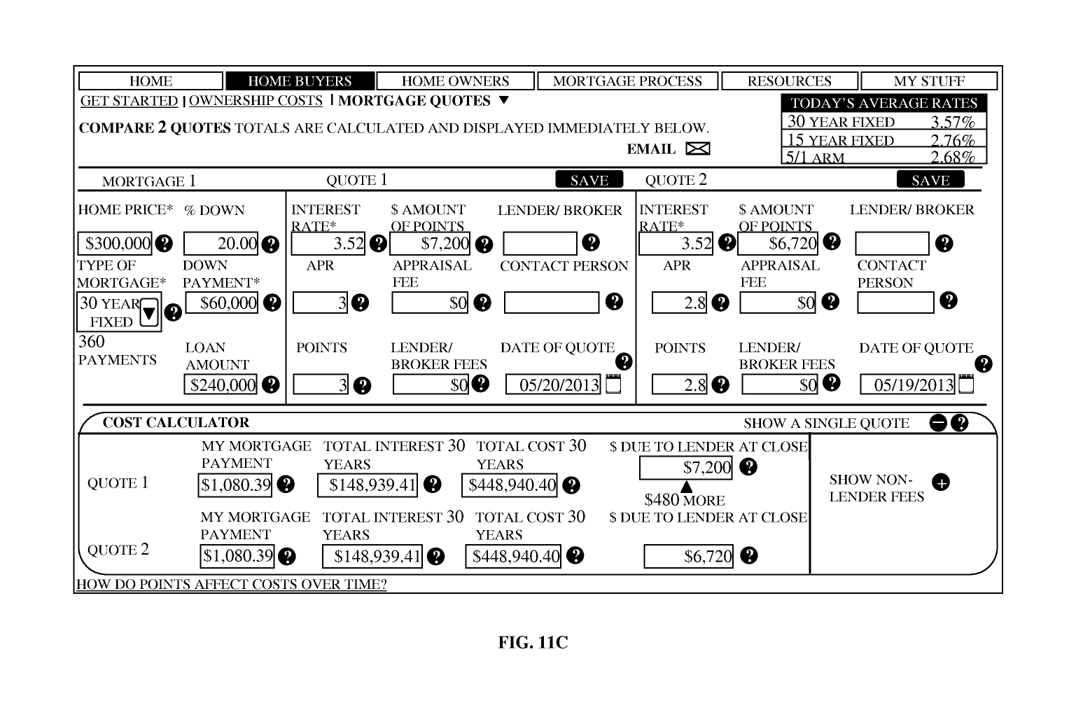

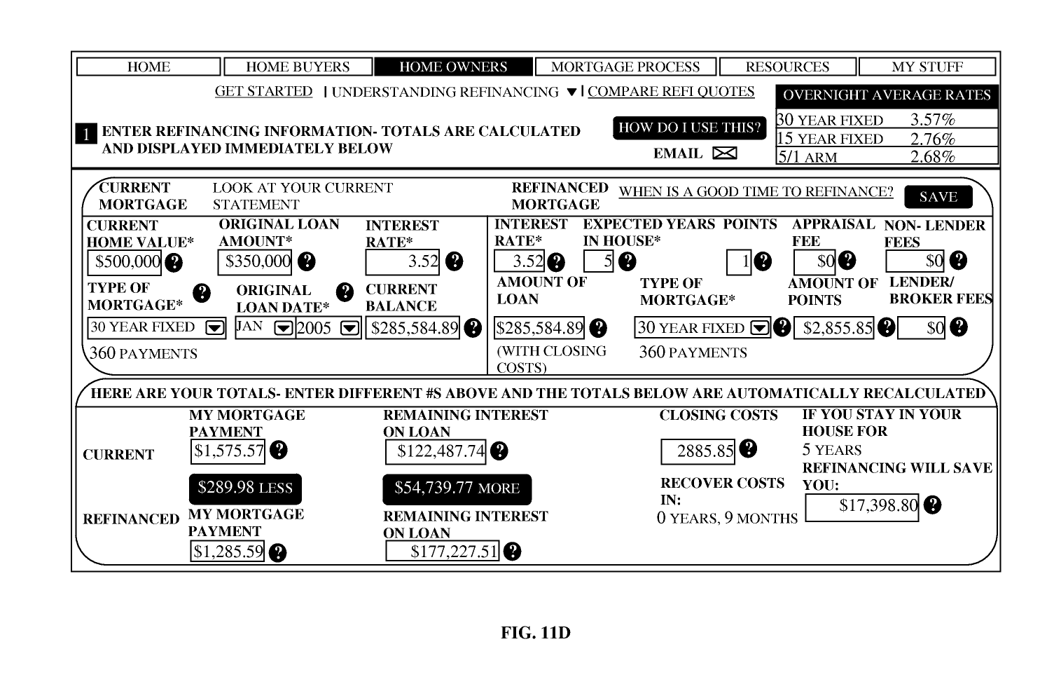

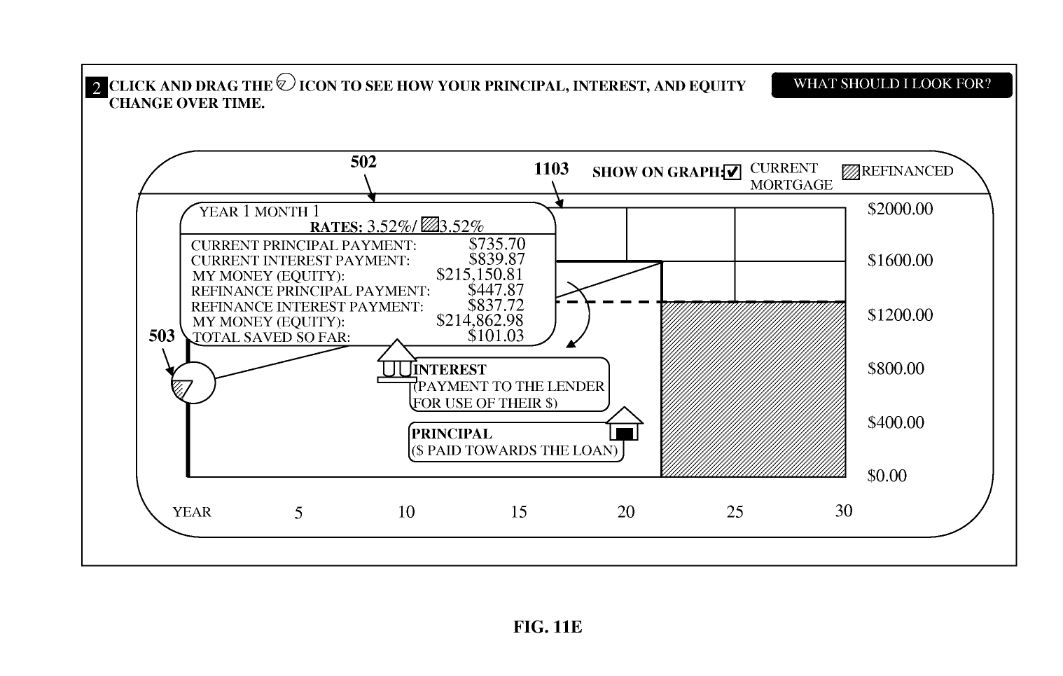

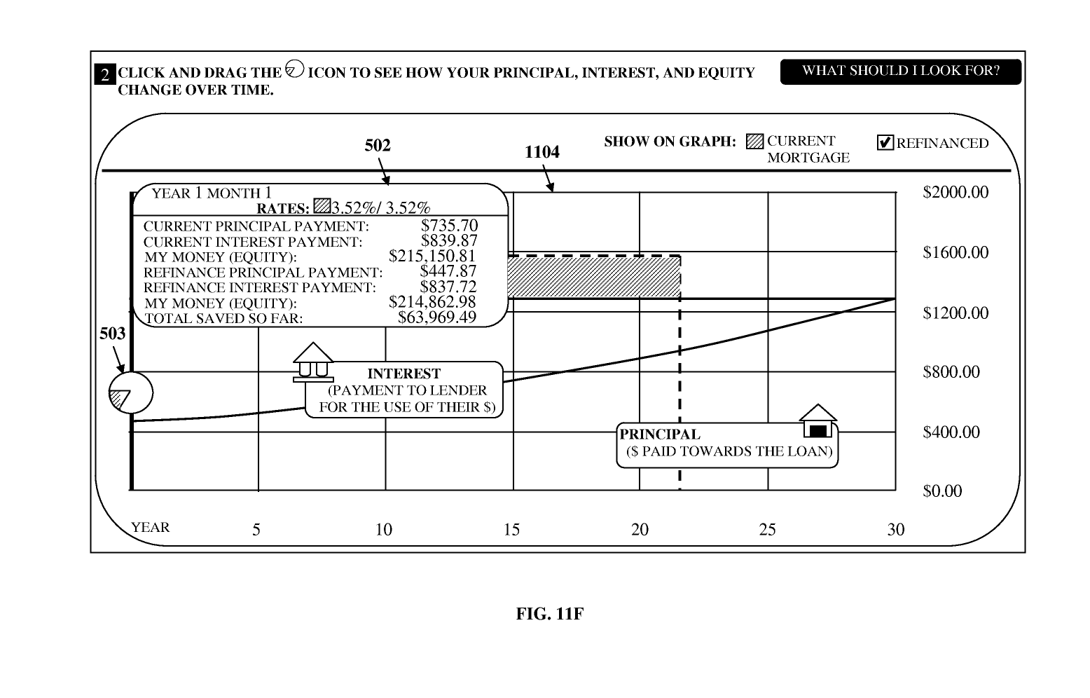

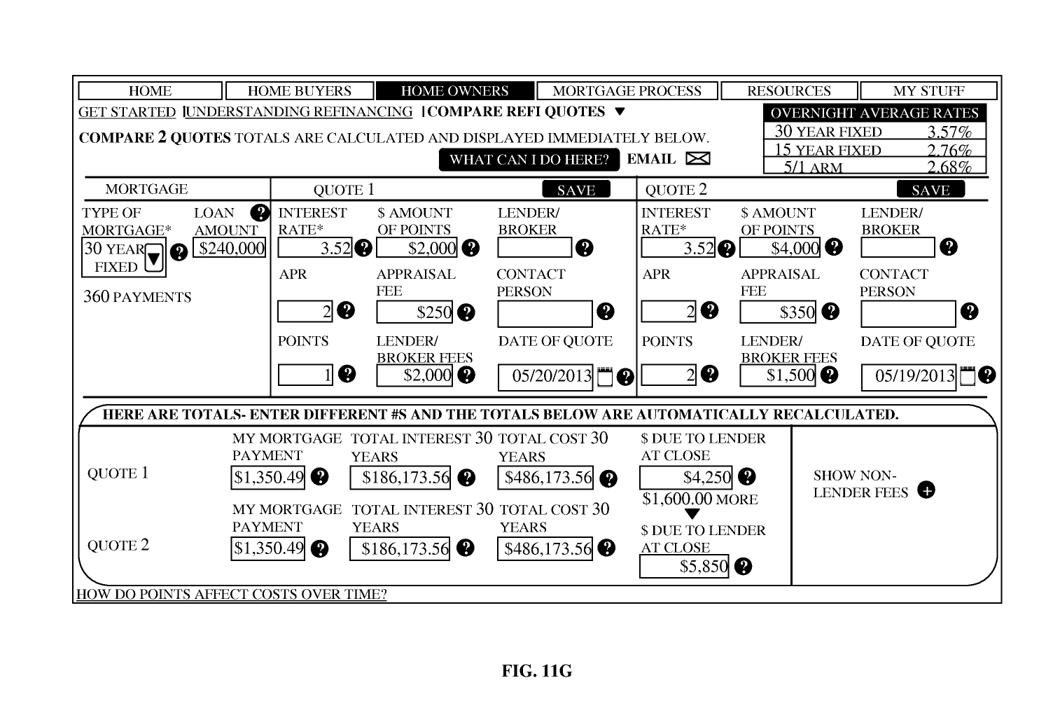

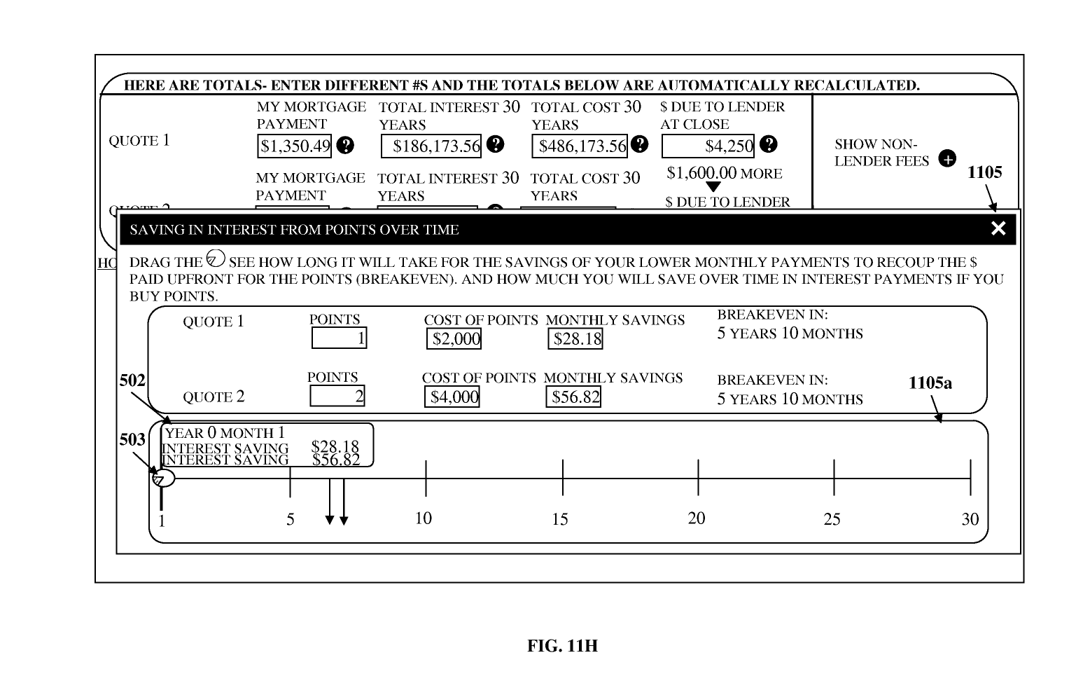

In an embodiment, the asset management application receives loan quotes received by the user from one or more external sources, for example, lenders via the GUI. The user receives the loan quotes from third party sources and requests the asset management application to model the loan quotes. The asset management application lists the available loan quotes and contact information of the external sources on the GUI. A user selects one or more of the received loan quotes. The asset management application receives selections of one or more of the received loan quotes from the user device via the GUI, determines one or more financial components of expenditure based on the selected loan quotes, and dynamically renders an interactive graphical model of each of the determined financial components of expenditure for each of the selected loan quotes for performing a comparative analysis of the determined financial components of expenditure for the selected loan quotes. The asset management application allows the user to model use cases on one or more loan quotes in time, for example, total paid during a sale of a property, total tax, total loan deduction, etc., thereby allowing the user to determine the best quote in a variety of different scenarios. The asset management application also allows the user to model fees and charges to determine the best return on investment for the user as exemplarily illustrated in FIGS. 11A-11C. In an example, the asset management application receives a selection of one of the loan quotes from the user device via the GUI and dynamically renders an interactive graphical model which can then be saved and compared.

Consider an example where the user enters a $300,000 home price and selects a 20% down payment and a 30 year fixed rate loan on the GUI, and wishes to compare two mortgage quotes at an interest rate of 2.63% and at an interest rate of 3.52%. The asset management application displays the loan amount as $240,000 on the GUI. For the interest rate of 2.63%, the asset management application determines financial components of expenditure, for example, the mortgage payment as $964.59, the total interest in 30 years as $107,253.04, and the total cost in 30 years as $407,252.40. For the interest rate of 3.52%, the asset management application determines the mortgage payment as $1080.39, the total interest in 30 years as $148,939.41, and the total cost in 30 years as $448,940.40. The asset management application dynamically renders interactive graphical models on the GUI displaying the determined values to enable the user to compare the two mortgage quotes graphically.

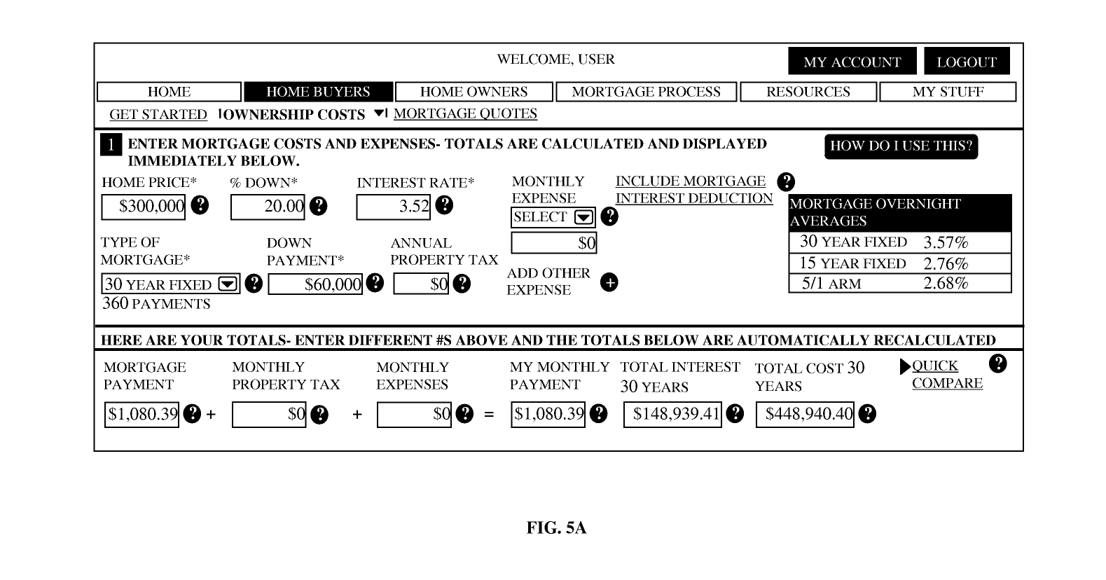

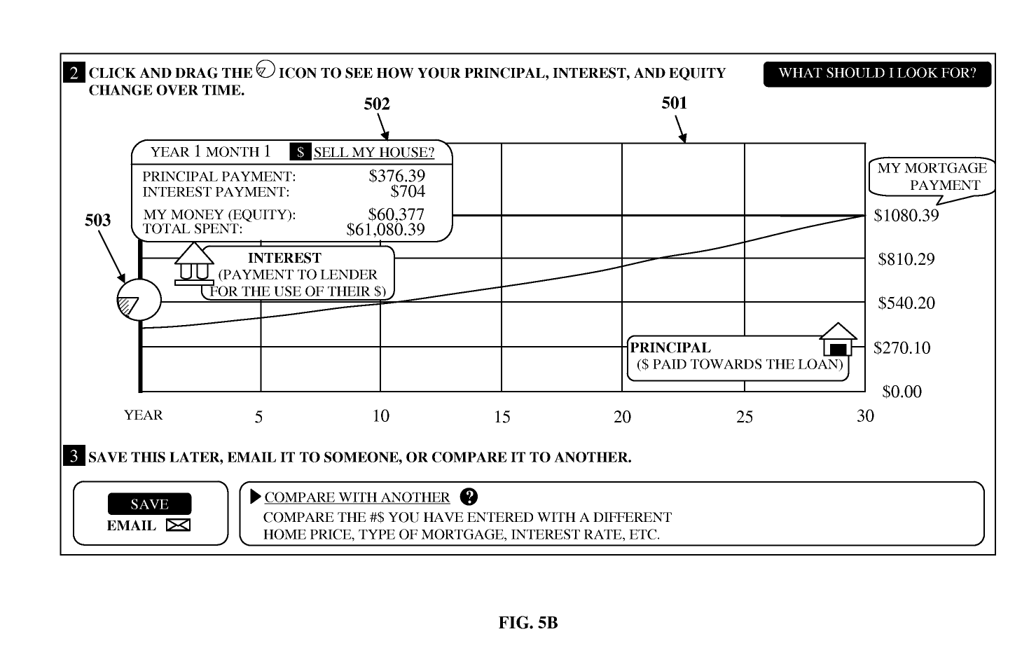

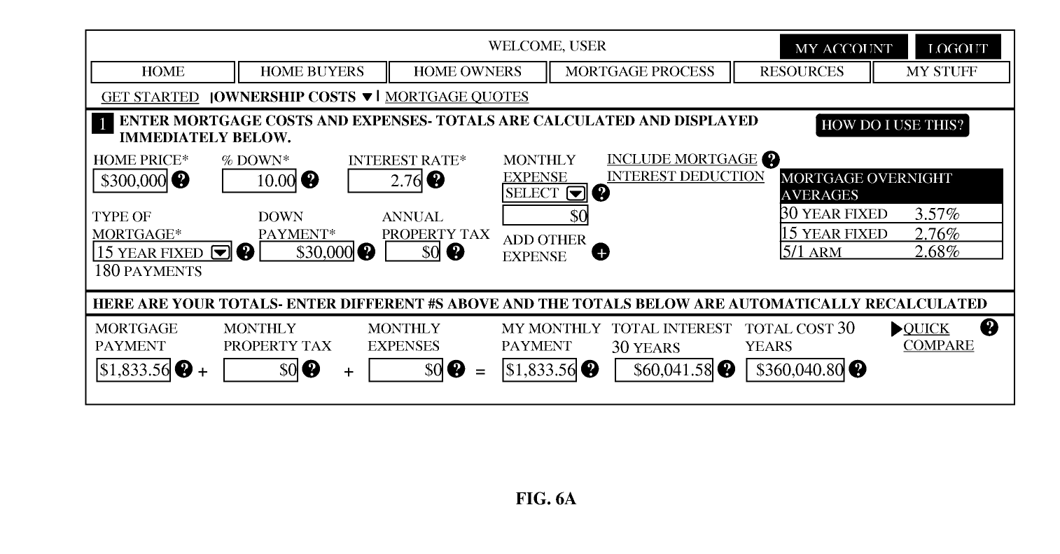

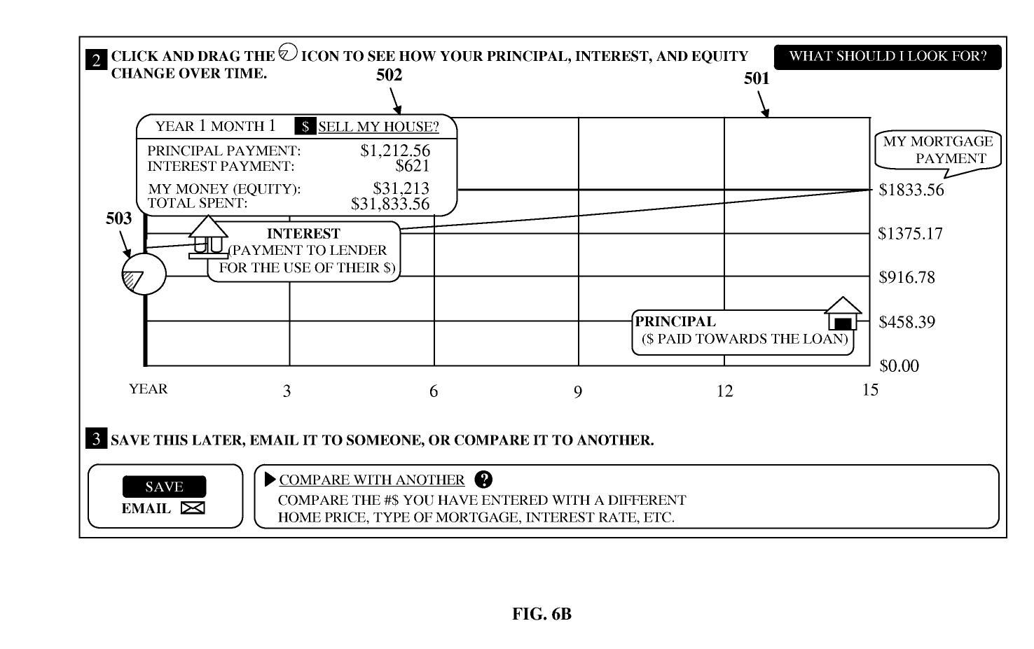

In an embodiment, the asset management application tracks changes made to the inputs associated with the asset by the user on the GUI via the user device over a configurable duration of time. The asset management application redetermines the determined financial components of expenditure based on the tracked changes and dynamically updates the tracked changes and the redetermined financial components of expenditure to the dynamically rendered interactive graphical models. The tracked changes are associated with computational algorithms that automatically modify the underlying financial components of expenditure based on the tracked changes and reflect the redeterminations of the financial components of expenditure on the interactive graphical models concurrently as exemplarily illustrated in FIGS. 5A-5B and FIGS. 6A-6B. In another embodiment, the asset management application performs a comparative analysis of associated financial components of expenditure over a configurable period of time using the dynamically rendered interactive graphical models of the associated financial components of expenditure and dynamically renders a comparative analytical report based on the comparative analysis as exemplarily illustrated in FIGS. 11A-11H. In an embodiment, the interactable interface elements positioned on associated interactive graphical models of the determined financial components of expenditure are configured to simultaneously displace over a configurable duration of time on the GUI for performing a comparative analysis of the determined financial components of expenditure as exemplarily illustrated in FIG. 11B.

In an embodiment, the asset management application determines an estimate amount for selling an asset at a configurable point in time selected via the user device using one or more of the interactable interface elements positioned on the dynamically rendered interactive graphical models of the determined financial components of expenditure as disclosed in the detailed description of FIG. 1B. The asset management application displays an interactable interface element, for example, a slider wheel icon on an interactive graphical model of the determined financial components of expenditure. The user can slide the slider wheel icon over selective time instants on the interactive graphical model to determine the amount the user would gain if the user sold his/her property asset at those selected time instants.

In an embodiment, the asset management application toggles display of the dynamically rendered interactive graphical models of the determined financial components of expenditure on the GUI based on a selectable index associated with each of the determined financial components of expenditure. As used herein, the term “selectable index” refers to an indicator of financial information or asset information represented by an interface element, for example, a checkbox on the GUI to allow the user to view different interactive graphical models based on a selection of a piece of financial information or asset information and compare the associated financial components of expenditure. For example, the selectable index is a loan interest rate index for a fixed rate loan and an adjustable rate loan or an index associated with current and refinanced loans. The index associated with an adjustable rate loan is, for example, a maximum interest rate or the highest interest rate that can be charged in a financial transaction, or a lowest interest rate. For example, in an adjustable rate mortgage, the maximum interest rate is the highest interest charged by a mortgagor on the borrower. The index associated with a fixed rate loan is, for example, a stable interest rate offered by the fixed rate loan. The index is an external rate, for example, a 6 month LIBOR. There are several common indices used in adjustable rate mortgages (ARMs), for example, constant maturity treasury (CMT) and month treasury average (MTA). When a user is under an ARM, the index for which the ARM is tied will be a part of the loan details. For example, if a user is under a 5/1 ARM tied to the 6 month LIBOR, the details will be listed in the loan documents. The 5/1 ARM will have parameters for adjustments. A 5/1 ARM can adjust only after 5 years and then once per year. Loan terms will have a yearly cap of 2%. Loan terms will also have a maximum cap, for example, 5% or 6% above a starting interest rate. The loan would have a starting interest rate, for example, 3%. After 5 years, the interest rate will be calculated by the index at that time plus a margin, where the margin is also a part of initial loan documents and is typically around 2.5. In 5 years, the 6 month LIBOR=1. Therefore, after 5 years, the interest rate adjusts to 1+2.5=3.5. 3.5 is below the adjustment cap of 2. That is, 3.5—starting interest rate of 3<2+ starting interest rate of 3. The asset management application determines what would happen if the loan is adjusted to the maximum amount, and also, what would happen if the loan is carried on at the current index amount, or what would happen if the loan is adjusted to a lowest interest rate, etc. The asset management application renders interactive graphical models for ARMs over the period of a loan. In another example, the user may view the interactive graphical models rendered based on a selection of a current mortgage index or a refinanced loan index and toggle between the interactive graphical models on the GUI to compare the associated financial components of expenditure as exemplarily illustrated in FIGS. 11E-11F.

In an embodiment, the asset management application facilitates communication of one or more financial scenarios between the user and one or more financial entities and/or one or more other users via a network, for example, the internet, a mobile communication network, etc. The asset management application facilitates communication between the user and one or more financial entities, for example, banks regarding, for example, loan offers, the interactive graphical models, etc., and also facilitates manipulation of the communicated interactive graphical models, via the network. The asset management application also communicates one or more financial scenarios, for example, loan offers for loan products, etc., to one or more other users via the network, for example, via electronic mail (email), a prompt provided on the GUI when the other users log into the asset management application, etc. The asset management application thus facilitates a communication mechanism for users to communicate with financial entities such as mortgage professionals and vice versa, for example, to take out friction in the process of deciding on a loan or deciding on a quote for a loan and to obtain the best outcome for users as well as improve the quality of service provided by the financial entities.

In another embodiment, the asset management application categorizes the determined financial components of expenditure, for example, based on geographical locations. As used herein, the term “geographical locations” refer to elements of an address, for example, a zip code, a street address, a locality name, etc., used for categorization of the determined financial components of expenditure. In an example, if a user selects multiple geographical locations on the GUI, the asset management application determines property tax based on the selected geographical locations. The asset management application also determines a local tax component associated with a property asset, property tax fluctuations, market price trends, etc., based on the geographical location selected by the user. In an embodiment, the asset management application facilitates communications between a user and one or more financial entities based on the geographical location selected by the user.

In another embodiment, the asset management application determines the amount of selling an asset based on one or more financial scenarios regarding an adjustable rate loan. For example, if a user wants to sell his/her home at a future point in time and have an adjustable rate mortgage (ARM) loan, the asset management application displays one or more results based on various potential adjustment financial scenarios in the future time. In another embodiment, the asset management application determines and displays break-even of a loan offer determining closing costs. In another embodiment, the asset management application displays a comparison of break-even of one or more loan offers. In another embodiment, the asset management application determines and displays a total amount saved or spent over a selected number of years, cost of funds for more than one loan type and loan terms, etc. In another embodiment, the asset management application determines total interest, total equity, etc., for a user entered time duration. For example, if a user selects a loan term of 5 years, then the asset management application determines the amount of equity for one or more loans for the purpose of comparison.

In another embodiment, the asset management application transmits one or more notifications on asset information and supplementary financial information to the user device via the GUI and/or a network, for example, the internet, a mobile communication network, etc. As used herein, the term “asset information” refers to information associated with an asset such a property, for example, local issues such as zoning or community board information, etc., that may affect property value, assets on sale in a particular geographical location, market rate trends, appreciation and depreciation respective to the asset, predictions for asset prices, newly available rates, cost of refinancing, duration of return on investments, etc. Also, as used herein, the term “supplementary financial information” refers to relevant information used to enhance a user's understanding of the financial components of expenditure, to enable the user to perform a comparative analysis of the financial components of expenditure over a configurable duration of time, etc. The supplementary financial information comprises, for example, informative articles explaining basic concepts of a loan, amortization, equity, discount points, interest rates, etc. The asset management application transmits the asset information and/or the supplementary financial information to the user device, for example, via electronic mail, a short message service (SMS), etc., via the network. The asset management application may also transmit the asset information and/or supplementary financial information, for example, via prompts on the GUI of the asset management application.

In another embodiment, the asset management application generates alerts based on events associated with the received inputs associated with an asset, the determined financial components of expenditure, and the dynamically rendered interactive graphical models of the determined financial components of expenditure stored in the database. The asset management application also transmits the generated alerts to the user device via the GUI and/or the network. The generated and transmitted alerts are based on events and scenarios stored by the user in the database. For example, the asset management application generates and transmits an alert to a user having a current mortgage scenario stored in the database when the interest rates are feasible enough to refinance the user's mortgage. The asset management application alerts homeowners when refinancing is applicable. The asset management application compares a current owner mortgage rate with newly available mortgage rates, determines an estimated cost of refinancing, and also determines duration to obtain a return on investment. The asset management application alerts a user, for example, a homeowner with the newly available rates, predicted cost of refinancing, months required to break even, etc. The asset management application transmits the alerts, for example, via electronic mail, a short message service (SMS), etc., via the network. The asset management application may also transmit the alerts, for example, via prompts on the GUI of the asset management application.

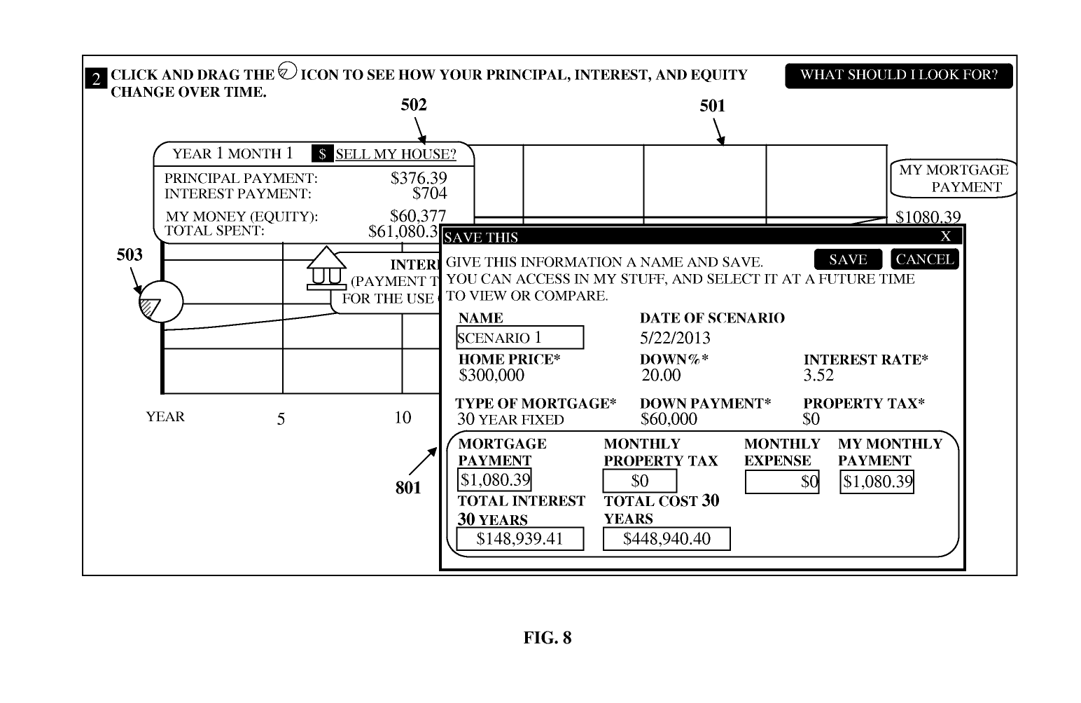

In an embodiment, the asset management application stores the user information, advisory information, the received inputs associated with the asset, the determined financial components of expenditure, and the dynamically rendered interactive graphical models of the determined financial components of expenditure in a database, and facilitates retrieval of the stored user information, the advisory information, the received inputs associated with the asset, the determined financial components of expenditure, and the dynamically rendered interactive graphical models of the determined financial components of expenditure from the database. For example, the asset management application provides a “Save” option on the GUI as exemplarily illustrated in FIG. 8, where a user can save his/her information, for example, name, location, asset information, etc., along with financial scenarios, interactive graphical models, etc., in the database. The asset management application facilitates retrieval of the stored information from the database for performing comparison, viewing, editing, deleting the stored information, etc.

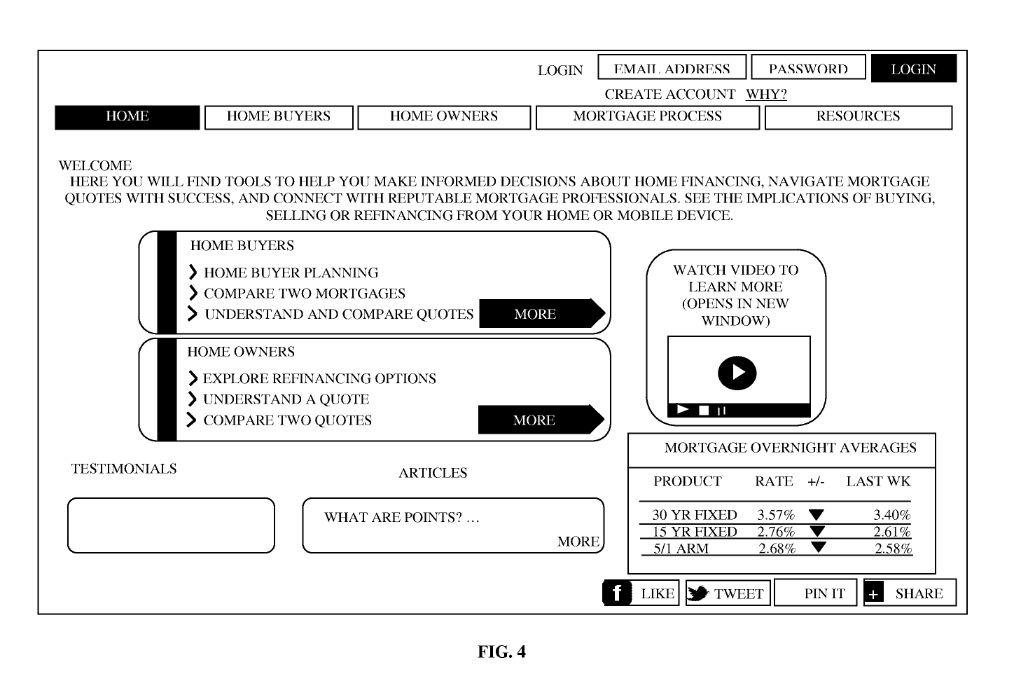

Consider an example where a user wants to monitor and manage his/her assets. The user accesses the asset management application hosted, for example, on a website via a network, for example, the internet using a web browser on his/her user device. The asset management application displays a home page menu via the graphical user interface (GUI) as exemplarily illustrated in FIG. 4, where the asset management application enables the user to register or log into the asset management application. After registration and authentication of the user, the asset management application prompts the user to log in. The GUI of the asset management application displays tabs for example, a “home buyers” tab, a “home owners” tab, a “mortgage process” tab, etc., as exemplarily illustrated in FIG. 4. The user can select one or more of the tabs for navigating the website. Once the selection of the tab is received from the user, the asset management application opens and displays the respective tab via the GUI. If the user selects the “home buyers” tab, the GUI displays a webpage for receiving inputs associated with an asset as exemplarily illustrated in FIG. 5A. The user enters inputs associated with an asset, for example, a $300000 value for “Home price”, a 20% down payment, a 3.52% interest rate, $0 as annual property tax, and selects a 30 year fixed rate mortgage. The financial management application receives the inputs entered by the user on the GUI. The asset management application then determines the user's financial components of expenditure based on the received inputs and displays the determined values as follows: a $1080.39 mortgage payment+a $0 monthly property tax+$0 monthly expenses=a $1080.39 monthly payment. The asset management application also displays the total interest for 30 years as $148939.41 and the total cost for 30 years as $448940.40. The asset management application determines some of the financial components of expenditure, for example, as follows:

Mortgage amount needed=Home price−down payment amount=[(300,000)−(0.2*300,000)]=240,000.

The asset management application determines the monthly mortgage payment using the following equation: P×(J/(1−(1+J)̂−N)), where P=mortgage amount needed, I=annual interest rate, J=monthly interest in decimal form (I/12×100), N=number of months over which a loan is amortized (L×12), and L=number of years. The asset management application also determines the monthly property tax as:

Monthly property tax=(Home price*Local property tax percentage(derived from state/county lookup))/12.

Total Monthly Payment=Monthly mortgage payment+Monthly Property Tax.

In an example, the asset management application determines a refinanced loan balance amount using the following formulae:

$$balance [ pmt\_ , n\_ , i\_ ] := p m t \frac{1 - \frac{1}{{( 1 + \frac{i}{12} )}^{n}}}{\frac{i}{12}} ;$$

$$term [ i\_ , pmt\_bal \_ ] := Flatten [ Solve [ p m t == \frac{i}{12} / ( 1 - 1 / {( 1 + \frac{i}{12} )}^{n} ) bal , n ] ] [ [ 1 ] ] [ [ 2 ] ] ;$$

pmt[loan_,rate_,n_]=Solve [TimeValue[Annuity[payment,n,1/12],

EffectiveInterest[rate,1/12],0]==loan,payment] [[1]] [[1]] [[2]];

where “pmt” is, for example, a function that calculates payments for a loan or a future value of an investment, assuming a stream of equal payments and a constant rate of interest. The “pmt” function returns the payment amount for a loan based on an interest rate and a constant payment schedule.

In another example, the asset management application determines remaining principal balance amount using the following formulae which calculates the remaining principal balance amount if the user has made “t” of “N” fixed payments on a timely basis, that is, before the due date so that no additional interest has accrued.

P=P*(1−((1+J)**t−1)/((1+J)**N−1))

where P is the principal, that is, the initial amount of the loan; I is the annual interest rate from 1 to 100 percent; L is the length in years of the loan, or at least the length over which the loan is amortized; J is the monthly interest in decimal form=I/(12×100); N is the number of months over which a loan is amortized=L×12; and t is the number of paid monthly loan payments.

After determining the financial components of expenditure, the asset management application dynamically renders an interactive graphical model based on the inputs received from the user and the determined financial components of expenditure as exemplarily illustrated in the FIG. 5B. The asset management application renders the interactive graphical model on the GUI, thereby enabling the user to understand assets with respect to principal amount, interest, and property tax. The interactive graphical model displays different colored volumes for enhanced visualization and understanding for the user. If the user makes changes to the inputs associated with the asset, the asset management application dynamically tracks the changes made, updates the values determined for the financial components of expenditure accordingly, and dynamically updates the rendered interactive graphical model. For example, if the user changes the type of mortgage from a 30 year fixed rate mortgage to a 15 year fixed rate mortgage as exemplarily illustrated in FIG. 6A, then the asset management application tracks this change and redetermines the values: $1833.56 as the monthly payment, $60041.58 as the total interest for 15 years, and $360040.80 as the total cost for 15 years. As exemplarily illustrated in FIG. 6B, the interactable interface element, for example, a slider window displays the updated values according to the tracked changes and the redetermined financial components of expenditure as follows: For “Year 1 Month 1”, the “Principal payment” is $1212.56, the “Interest payment” is $621, the “Equity” is $31,213, and the “Total spent” is $31833.56. Therefore, with a change in the “Type of mortgage” from a 30 year fixed rate mortgage to a 15 year fixed rate mortgage, the asset management application updates the mortgage payment from $1080.39 to $1833.56.

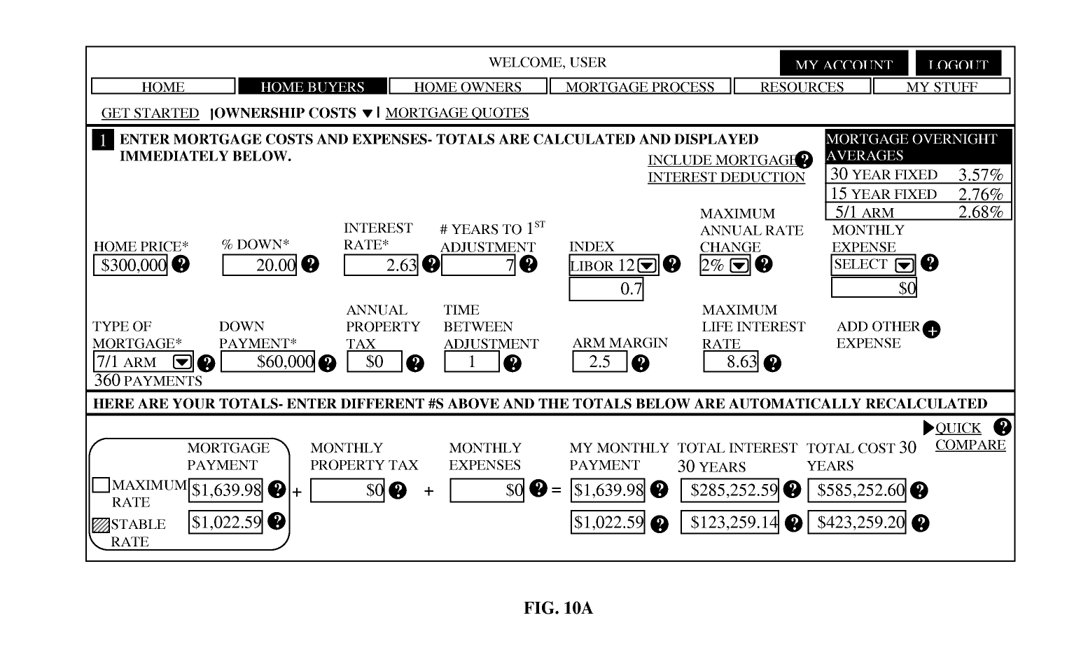

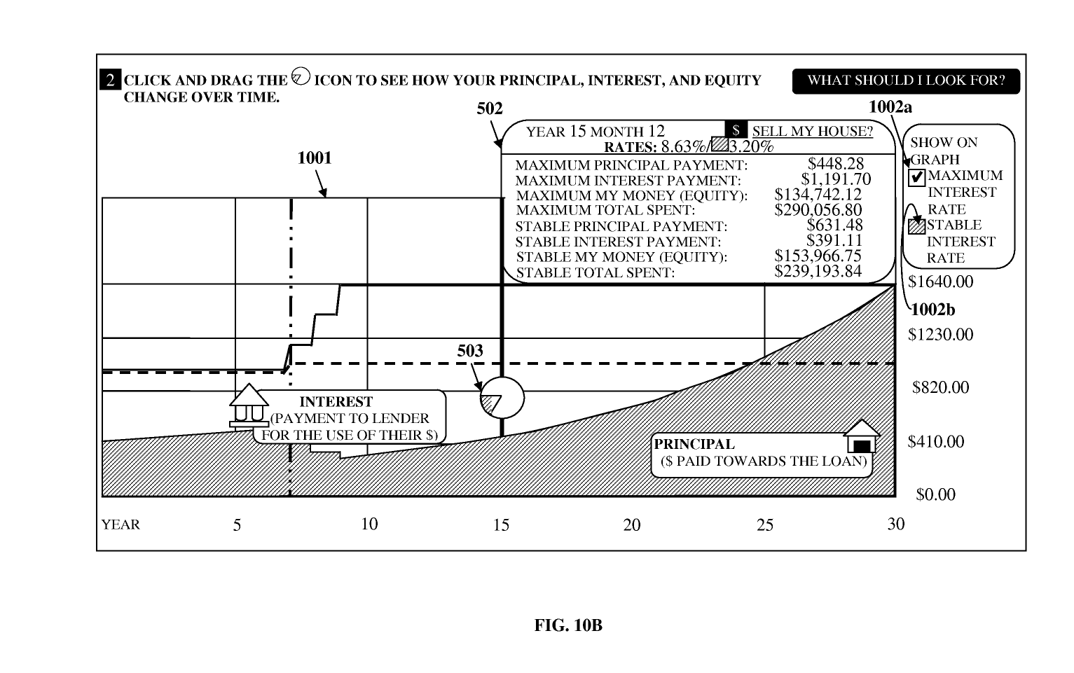

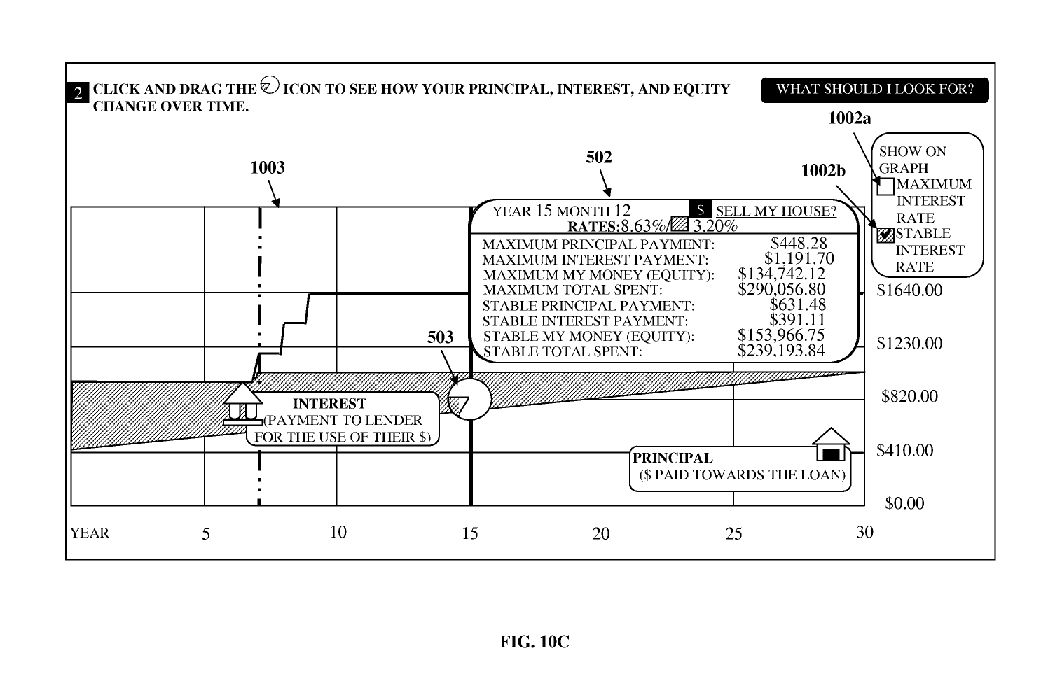

The asset management application also provides a toggle option with a selectable index for enabling the user to view superimposed interactive graphical models of the determined financial components of expenditure on the GUI for performing a comparative analysis, for example, between maximum interest rates and stable interest rates as exemplarily illustrated in FIGS. 10B-10C, and between current mortgages and refinanced mortgages as exemplarily illustrated in FIGS. 11E-11F. The asset management application also provides a slider wheel icon on the GUI as exemplarily illustrated in FIG. 11B, that displaces simultaneously with another slider wheel icon on associated interactive graphical models for enabling the user to perform a comparative analysis of the determined financial components of expenditure over a configurable duration of time. The asset management application also enables the user to save financial scenarios in a database, retrieve the saved scenarios from the database, transmit the financial scenarios, for example, via electronic mail, communicate the financial scenarios with other users and financial entities, etc. The asset management application generates alerts and sets notifications on the saved financial scenarios to inform the user about relevant updates and news.

The user can visualize the determined financial components of expenditure by clicking on a link, for example, “Click and drag the slider wheel icon to see how your principal, interest and equity change over time”, provided by the asset management application on the GUI as exemplarily illustrated in FIG. 5B. The user can understand his/her equity and mortgage payment over time through the asset management application, for example, as follows: by viewing an interactive graphical model having its X axis showing the number of years of the user's mortgage and a Y axis showing the user's monthly mortgage payment on the GUI, by viewing an interactive graphical model composed of a monthly amount of interest that tapers over a period of time on the GUI, by viewing an interactive graphical model showing a gradually increasing principal as a result of building equity over time on the GUI, by viewing an interactive graphical model showing total spent on the mortgage including the down payment on the GUI, by using a slider window that displays changes in values of interest and principal with respect to time as the slider window slides over the interactive graphical model on the GUI, etc. In an example, for “Year 1 Month 1”, the slider window displays the “Principal payment” as $376.39, the “Interest payment” as $704, the “Equity” as $60377, and the “Total spent” as $61080.39, while at “Year 5 Month 12”, the slider window displays the “Principal payment” as $447.39, the “Interest payment” as $633, the “Equity” as $84,653.23, and the “Total spent” as $124,823.40. The user can view the information displayed on the GUI and perform multiple actions, for example, save an interactive graphical model of the financial scenario, transmit the interactive graphical model of the financial scenario to a user device of another user, for example, via electronic mail, compare the values entered for home price, type of mortgage, interest rate, etc., with another home price, type of mortgage, interest rate, etc.

FIG. 1B exemplarily illustrates an embodiment of the computer implemented method for monitoring and managing a user's assets, where the asset management application determines an estimate amount for selling an asset at a configurable point in time selected by the user. The computer implemented method disclosed herein comprises steps 101, 102, and 103 as disclosed in the detailed description of FIG. 1A. After receiving the inputs associated with the asset from the user device via the GUI, the asset management application determines 106 one or more financial outcomes of a sale of the asset at a configurable point in time based on the received inputs associated with the asset and/or the geographical location of the asset. As used herein, the term “financial outcomes of a sale” refers to computations associated with the sale of an asset, for example, closing costs, amount gained by a user on selling his/her asset, etc. The asset management application dynamically renders 107 one or more interactive graphical models of the determined financial outcomes of the sale of the asset. The dynamically rendered interactive graphical models of the determined financial outcomes of the sale of the asset are configurably accessible and modifiable on the GUI via the user device using one or more interactable interface elements.

The asset management application displays an interactable interface element, for example, a slider wheel icon on the interactive graphical model of the determined financial outcomes of the sale of the asset. The user can slide the slider wheel icon over selective time instants on the interactive graphical model to determine the amount the user would gain if the user sold his/her property asset at those selected time instants. The asset management platform receives 108 at least one input on the dynamically rendered interactive graphical models of the determined financial outcomes of the sale of the asset from the user device via the GUI. The asset management platform dynamically updates 109 the determined financial outcomes of the sale of the asset based on the received input, for example, on the slider window on the GUI. For example, if the user slides an interactable interface element, for example, a slider wheel icon on a dynamically rendered interactive graphical model on the GUI, the asset management platform dynamically updates the determined financial outcomes of the sale of the asset on the slider window on the GUI.

Consider an example where a user selects a 30 year fixed rate mortgage on a property asset with a home price of $300,000 and an interest rate of 3.52% and pays a down payment of $60,000. If the user wants to determine how much he/she would gain if he/she would sell the property asset in the first month of the first year of the mortgage, the user may click a “Sell My House” option provided on the GUI of the asset management application. As exemplarily illustrated in FIG. 5B, the asset management application provides a link for the “Sell My House” option in the slider window. When the user clicks the “Sell My House” option on the GUI, the asset management application prompts the user to enter, for example, a sale price, a geographical location, and a broker's or a real estate agent's fee. The asset management application receives the prompted inputs associated with the asset, for example, a sale price of $300,000, the state of New York, and the broker's or the real estate agent's fee as 6% from the user device via the GUI and determines the closing costs as $5,811 and the amount the user would gain as $36,565.39 in the first month of the first year of the mortgage. If the user slides the slider wheel icon on the GUI to the 20th year of the mortgage on the interactive graphical model on the GUI, the asset management application dynamically determines and displays the amount the user would gain as $167,036.89. If the user slides the slider wheel icon on the GUI to the 30th year of the mortgage on the interactive graphical model on the GUI, the asset management application dynamically determines and displays the amount the user would gain as $276,189.99. The asset management application calculates the amount the user would gain, for example, using the formula:

Amount gained by the user=sale price−remaining amount on the loan−real estate agent's fees−closing costs.

FIG. 1C illustrates another embodiment of the computer implemented method for monitoring and managing a user's assets. The computer implemented method disclosed herein comprises steps 101, 102, 103, 104, and 105 as disclosed in the detailed description of FIG. 1A. After receiving 103 inputs associated with an asset, determining 104 one or more financial components of expenditure based on the received inputs, and dynamically rendering 105 one or more interactive graphical models based on the determined financial components of expenditure, the asset management application facilitates 110 communication of the dynamically rendered interactive graphical models of the determined financial components of expenditure and updates thereof between the users and one or more financial entities and/or one or more other users via a network, for example, the internet, a mobile communication network, etc. For example, the asset management application facilitates communications between the users and one or more financial entities such as banks regarding, for example, loan offers, the interactive graphical models, etc., and also facilitates manipulation of the communicated interactive graphical models via the network. The asset management application also communicates one or more financial scenarios, for example, loan offers for loan products, etc., to one or more other users via the network, for example, via electronic mail (email), a prompt provided on the GUI when the other users log into the asset management application, etc.

The asset management application enables users to contact professionals, other users, financial entities, etc., communicate with them via the GUI of the asset management application, and perform offline transactions online. Users can email professionals, other users, financial entities, etc., and obtain notifications from the professionals, other users, financial entities, etc., through the asset management application. The professionals can obtain notifications from the user in their accounts through the asset management application. A user can also send an interactive scenario to a mortgage professional who is listed on the GUI, and the mortgage professional can send back a quote, or two quotes compared. The users can then save the quotes in their accounts, keep track of who they have contacted on the asset management application, and receive alerts.

In another embodiment, the asset management application displays brand advertisements of multiple financial entities on the GUI for generating revenue. The brand advertisements display, for example, contact information and reviews about each financial entity to enable the users to select, for example, financial advisors, financial professionals, etc., to contact and seek advice.

Consider an example where a user saves a financial scenario based on a comparative analysis performed by the asset management application. The saved financial scenario comprises one or more interactive graphical models. The asset management application facilitates communication of the saved interactive graphical models over a network, whereby the user can email or transmit through the asset management application to another user account, the interactive graphical models saved to a financial professional for seeking advice on a loan undertaken on the user's asset. The communicated interactive graphical model can be opened by the financial professional dynamically and the financial professional can view the modifications performed by him/her to better understand the financial scenario sent by the user. The financial professional can then send back the interactive graphical model with suggestions and comments to the user over the network.

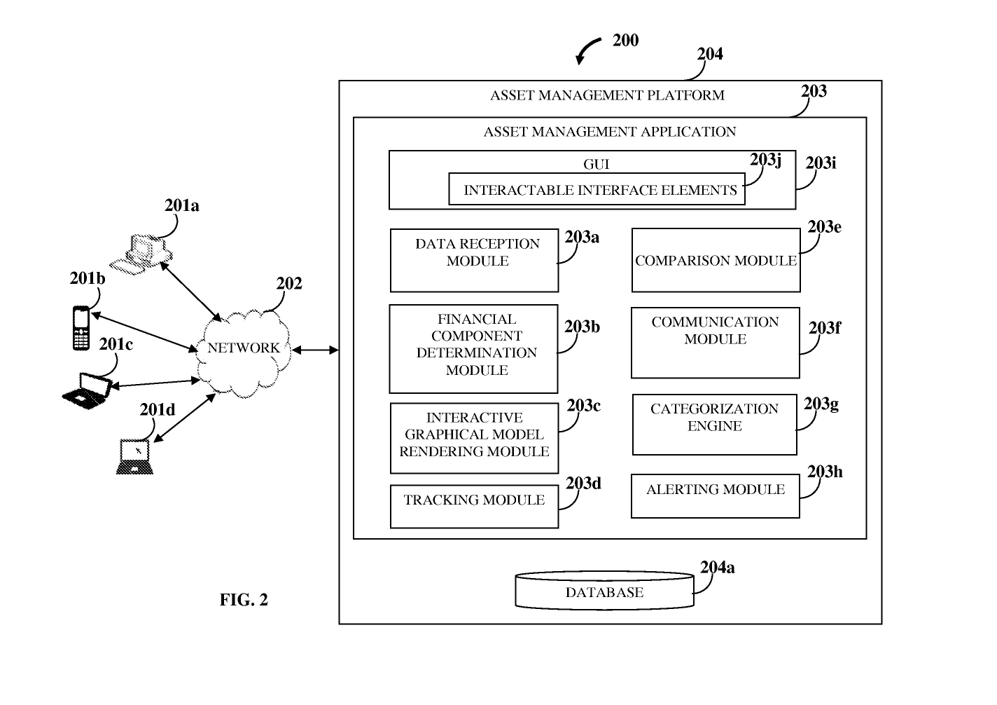

FIG. 2 exemplarily illustrates a computer implemented system 200 for monitoring and managing a user's assets. The computer implemented system 200 disclosed herein comprises at least one processor, a non-transitory computer readable storage medium communicatively coupled to the processor, and an asset management application 203. The non-transitory computer readable storage medium is configured to store modules 203a, 203b, 203c, 203d, 203e, 203f, 203g, 203h, 203i, 203j, etc., of the asset management application 203. The processor executes the modules 203a, 203b, 203c, 203d, 203e, 203f, 203g, 203h, 203i, 203j, etc., of the asset management application 203. In an embodiment, the asset management application 203 is implemented on a web based platform, for example, an asset management platform 204 as exemplarily illustrated in FIG. 2. The asset management platform 204 hosts the asset management application 203. The asset management application 203 is accessible to one or more user devices, for example, a computer 201a, a mobile phone 201b, laptops 201c and 201d, etc., for example, over a network 202, for example, the internet, a network that implements Wi-Fi® of the Wireless Ethernet Compatibility Alliance, Inc., a mobile telecommunication network, etc. The asset management application 203 is accessible through multiple browsers, for example, Internet Explorer® (IE) 7, IE 8, and IE 9 of Microsoft Corporation, Mozilla® Firefox® of Mozilla Foundation, Safari® of Apple Inc., Chrome of Google, Inc., etc., and is compatible with technologies, for example, hypertext markup language 5 (HTML5), etc. In an embodiment, the asset management application 203 is configured as a software application, for example, a mobile application downloadable on the user device, for example, 201a, 201b, 201c, or 201d.

The asset management application 203 comprises modules 203a, 203b, 203c, 203d, 203e, 203f, 203g, 203h, 203i, 203j, etc., executable by the processor configured to monitor and manage the user's assets. The asset management application 203 comprises a graphical user interface (GUI) 203i, a data reception module 203a, a financial component determination module 203b, an interactive graphical model rendering module 203c, a tracking module 203d, a comparison module 203e, a communication module 203f, a categorization engine 203g, and an alerting module 203h. The GUI 203i is, for example, a webpage of a website hosted by the asset management application 203, an online web interface, a web based downloadable application interface, a mobile based downloadable application interface, etc. The GUI 203i comprises multiple interactable interface elements 203j configured to enable configuration and access of asset information and computations via the user device, for example, 201a, 201b, 201c, or 201d.

The data reception module 203a receives inputs associated with an asset from the user device, for example, 201a, 201b, 201c, or 201d via the GUI 203i. The inputs comprise, for example, provisions of an adjustable rate loan on the asset or a fixed rate loan on the asset, parameters defining a term of a loan such as a loan start date and a loan end date, a price of an asset, a down payment, a term of the fixed rate loan or the adjustable rate loan, an interest rate for the fixed rate loan or the adjustable rate loan, an amount of asset tax, a tax bracket, state of the asset, city of the asset, county of the asset, fees of the asset, condominium fees of a property asset or housing cooperative fees of the property asset, tax information, prospective financial parameters, etc.

The financial component determination module 203b determines one or more of multiple financial components of expenditure comprising, for example, an amount of loan required, a monthly loan payment, a payment over a configurable duration of time, an amount of asset tax, an amount of an interest rate deduction for a loan, an amount of tax deduction from tax deductable housing cooperative fees, an amount of equity available to the user at a point in the configurable duration of time, an amount of the equity spent by the user at a point in the configurable duration of time, a break-even point, an amount of income needed at a configurable stage in the configurable duration of time to enable the user to repay the loan within a term of the loan, a fixed rate loan payment over the term of the loan, an adjustable rate loan payment over the term of the loan, loans available in different geographical locations, time of refinancing of the loan, etc., based on one or more of the received inputs associated with the asset and/or a geographical location of the asset and/or the user. The interactive graphical model rendering module 203c dynamically renders one or more interactive graphical models of the determined financial components of expenditure. The dynamically rendered interactive graphical models of the determined financial components of expenditure are configurably accessible and modifiable on the GUI 203i via the user device, for example, 201a, 201b, 201c, or 201d, using one or more of the interactable interface elements 203j. The data reception module 203a further receives at least one input on the dynamically rendered interactive graphical models of the determined financial components of expenditure from the user device, for example, 201a, 201b, 201c, or 201d via the GUI 203i. The financial component determination module 203b further dynamically updates the determined financial components of expenditure based on the received input.

The data reception module 203a further receives loan quotes received by the user from one or more external sources via the GUI 203i. The data reception module 203a further receives selections of one or more of the received loan quotes from the user device, for example, 201a, 201b, 201c, or 201d via the GUI 203i. The financial component determination module 203b determines one or more of the financial components of expenditure for the selected loan quotes. The interactive graphical model rendering module 203c dynamically renders an interactive graphical model of each of the determined financial components of expenditure for each of the selected loan quotes for performing a comparative analysis of the determined financial components of expenditure for the selected loan quotes. The interactive graphical model rendering module 203c further toggles display of the dynamically rendered interactive graphical models of the determined financial components of expenditure on the GUI 203i based on a selectable index associated with each of the determined financial components of expenditure.

The financial component determination module 203b also determines an estimate amount for selling an asset at a configurable point in time selected via the user device, for example, 201a, 201b, 201c, or 201d using the interactable interface elements 203j positioned on the dynamically rendered interactive graphical models of the determined financial components of expenditure. The financial component determination module 203b further determines one or more financial outcomes of a sale of the asset at a configurable point in time based on one or more of the received inputs associated with the asset and/or a geographical location of the asset. The interactive graphical model rendering module 203c dynamically renders one or more interactive graphical models of the determined financial outcomes of the sale of the asset. The dynamically rendered interactive graphical models of the determined financial outcomes of the sale of the asset are configurably accessible and modifiable on the GUI 203i via the user device, for example, 201a, 201b, 201c, or 201d using one or more of the interactable interface elements 203j. The data reception module 203a further receives at least one input on the dynamically rendered interactive graphical models of the determined financial outcomes of the sale of the asset from the user device, for example, 201a, 201b, 201c, or 201d via the GUI 203i. The financial component determination module 203b further dynamically updates the determined financial outcomes of the sale of the asset based on the received input.

The tracking module 203d tracks changes made to the inputs associated with the asset on the GUI 203i via the user device, for example, 201a, 201b, 201c, or 201d over the configurable duration of time. The financial component determination module 203b redetermines the financial components of expenditure based on the tracked changes. The interactive graphical model rendering module 203c dynamically updates the tracked changes and the redetermined financial components of expenditure to the dynamically rendered interactive graphical models. The comparison module 203e performs a comparative analysis of associated financial components of expenditure over a configurable duration of time using the dynamically rendered interactive graphical models of the associated financial components of expenditure. The comparison module 203e further dynamically renders a comparative analytical report based on the comparative analysis. The categorization engine 203g categorizes the determined financial components of expenditure, for example, based on the geographical location.

The communication module 203f facilitates communication of one or more financial scenarios between the user and one or more financial entities and/or other users via the network 202. The communication module 203f further facilitates communication of the dynamically rendered interactive graphical models of the determined financial components of expenditure and updates thereof between the user and one or more financial entities and/or other users via the network 202. The communication module 203f further transmits one or more notifications on asset information and supplementary financial information to the user device, for example, 201a, 201b, 201c, or 201d via the GUI 203i and/or the network 202. The alerting module 203h generates alerts based on events associated with the received inputs associated with the asset, the determined financial components of expenditure, and the dynamically rendered interactive graphical models of the determined financial components of expenditure stored in a database 204a. The alerting module 203h further transmits the generated alerts to the user device, for example, 201a, 201b, 201c, or 201d via the GUI 203i and/or the network 202.

The asset management platform 204 comprises the database 204a. The database 204a, in communication with the asset management application 203, stores user information, advisory information, the received inputs associated with the asset, the determined financial components of expenditure, and the dynamically rendered interactive graphical models of the determined financial components of expenditure. The database 204a further facilitates retrieval of the stored user information, the stored advisory information, the stored received inputs associated with the asset, the stored financial components of expenditure, and the stored interactive graphical models of the determined financial components of expenditure. The database 204a is, for example, a structured query language (SQL) data store or a not only SQL (NoSQL) data store such as the Microsoft® SQL Server®, the Oracle® servers, the MySQL® database of MySQL AB Company, the MongoDB® of 10gen, Inc., the Neo4j graph database, the Cassandra database of the Apache Software Foundation, the HBase™ database of the Apache Software Foundation, etc. In an embodiment, the database 204a can also be a location on a file system. The database 204a is any storage area or medium that can be used for storing data and files. In another embodiment, the database 204a can be remotely accessed by the asset management application 203 via the network 202. In another embodiment, the database 204a is configured as a cloud based database implemented in a cloud computing environment, where computing resources are delivered as a service over the network 202, for example, the internet.

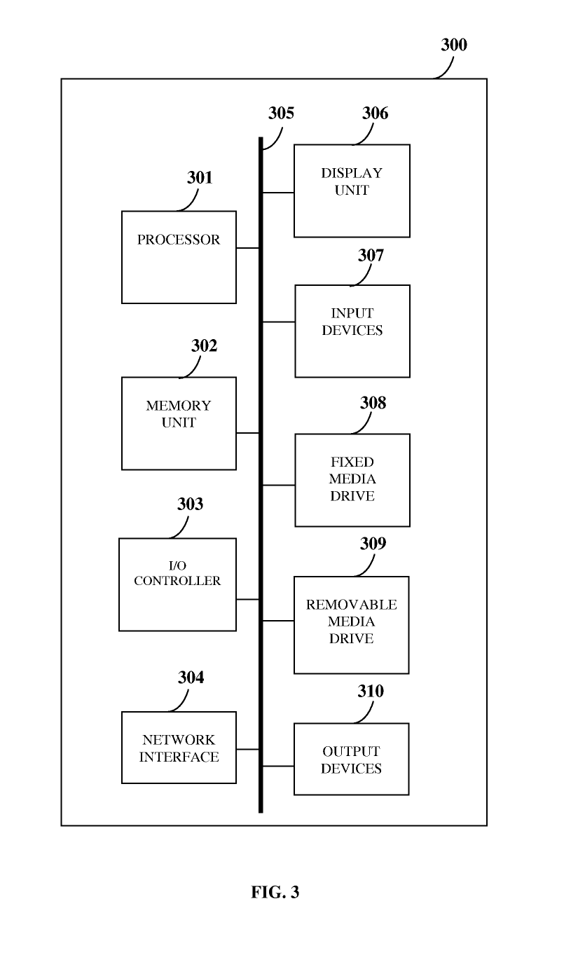

FIG. 3 exemplarily illustrates the architecture of a computer system 300 employed by the asset management application 203 for monitoring and managing a user's assets. The asset management application 203 of the computer implemented system 200 exemplarily illustrated in FIG. 2 employs the architecture of the computer system 300 exemplarily illustrated in FIG. 3. The computer system 300 is programmable using a high level computer programming language. The computer system 300 may be implemented using programmed and purposeful hardware.

The asset management platform 204 hosting the asset management application 203 communicates with user devices, for example, 201a, 201b, 201c, etc., of a user, for example, a property buyer who requires or is under a mortgage loan for purchasing a property, etc., a student who requires or is under a student loan, etc., registered with the asset management application 203 via the network 202, for example, a short range network or a long range network. The network 202 is, for example, the internet, a local area network, a wide area network, a wired network, a wireless network, a mobile communication network, etc. The computer system 300 comprises, for example, a processor 301, a memory unit 302 for storing programs and data, an input/output (I/O) controller 303, a network interface 304, a data bus 305, a display unit 306, input devices 307, a fixed media drive 308, a removable media drive 309 for receiving removable media, output devices 310, etc.

The term “processor” refers to any one or more microprocessors, central processing unit (CPU) devices, finite state machines, computers, microcontrollers, digital signal processors, logic, a logic device, an electronic circuit, an application specific integrated circuit (ASIC), a field-programmable gate array (FPGA), a chip, etc., or any combination thereof, capable of executing computer programs or a series of commands, instructions, or state transitions. The processor 301 may also be implemented as a processor set comprising, for example, a general purpose microprocessor and a math or graphics co-processor. The processor 301 is selected, for example, from the Intel® processors such as the Itanium® microprocessor or the Pentium® processors, Advanced Micro Devices (AMD®) processors such as the Athlon® processor, UltraSPARC® processors, MicroSPARC® processors, hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, etc. The computer implemented system 200 disclosed herein is not limited to a computer system 300 employing a processor 301. The computer system 300 may also employ a controller or a microcontroller.

The memory unit 302 is used for storing programs, applications, and data. For example, the data reception module 203a, the financial component determination module 203b, the interactive graphical model rendering module 203c, the tracking module 203d, the comparison module 203e, the communication module 203f, the categorization engine 203g, the alerting module 203h, etc., of the asset management application 203 are stored in the memory unit 302. The memory unit 302 is, for example, a random access memory (RAM) or another type of dynamic storage device that stores information and instructions for execution by the processor 301. The memory unit 302 also stores temporary variables and other intermediate information used during execution of the instructions by the processor 301. The computer system 300 further comprises a read only memory (ROM) or another type of static storage device that stores static information and instructions for the processor 301.

The I/O controller 303 controls input actions and output actions performed by the asset management application 203. The network interface 304 enables connection of the computer system 300 to the network 202. For example, the asset management platform 204 hosting the asset management application 203 connects to the network 202 via the network interface 304. In an embodiment, the network interface 304 is provided as an interface card also referred to as a line card. The network interface 304 comprises, for example, one or more of an infrared (IR) interface, an interface implementing Wi-Fi® of the Wireless Ethernet Compatibility Alliance, Inc., a universal serial bus (USB) interface, a FireWire® interface of Apple, Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, and Ethernet communication interfaces, asynchronous transfer mode (ATM) interfaces, a high-speed serial interface (HSSI), a fiber distributed data interface (FDDI), interfaces based on transmission control protocol (TCP)/internet protocol (IP), interfaces based on wireless communications technology such as satellite technology, radio frequency (RF) technology, near field communication, etc. The data bus 305 permits communications between the modules, for example, 203a, 203b, 203c, 203d, 203e, 203f, 203g, 203h, 203i, etc., of the asset management application 203.

The display unit 306, via the graphical user interface (GUI) 203i, displays information, display interfaces, interactable interface elements 203j such as text fields, checkboxes, drop down menus, text boxes, floating windows, hyperlinks, slider elements such as a slider wheel icon, a slider window, etc., for example, for allowing a user to enter inputs associated with an asset. The display unit 306 comprises, for example, a liquid crystal display, a plasma display, an organic light emitting diode (OLED) based display, etc. The input devices 307 are used for inputting data into the computer system 300. A user, for example, a property buyer who requires or is under a mortgage loan for buying a property, etc., a student who requires or is under a student loan, etc., registered with the asset management application 203 uses one or more of the input devices 307 of the user devices, for example, 201a, 201b, 201c, etc., to provide inputs to the asset management application 203. For example, a user may enter profile information, financial information, enter loan details, enter loan quotes, provide selections of the loan quotes, upload a loan scenario to seek advice, establish communication with financial entities, etc., using the input devices 307. The input devices 307 are, for example, a keyboard such as an alphanumeric keyboard, a joystick, a pointing device such as a computer mouse, a touch pad, a light pen, a physical button, a pointing device, a touch sensitive display device, a track ball, a pointing stick, any device capable of sensing a tactile input, etc.

Computer applications and programs are used for operating the computer system 300. The programs are loaded onto the fixed media drive 308 and into the memory unit 302 of the computer system 300 via the removable media drive 309. In an embodiment, the computer applications and programs may be loaded directly via the network 202. Computer applications and programs are executed by double clicking a related icon displayed on the display unit 306 using one of the input devices 307. The output devices 310 output the results of operations performed by the asset management application 203.

The processor 301 executes an operating system, for example, the Linux® operating system, the Unix® operating system, any version of the Microsoft® Windows® operating system, the Mac OS of Apple Inc., the IBM® OS/2, VxWorks® of Wind River Systems, inc., QNX Neutrino® developed by QNX Software Systems Ltd., Palm OS®, the Solaris operating system developed by Sun Microsystems, Inc., the Android operating system, Windows Phone™ operating system of Microsoft Corporation, BlackBerry® operating system of Research in Motion Limited, the iOS operating system of Apple Inc., the Symbian® operating system of Symbian Foundation Limited, etc. The computer system 300 employs the operating system for performing multiple tasks. The operating system is responsible for management and coordination of activities and sharing of resources of the computer system 300. The operating system further manages security of the computer system 300, peripheral devices connected to the computer system 300, and network connections. The operating system employed on the computer system 300 recognizes, for example, inputs provided by the user using one of the input devices 307, the output display, files, and directories stored locally on the fixed media drive 308, for example, a hard drive. The operating system on the computer system 300 executes different programs using the processor 301. The processor 301 and the operating system together define a computer platform for which application programs in high level programming languages are written.

The processor 301 retrieves instructions for executing the modules, for example, 203a, 203b, 203c, 203d, 203e, 203f, 203g, 203h, etc., of the asset management application 203 from the memory unit 302. A program counter determines the location of the instructions in the memory unit 302. The program counter stores a number that identifies the current position in the program of each of the modules, for example, 203a, 203b, 203c, 203d, 203e, 203f, 203g, 203h, etc., of the asset management application 203. The instructions fetched by the processor 301 from the memory unit 302 after being processed are decoded. The instructions are stored in an instruction register in the processor 301. After processing and decoding, the processor 301 executes the instructions. For example, the data reception module 203a defines instructions for receiving inputs associated with an asset from the user device 201a, 201b, 201c, or 201d via the GUI 203i. Furthermore, the data reception module 203a defines instructions for receiving loan quotes received by the user from one or more external sources and selections of one or more of the received loan quotes from the user device 201a, 201b, 201c, or 201d via the GUI 203i. The financial component determination module 203b defines instructions for determining one or more financial components of expenditure comprising, for example, an amount of loan required, a monthly loan payment, a fixed rate loan payment over the term of the loan, an adjustable rate loan payment over the term of the loan, etc., over a configurable duration of time based on one or more of the received inputs associated with the asset and/or a geographical location of the asset and/or the user. The financial component determination module 203b also defines instructions for determining one or more of the financial components of expenditure for the loan quotes selected by the user. Furthermore, the financial component determination module 203b defines instructions for determining an estimate amount for selling an asset at a configurable point in time selected via the user device 201a, 201b, 201c, or 201d using one or more of the interactable interface elements 203j positioned on the dynamically rendered interactive graphical models of the determined financial components of expenditure.

The interactive graphical model rendering module 203c defines instructions for dynamically rendering one or more interactive graphical models of the determined financial components of expenditure. Furthermore, the interactive graphical model rendering module 203c defines instructions for dynamically generating an interactive graphical model of each of the determined financial components of expenditure for each of the selected loan quotes for performing a comparative analysis of the determined financial components of expenditure for the selected loan quotes. Furthermore, the interactive graphical model rendering module 203c defines instructions for toggling display of the dynamically rendered interactive graphical models of the determined financial components of expenditure on the GUI 203i based on a selectable index associated with the determined financial components of expenditure.

Furthermore, the financial component determination module 203b also defines instructions for determining one or more financial outcomes of a sale of an asset at a configurable point in time based on one or more received inputs associated with the asset and/or a geographical location of the asset. The interactive graphical model rendering module 203c defines instructions for dynamically rendering one or more interactive graphical models of the determined financial outcomes of the sale of the asset. Furthermore, the data reception module 203a defines instructions for receiving at least one input on the dynamically rendered interactive graphical models of the determined financial components of expenditure and/or the determined financial outcomes of the sale of the asset from the user device, for example, 201a, 201b, 201c, or 201d via the GUI 203i. The financial component determination module 203b also defines instructions for dynamically updating the determined financial components of expenditure and/or the determined financial outcomes of the sale of the asset based on the received input.

The tracking module 203d defines instructions for tracking changes made to the inputs associated with the asset on the GUI 203i via the user device 201a, 201b, 201c, or 201d over a configurable duration of time. Furthermore, the financial component determination module 203b defines instructions for redetermining the financial components of expenditure based on the tracked changes. Furthermore, the interactive graphical model rendering module 203c defines instructions for dynamically updating the tracked changes and the redetermined financial components of expenditure to the dynamically rendered interactive graphical models. The comparison module 203e defines instructions for performing a comparative analysis of two or more of the interactive graphical models of the determined financial components of expenditure over a configurable duration of time and for dynamically rendering a comparative analytical report based on the comparative analysis. The categorization engine 203g defines instructions for categorizing the determined financial components of expenditure based on geographical locations. The communication module 203f defines instructions for facilitating communication of one or more financial scenarios between the user and one or more financial entities and/or other users via the network 202. Furthermore, the communication module 203f defines instructions for transmitting one or more notifications on the asset information and supplementary financial information to the user device 201a, 201b, 201c, or 201d via the GUI 203i and/or the network 202. Furthermore, the communication module 203f defines instructions for facilitating communication of the dynamically rendered interactive graphical models of the determined financial components of expenditure and updates thereof between the user and one or more financial entities and/or other users via the network 202.

The alerting module 203h defines instructions for generating alerts based on events associated with the received inputs associated with the asset, the determined financial components of expenditure, and the dynamically rendered interactive graphical models of the determined financial components of expenditure stored in the database 204a. Furthermore, the alerting module 203h defines instructions for transmitting the generated alerts to the user device 201a, 201b, 201c, or 201d via the GUI 203i and/or the network 202.

The processor 301 of the computer system 300 employed by the asset management application 203 retrieves the instructions defined by the data reception module 203a, the financial component determination module 203b, the interactive graphical model rendering module 203c, the tracking module 203d, the comparison module 203e, the communication module 203f, the categorization engine 203g, and the alerting module 203h of the asset management application 203, and executes the instructions, thereby performing one or more processes defined by those instructions.

At the time of execution, the instructions stored in the instruction register are examined to determine the operations to be performed. The processor 301 then performs the specified operations. The operations comprise arithmetic operations and logic operations. The operating system performs multiple routines for performing a number of tasks required to assign the input devices 307, the output devices 310, and memory for execution of the modules, for example, 203a, 203b, 203c, 203d, 203e, 203f, 203g, 203h, 203i, 203j, etc., of the asset management application 203. The tasks performed by the operating system comprise, for example, assigning memory to the modules, for example, 203a, 203b, 203c, 203d, 203e, 203f, 203g, 203h, 203i, 203j, etc., of the asset management application 203, and to data used by the asset management application 203, moving data between the memory unit 302 and disk units, and handling input/output operations. The operating system performs the tasks on request by the operations and after performing the tasks, the operating system transfers the execution control back to the processor 301. The processor 301 continues the execution to obtain one or more outputs. The outputs of the execution of the modules, for example, 203a, 203b, 203c, 203d, 203e, 203f, 203g, 203h, etc., of the asset management application 203 are displayed on the display unit 306 to the user.

For purposes of illustration, the detailed description refers to the asset management application 203 being run locally on a computer system 300; however the scope of the computer implemented method and system 200 disclosed herein is not limited to the asset management application 203 being run locally on the computer system 300 via the operating system and the processor 301, but may be extended to run remotely over the network 202 by employing a web browser and a remote server, a mobile phone, or other electronic devices. One or more portions of the computer system 300 may be distributed across one or more computer systems (not shown) coupled to the network 202.

Disclosed herein is also a computer program product comprising a non-transitory computer readable storage medium that stores computer program codes comprising instructions executable by at least one processor 301 for monitoring and managing assets of a user. As used herein, the term “non-transitory computer readable storage medium” refers to all computer readable media, for example, non-volatile media such as optical discs or magnetic disks, volatile media such as a register memory, a processor cache, etc., and transmission media such as wires that constitute a system bus coupled to the processor 301, except for a transitory, propagating signal.

The computer program product disclosed herein comprises a first computer program code for receiving inputs associated with an asset comprising, for example, provisions of an adjustable rate loan on the asset or a fixed rate loan on the asset, from a user device 201a, 201b, 201c, or 201d via the GUI 203i; a second computer program code for determining one or more financial components of expenditure over a configurable duration of time based on one or more of the received inputs associated with the asset and/or a geographical location of the asset and/or the user; and a third computer program code for dynamically rendering one or more interactive graphical models of the determined financial components of expenditure. In an embodiment, the computer program product disclosed herein further comprises a fourth computer program code for determining one or more financial outcomes of a sale of the asset at a configurable point in time based on one or more of the received inputs associated with the asset and/or the geographical location of the asset; a fifth computer program code for dynamically rendering one or more interactive graphical models of the determined financial outcomes of the sale of the asset; a sixth computer program code for receiving at least one input on the dynamically rendered interactive graphical models of the determined financial outcomes of the sale of the asset from the user device 201a, 201b, 201c, or 201d via the GUI 203i; and a seventh computer program code for dynamically updating the determined financial outcomes of the sale of the asset based on the received input.

In an embodiment, the computer program product disclosed herein further comprises an eighth computer program code for facilitating communication of the dynamically rendered interactive graphical models of the determined financial components of expenditure and updates thereof between the user and one or more financial entities and/or other users via a network 202. The computer program product disclosed herein further comprises one or more additional computer program codes for performing additional steps that may be required and contemplated for monitoring and managing a user's assets. In an embodiment, a single piece of computer program code comprising computer executable instructions performs one or more steps of the computer implemented method disclosed herein for monitoring and managing the user's assets. The computer program codes comprising computer executable instructions are embodied on the non-transitory computer readable storage medium. The processor 301 of the computer system 300 retrieves these computer executable instructions and executes them. When the computer executable instructions are executed by the processor 301, the computer executable instructions cause the processor 301 to perform the steps of the computer implemented method for monitoring and managing the user's assets.

FIG. 4 exemplarily illustrates a screenshot of a graphical user interface (GUI) 203i provided by the asset management application 203 exemplarily illustrated in FIG. 2, displaying a home page of the asset management application 203. The home page facilitates registration of a user and provides an overview of the features of the asset management application 203. A user registers with the asset management application 203 via the GUI 203i by clicking on a “Create account” link provided on the GUI 203i and entering user information, for example, a first name, an electronic mail (email) address, a password, an email notification, an indication on a check box that provides an option to receive emails of offers and notices, an indication on a user agreement link, etc. A registered user can directly log in to the asset management application 203 via a “log in” option provided on the GUI 203i by entering an email address and a password in the “Email address” and “Password” respectively displayed on the GUI 203i. The GUI 203i displays multiple options for monitoring and managing the user's assets. For example, the GUI 203i provides a “Home Buyers” tab to a user who wants to understand ownership costs, compare loan quotes received from one or more financial entities, understand and analyze a loan that the user has taken, etc.; a “Home Owners” tab to a user who has an equity in an asset under a loan and wants to explore refinancing options, compare refinance quotes received from one or more financial entities etc.; a “Mortgage Process” tab configured to enable the user to understand a mortgage process in a step by step manner and track the progress made by the user; a “Resources” tab for enabling a user to store and/or review informative articles related to a loan, news, and finance concepts; a “My stuff” tab configured to enable the user to retrieve and view stored financial scenarios, etc. In an embodiment, the asset management application 203 provides access to the “My stuff” tab to only registered users.

The GUI 203i also displays options on the home page for home buyers and home owners. These options enlist the main functions hyperlinked on each of the two tabs as stated above. These functions are enlisted, for example, as “Home buyer planning”, “Compare two mortgages”, and “Understand and compare quotes” under the “Home Buyers” option, and “Explore refinancing options”, “Understand a quote”, and “Compare two quotes” under the “Home Owners” option, etc. The user can click on a “More” button displayed in each of these options to directly navigate to an introductory “Get started” page on the “Home Buyers” and “Home Owners” tabs respectively. The “Get started page” informs the users about the features provided by each of these tabs using hyperlinks. The user can view a video explaining the main features of the asset management application 203 via a video link displayed on the GUI 203i. On clicking the video link, the asset management application 203 opens a new window. The GUI 203i also displays options for viewing updated overnight mortgage rates, trending articles and reviews, providing feedback, etc.

FIG. 5A exemplarily illustrates a screenshot of a graphical user interface (GUI) 203i provided by the asset management application 203 exemplarily illustrated in FIG. 2, for receiving inputs associated with an asset from a user to determine financial components of expenditure. The asset management application 203 displays a “My Account” interface element such as a button, a link, an icon, etc., on the GUI 203i to allow the user to access the user's account. When the user clicks on the “My Account” link, the asset management application 203 directs the user to a web page with fields to allow the user to enter a user name, an electronic mail (email) identifier (ID), and a password for authentication. The “My Account” web page also allows the user to edit the user name and the user email ID, to change password, and to add text/images. The user performs tasks related to purchasing of an asset via the “Home Buyers” tab that displays options for an introductory “Get started” page, an “Ownership costs” page, and a “Mortgage quotes” page. When the user clicks on the “Ownership costs” tab, the asset management application 203 provides a stepwise display. The user enters the inputs associated with the asset by populating the fields exemplarily illustrated in FIG. 5A. The user inputs values in various fields displayed on the GUI 203i. For example, the user inputs a $300,000 value in a “Home price” field, 20% in a “% Down payment” field, 3.52% in an “Interest rate” field, $0 in an “Annual property tax” field, and selects a 30 year fixed option for “Type of Mortgage” field. When the user populates either of the fields “% Down payment” or “Down payment”, the other field is automatically populated, for example, by entering 20% in the “% Down payment” field for a home price of $300,000, the asset management application 203 automatically determines and populates the “Down payment” field as $60000.

The user can provide additional inputs associated with an asset, for example, a $0 for the drop down menu of “Monthly expenses” field that displays options for condo fees, maintenance, insurance, etc. The user may also access a link “Include mortgage interest deduction” and enter values in a “Household income” field, a “total deductions in the first year of mortgage” field, and a “total deductions in the last year of mortgage” field, and select an option from a drop down menu for “filing type” field that displays options, for example, single, married and filing jointly, married and filing separately, head of household, etc. A window on the GUI 203i displays “Mortgage overnight averages” showing the interest rates for different types of mortgages. Once the user enters the inputs associated with the asset in the field on the GUI 203i, the asset management application 203 determines the user's financial components of expenditure and renders the determined values on the GUI 203i. For example, for the above inputs associated with the asset, the asset management application 203 determines and renders a $1080.39 in the “mortgage payment” field+$0 in the “Monthly property tax” field+$0 in the “Monthly expenses” field=$1080.39 in the “My monthly payment” field, a $148,939.41 in the “Total interest for 30 years” field, and $448940.40 in the “Total cost for 30 years” field. The user can visualize the financial components of expenditure determined by the asset management application 203 in an interactive graphical model 501 rendered by the asset management application 203 as exemplarily illustrated in FIG. 5B.

FIG. 5B exemplarily illustrates a screenshot of the graphical user interface (GUI) 203i provided by the asset management application 203 exemplarily illustrated in FIG. 2, showing an interactive graphical model 501 of a financial component of expenditure. The user can understand his/her $ and mortgage product over time via the interactive graphical model 501 having its X axis showing the number of years of the user's mortgage and a Y axis showing the user's monthly mortgage payment. The interactive graphical model 501 comprises a graph with a tapering nature showing monthly amount of interest over a period of time, a gradually increasing principal as a result of building equity over time, total spent on the mortgage including down payment, a slider window 502 accessible via a slider wheel icon 503 that displays changes in values of interest and principal with respect to time as the user slides the slider wheel icon 503 over the interactive graphical model 501. In an example, for Year 1 Month 1, the slider window 502 displays a “Principal payment” as $376.39, “Interest payment” as $704, “Equity” as $60377, and “Total spent” as $61080.39. The asset management application 203 also enables the user to save financial scenarios in the database 204a exemplarily illustrated in FIG. 2, transmit the financial scenarios via electronic mail, communicate the financial scenarios with other users and financial entities, compare multiple financial scenarios, etc., using the options displayed on the GUI 203i as exemplarily illustrated in FIG. 5B.

FIGS. 6A-6B exemplarily illustrate screenshots of a graphical user interface (GUI) 203i provided by the asset management application 203 exemplarily illustrated in FIG. 2, showing tracking and updating of changes made to the received inputs associated with an asset to the interactive graphical model 501 shown in FIG. 5B. Consider an example where a user enters the inputs associated with an asset by populating various fields displayed on the GUI 203i. For example, the user enters $300,000 in the “Home price” field, 20% in the “% Down payment” field, 2.76% in the “Interest rate” field, and $0 for “Annual property tax” field on the GUI 203i as exemplarily illustrated in FIG. 6A. The user changes the “Type of Mortgage” field from a 30 year fixed rate mortgage as disclosed in the detailed description of FIGS. 5A-5B to a 15 year fixed rate mortgage as exemplarily illustrated in FIG. 6A. The asset management application 203 tracks changes made to the inputs associated with the asset on the GUI 203i over a configurable duration of time, redetermines the financial components of expenditure based on the tracked changes, and dynamically updates the tracked changes and the redetermined financial components of expenditure to the dynamically rendered interactive graphical models 501 as exemplarily illustrated in FIG. 6B. The asset management application 203 automatically redetermines and renders the financial components of expenditure as follows: $1833. 56 “mortgage payment”+$0 “Monthly property tax”+$0 for “Monthly expenses”=a monthly payment of $1833.56, a total interest of $60041.58 for 15 years, and a total cost of $360,040.80 for 15 years. The slider window 502 displays the updated values according to the tracked changes and the redetermined financial components of expenditure as exemplarily illustrated in FIG. 6B. For example, at Year 1 Month 1, the slider window 502 displays the principal payment as $1212.56, the interest payment as $621, the equity as $31,213, and the total spent as $31,833.56.

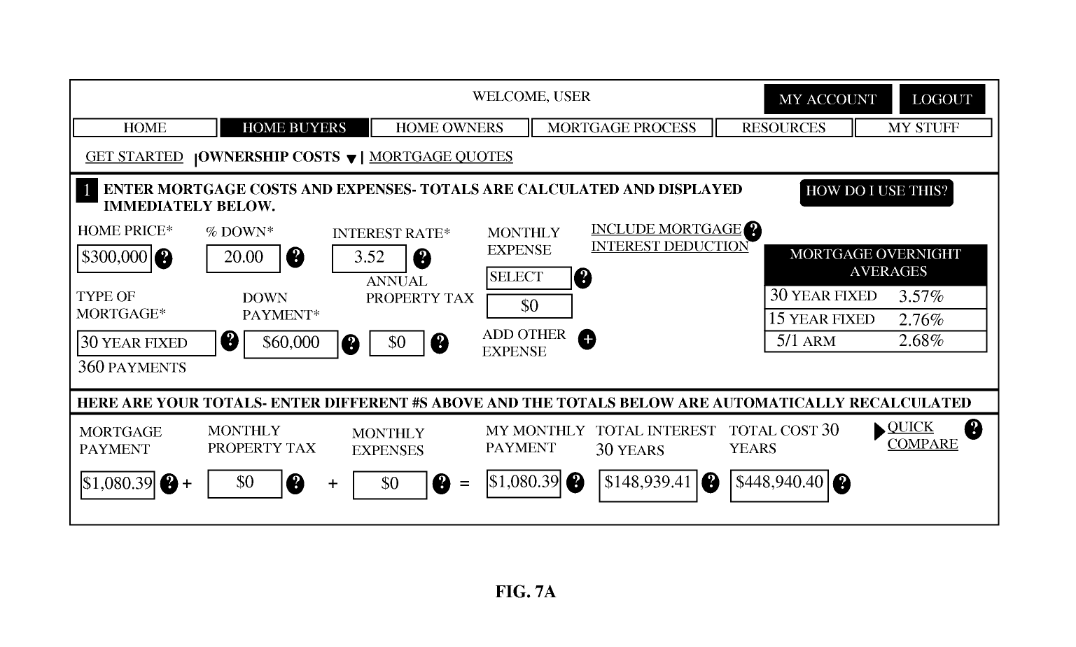

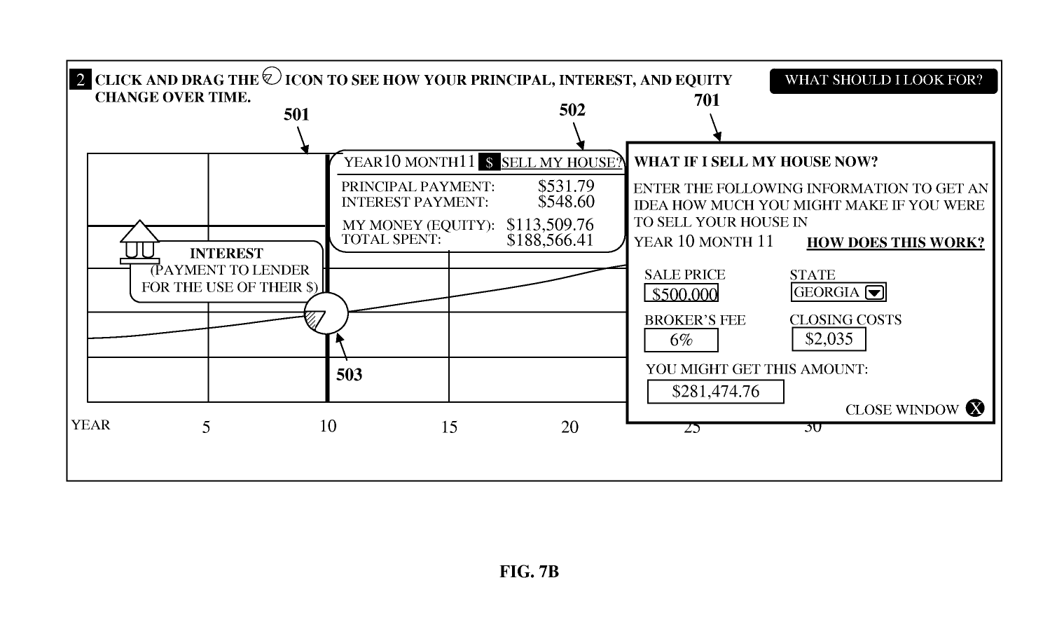

FIGS. 7A-7B exemplarily illustrate screenshots of a graphical user interface (GUI) 203i provided by the asset management application 203 exemplarily illustrated in FIG. 2, displaying interactable interface elements enabling a user to view selling price of an asset at a configurable point in time. The asset management application 203 displays an interactable interface element, for example, a “Sell My House” window 701 at a time instant selected by the user, where the user can view what they would gain at that time instant. Using the slider window 502 positioned on the dynamically rendered interactive graphical model 501, the user selects a configurable point in time, at which the asset management application 203 determines an estimate amount for selling the asset. The user enters the inputs associated with the asset by populating the fields on the GUI 203i as exemplarily illustrated in FIG. 7A. For example, the user enters a $300,000 value in the “Home price” field, 20% in “% Down payment” field, 3.52% in the “Interest rate” field, $0 in the “Annual property tax” field, and selects a 30 year fixed rate mortgage. Once the user enters the inputs associated with the asset, the asset management application 203 determines one or more financial outcomes of the sale of the asset over a configurable duration of time and renders the determined values on the GUI 203i. For example, for the above entered inputs associated with the asset, the asset management application 203 determines and renders a $1080.39 in the “mortgage payment” field+$0 in the “Monthly property tax” field+$0 in the “Monthly expenses” field=$1080.39 in the “My monthly payment” field, $148,939.41 in the “Total interest for 30 years” field, and $448,940.40 in the “Total cost for 30 years” field.

The asset management application 203 displays the determined financial outcomes of the sale of the asset in an interactive graphical model 501 rendered by the asset management application 203 as exemplarily illustrated in FIG. 7B. The slider window 502 displays changes in values of interest and principal with respect to time at a particular point where the slider window 502 is slid. For example, at Year 10 Month 11, the “Principal payment” is $531.79, the “Interest payment” is $548.60, the “Equity” is $113,509.76, and the “Total spent” is $188,566.41. On clicking a hyperlinked option “Sell My House” displayed on the slider window 502, the asset management application 203 invokes a “Sell My House” window 701 that allows the user to visualize the amount that can be gained by selling the user's house at that point in time. For example, if the user sells his/her house at Year 10 month 11 with a $500,000 sale price in the state of Georgia, with a 6% broker's fee, then the asset management application 203 determines the values for financial outcomes of sale of the asset, for example, the “closing costs” as $2035 and the user earned amount as $281,474.76 as exemplarily illustrated in FIG. 7B. The user may then close the “Sell my house” window 701 using an icon “X” provided on the “Sell my house” window 701.

The asset management application 203 determines the closing costs and the user earned amount in the “Sell My House” window 701, for example, as follows: The asset management application 203 receives inputs associated with an asset, for example, an entered sale price, etc. The asset management application 203 subtracts the remaining loan balance amount, the percentage of a broker's fee, and the estimated closing costs respective to the geographical location entered by the user. The value displayed in “The You Might Get This Amount” field is the amount the user may get back if he/she sold his/her home at the price entered for the year and month displayed. If the user owes more on the user's home than the sale price plus the real estate agent's fee and closing cost fees, then the value in the “You Might Get This Amount” field displays a negative value, indicating that the user would owe this money if the user sold his/her house at the sale price the user entered. The asset management application 203 determines the closing costs by aggregating and analyzing multiple data points stored in the database 204a recorded from real home sales at different price points and determining the values based on price and location as the closing costs vary by sale price and geographical location.

FIG. 8 exemplarily illustrates a screenshot of a graphical user interface (GUI) 203i provided by the asset management application 203 exemplarily illustrated in FIG. 2, for enabling a user to save a financial scenario associated with a loan process. The user can store user information, advisory information, the inputted asset information, the determined financial components of expenditure, and the dynamically rendered interactive graphical models 501 of the determined financial components of expenditure in the database 204a exemplarily illustrated in FIG. 2, by selecting a “Save” option provided on the GUI 203i as exemplarily illustrated in FIG. 8. The asset management application 203 determines the financial components of expenditure and renders the dynamically rendered interactive graphical models 501 on the GUI 203i as exemplarily illustrated in FIG. 5B, FIG. 6B, and FIG. 7B. The user can view and save a particular financial scenario in the database 204a by clicking the “Save” option on the GUI 203i. When the user clicks the “Save” option on the GUI 203i, the asset management application 203 displays a “Save this” pop up window 801 that provides an option to access the saved data in a “My stuff” tab, and select the saved data at a future point in time to view or compare the saved data with other financial scenarios. The asset management application 203 prompts the user to populate a “name” field in the “Save this” pop up window 801 for saving the financial scenario under that name. The user enters, for example, “Scenario 1” in the “name” field. The “Save this” pop up window 801 also displays supplementary information, for example, May 22, 2013 in the “Date of Scenario” field, $300,000 in the “Home price” field, 20% in the “% Down payment” field, 3.52% in the “Interest rate” field, a 30-year fixed type of mortgage, $0 in the “Annual property tax” field, etc., and the determined financial components of expenditure, for example, a $1080.39 in “mortgage payment” field, a $0 in “Monthly property tax” field, a $0 in “Monthly expense” field, a $1080.39 in the “My monthly payment” field, a $148,939.41 in “Total interest for 30 years” field, and a $448,940.40 in “Total cost for 30 years” field as exemplarily illustrated in FIG. 8. The “Save this” pop up window 801 also displays options for saving the financial scenario or canceling the saving process.

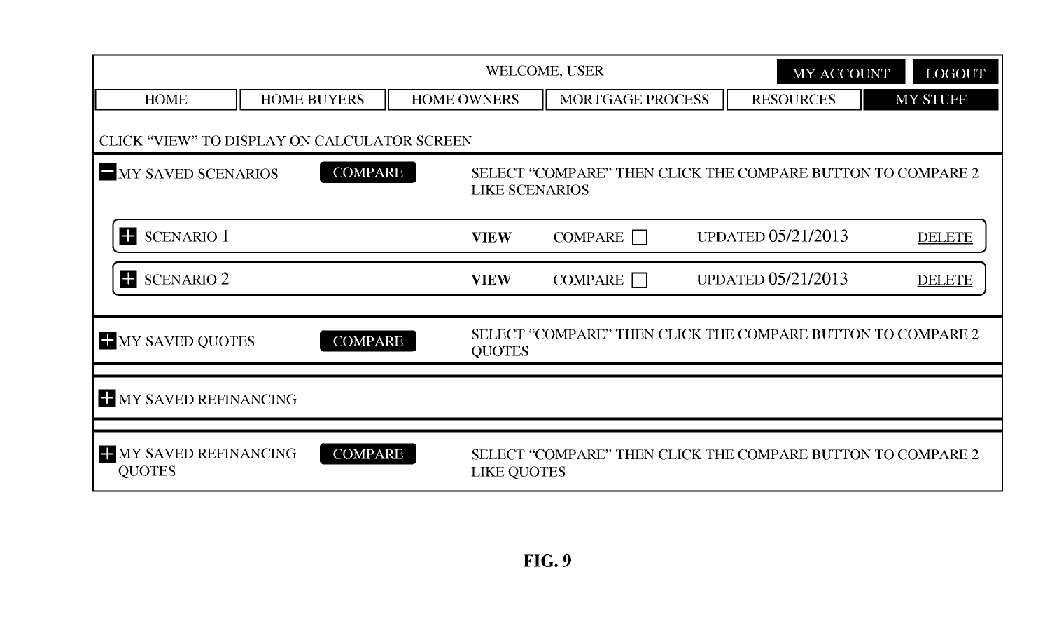

FIG. 9 exemplarily illustrates a screenshot of a graphical user interface (GUI) 203i provided by the asset management application 203 exemplarily illustrated in FIG. 2, displaying asset information saved by a user. The user can retrieve the stored user information, advisory information, the stored inputs associated with an asset, the determined financial components of expenditure, and the dynamically rendered interactive graphical models 501 of the determined financial components of expenditure from the database 204a via a “My stuff” tab provided on the GUI 203i as exemplarily illustrated in FIG. 9. The “My stuff” tab displays maximizing/minimizing +/− menus enabling the user to view, for example, the saved financial scenarios, the saved quotes, the saved refinancing, the saved refinancing quotes, etc. On expanding the +/− menus, for example, the “My saved scenarios” menu, the asset management application 203 displays a list of all the financial scenarios along with the dates on which the financial scenarios are updated and saved by the user. For example, the asset management application 203 displays Scenario 1 updated on May 21, 2013, Scenario 2 updated on May 21, 2013, etc., on the GUI 203i. The user can select two or more financial scenarios for comparison and/or editing, viewing, deleting, etc.

FIGS. 10A-10C exemplarily illustrate screenshots of a graphical user interface (GUI) 203i provided by the asset management application 203 exemplarily illustrated in FIG. 2, displaying interactable interface elements, for example, in the form of selectable indexes 1002a and 1002b enabling a user to graphically toggle between dynamically rendered interactive graphical models 1001 and 1003 of financial components of expenditure. The user can toggle display of the dynamically rendered interactive graphical models 1001 and 1003 of the determined financial components of expenditure based on a selectable index 1002a or 1002b associated with the determined financial components of expenditure as disclosed in the detailed description of FIG. 1A. The selectable indexes 1002a and 1002b represent a maximum interest rate and a stable interest rate respectively as exemplarily illustrated in FIGS. 10A-10C. As exemplarily illustrated in FIG. 10A, the user enters the inputs associated with an asset along with an index associated with adjustable rate loans. For example, the user enters a $300,000 value in the “Home price” field, 20% in the “% Down payment” field, 2.63% in the “Interest rate” field, 2% in the “maximum annual rate change” field, a 7/1 ARM in the “Type of Mortgage” field, $0 in the “Annual property tax” field, 2.5 in the “ARM margin” field, and views options for entering additional expenses. The asset management application 203 pre-populates values, for example, a 7 year period in the “#years to 1^{st} adjustment” field, a 0.7 index in the “Libor 12” field, 1 year in the “time period in between adjustments” field, and 8.63% in the “Max. Life interest rate” field on the GUI 203i exemplarily illustrated in FIG. 10A.

The asset management application 203 displays the financial components of expenditure, for example, “Mortgage payment” having a value of a $1639.98 for maximum rate and $1022.59 for stable rate+a $0 “monthly property tax”+a $0 “monthly expenses” field=“my monthly payment” having a value of $1639.98 for “maximum rate” and $1022.59 for “stable rate”, “total interest for 30 years” having a value of $285,252.59 for maximum rate and $123,259.14 for stable rate, and “total cost for 30 years” field having a value of a $585,252.60 for maximum rate and a $423259.20 for stable rate. “Mortgage payment” and “My monthly payment” field values change according to the displacement of the slider wheel icon 503 positioned on the dynamically rendered interactive graphical models 1001 and 1003 as exemplarily illustrated in FIGS. 10B-10C. As exemplarily illustrated in FIG. 10B-10C, the slider wheel icon 503 is moved to year 15 month 12 on the interactive graphical models 1001 and 1003.

As exemplarily illustrated in FIG. 10B, the dynamically rendered interactive graphical model 1001 displays an indication on the selectable index 1002a showing a maximum interest rate. FIG. 10B exemplarily illustrates the interactive graphical model 1001 for maximum interest rate with the slider window 502 displaying values for principal, interest, equity and total spent. For example, the slider window 502 displays a maximum interest rate of 8.63% and a stable interest rate of 3.20% in the “Rates” field, $448.28 in the “maximum principal payment” field, $1191.70 in the “maximum interest payment” field, $134,742.12 in the “maximum my money (equity)” field, $290,056.80 in the “maximum total spent” field, $631.48 in the “stable principal payment” field, $391.11 in the “stable interest payment” field, $153,966.75 in the “stable my money (equity)” field, and $239,193.84 in the “stable total spent” field.

As exemplarily illustrated in FIG. 10C, the dynamically rendered interactive graphical model 1003 displays an indication on the selectable index 1002b showing a stable interest rate. FIG. 10C exemplarily illustrates the interactive graphical model 1003 for a stable interest rate with the slider window 502 displaying values for principal, interest, equity and total spent. For example, the slider window 502 displays a maximum interest rate of 8.63% and a stable interest rate of 3.20% in the “Rates” field, $448.28 in the “maximum principal payment” field, $1191.70 in the “maximum interest payment” field, $134,742.12 in “maximum my money (equity)” field, $290056.80 in the “maximum total spent” field, $631.48 in the “stable principal payment” field, $391.11 in the “stable interest payment” field, $153,966.75 in the “stable my money (equity)” field, $239,193.84 in the “stable total spent” field. The interactive graphical models 1001 and 1003 exemplarily illustrated in FIGS. 10B-10C dynamically rendered for maximum and stable interest rates co-exist on the GUI 203i. The user can toggle between the two interactive graphical models 1001 and 1003 by selecting the indexes 1002a and 1002b respectively for viewing the respective interactive graphical models 1001 and 1003.

FIGS. 11A-11H exemplarily illustrate screenshots of a graphical user interface (GUI) 203i provided by the asset management application 203 exemplarily illustrated in FIG. 2, for performing a comparative analysis of one or more financial components of expenditure for monitoring and managing a user's assets. FIG. 11A exemplarily illustrates the GUI 203i displaying a page for comparing two mortgages under the “Home Buyers” tab. The asset management application 203 performs a comparative analysis of associated financial components of expenditure using the dynamically rendered interactive graphical models 1101 and 1102 of the associated financial components of expenditure and dynamically renders a comparative analytical report based on the comparative analysis. The user enters inputs associated with the asset for the fields displayed under “Mortgage 1” and the fields displayed under “Mortgage 2” on the GUI 203i. The asset management application 203 pre-populates a few fields using previously entered inputs. For example, the asset management application 203 pre-populates $300,000 in the “Home price” field and 30-year fixed in the “Type of Mortgage” field. The user enters values for the fields displayed under “Mortgage 1”, for example, 20% in the “% Down payment” field and 3.52% in the “Interest rate” field. The user then enters values for the fields displayed under “Mortgage 2”, for example, 17% in the “% Down payment” field and a 3.52% in “Interest rate” field and $1000 in the “monthly maintenance” field. The asset management application 203 determines the financial components of expenditure based on the mortgage information entered by the user. For example, the asset management application 203 determines values of $240,000 in the “amount of loan” field, $1080.39 in the “mortgage payment” field, $0 in the “Monthly property tax” field, $0 in the “Monthly expenses” field, $1080.39 in the “My monthly payment” field, $148,939.41 in the “Total interest for 30 years” field, and $448,940.40 in the “Total cost for 30 years” field for “Mortgage 1”, and values of $249,000 in the “amount of loan” field, $1120.90 in the “mortgage payment” field, $0 in “Monthly property tax” field, $1000 in the “Monthly expenses” field, $2120.90 in the “My monthly payment” field, a $154,525.92 in the “Total interest for 30 years” field, and $454,524 in the “Total cost for 30 years” field for the “Mortgage 2”.

FIG. 11B exemplarily illustrates the GUI 203i displaying the dynamically rendered interactive graphical models 1101 and 1102 for the two mortgages entered by the user. The interactable interface elements, for example, the slider wheel icons 503 positioned on associated dynamically rendered interactive graphical models 1101 and 1102 of the determined financial components of expenditure are configured to simultaneously displace over a configurable duration of time on the GUI 203i for performing a comparative analysis of the determined financial components of expenditure. The user can view the two interactive graphical models 1101 and 1102 rendered for the two mortgages entered, adjacent to each other for obtaining a better comparison. Furthermore, the user can select a radio button option provided on the GUI 203i to enable or disable movement of the slider wheel icons 503 together. In an example, when the user moves the slider wheel icon 503 on the interactive graphical model 1101 for “Mortgage 1” to “Year 9”, the slider wheel icon 503 on the adjacent interactive graphical model 1102 for “Mortgage 2” automatically and simultaneously slides to “Year 9”. The slider windows 502 display the determined financial components of expenditure. For example, for “Mortgage 1”, the slider window 502 displays $516.44 in the “Principal payment” field, $563.95 in the “interest payment” field, $108,261.29 in the “My money (equity)” field, and $177,762.51 in the “total spent” field, and for “Mortgage 2”, the corresponding slider window 502 displays $535.80 in the “Principal payment” field, $585.10 in the “interest payment” field, $101,070.49 in the “My money (equity)” field, and $173,178.10 in the “total spent” field.

FIG. 11C exemplarily illustrates the GUI 203i displaying a “Mortgage Quotes” sub-tab under the “Home Buyers” tab. The asset management application 203 receives loan quotes received by the user from one or more external sources, and selections of the received loan quotes via the GUI 203i. The asset management application 203 dynamically renders interactive graphical models 1101 and 1102 of the selected loan quotes for performing a comparative analysis of the selected loan quotes from one or more external sources. The user enters one or more quotes for a mortgage. The values in the fields for the mortgage are, for example, $300,000 in the “Home price” field, 20% in the “% Down payment” field, 30-year fixed in the “Type of Mortgage” field, $240,000 in the “Loan Amount” field, etc. The user populates the fields for “Quote 1”, for example, by entering 3.52% in the “Interest rate” field, 3% in the annual percentage rate (APR) field, 3 Points, $0 in the “appraisal fee” field, $0 in the “Lender/broker fees” field, May 20, 2013 in the “date of quote” field, a name of the lender or the broker, a contact person, etc., on the GUI 203i. Similarly, the user enters values in the fields for “Quote 2” as follows: 3.52% in the “Interest rate” field, 2.8% in the “APR” field, 2.8 Points, $0 in the “appraisal fee” field, $0 in the “Lender/broker fees” field, May 19, 2013 in the “date of quote” field, a name of the lender or the broker, a contact person, etc., on the GUI 203i. The asset management application 203 determines one or more financial components of expenditure and renders the determined financial components of expenditure under the “Cost Calculator” section on the GUI 203i for each of the quotes received. The user can view the comparison of one or more entered quotes one below the other, for example, for “Quote 1”, $1080.39 in the “My mortgage payment” field, $148,939.41 in the “total interest 30 years” field, $448940.40 in the “total cost 30 years” field, and $7200 in the “$ due to lender at close” field, and for “Quote 2”, $1080.39 in the “My mortgage payment” field, $148,939.41 in the “total interest 30 years” field, $448,940.40 in the “total cost 30 years” field, and $6720 in the “$ due to lender at close” field. The asset management application 203 displays the difference amount in the “due to lender at close” field values respective to each of the quotes “Quote 1” and “Quote 2”. For example, the asset management application 203 displays the amount due to lender at close as $480 more with quote 1.

FIG. 11D exemplarily illustrates a sub-tab “Understanding refinancing” under the “Home Owners” tab that enables the user to obtain a complete picture of the effects on refinancing the user's finances, compare an existing mortgage with a refinanced one, choose the right length of time for the user's refinanced mortgage, understand the components and terms of a refinanced quote, visualize the affects of points and closing costs, understand commitment over time, visualize the financial benefits over time, etc. The user provides inputs associated with an asset under current mortgage, for example, $500,000 in the “Current home value” field, $350,000 in the “Original loan amount” field, 3.52% in the “Interest rate” field, 30 Year fixed in the “Type of mortgage” field, and January 2005 in the “Original loan date” field. The asset management application 203 determines one or more financial components of expenditure based on the entered inputs and populates, for example, $285,584.89 in the “Current balance” field and $285,584.89 in the “Amount of loan” field. The user enters the values for refinanced mortgage, for example, 3.52% in the “Interest rate” field, 5 in the “Expected years in house” field, 1 in the “Points” field, $0 in the “Appraisal fee” field, $0 in the “Non-Lender fees” field, and $0 in the “Lender/broker fees”. The user can view the values determined by the asset management application 203 for “Current” and “Refinanced” mortgage types on the GUI 203i for performing a comparative analysis. For example, the asset management application 203 determines and displays $1575.57 in the “My mortgage payment” field and $122,487.74 in the “Remaining interest on loan” field for the “Current” mortgage type, and $1285.59 in the “My mortgage payment” field and $177,227.51 in the “Remaining interest on loan” field for the “Refinanced” mortgage type on the GUI 203i. The asset management application 203 displays the difference amount between the respective fields for “Current” and “Refinanced” mortgage types, for example, as $289.98 Less for the “My mortgage payment” field and $54,739.77 More for the “Remaining interest on loan” field. The asset management application 203 determines and displays other values, for example, $2855.85 in the “closing costs” field, 0 years 9 months in the “Recover costs in” field, 5 years in the “If you stay in your house for” field, $17,398.80 in the “Refinancing will save you” field on the GUI 203i. From this, the user can understand that refinancing will save him/her $17,398.80 if he/she stays in the house for 5 years.

FIGS. 11E-11F exemplarily illustrate the GUI 203i displaying a slider wheel icon 503 that enables a user to view how principal, interest, and equity change over time” using the dynamically rendered interactive graphical models 1103 and 1104 with respect to the “Current” and “Refinanced” mortgage types. FIG. 11E exemplarily illustrates the GUI 203i displaying the interactive graphical model 1103 rendered for the “Current” mortgage type. The user can view the interactive graphical model 1103 of interest and principal for a current mortgage payment along with the interactive graphical model 1104 of interest and principal for a refinanced mortgage payment in the background as exemplarily illustrated in FIG. 11E by the hatched lines. The user can toggle between the two displays using the selectable “check box” option displayed for viewing the “current” or “refinanced” mortgage types of interactive graphical models 1103 and 1104. The slider window 502 displays the financial components of expenditure determined for the current mortgage. For example, for Year 1 month 1 and 3.52% in the “current interest rate” field, the asset management application 203 determines and displays $735.60 in the “Current principal payment” field, $839.87 in the “Current interest payment” field, $215,150.81 in the “My money (equity)” field, $447.87 in the “Refinance principal payment” field, $837.72 in the “Refinance interest payment” field, $214,862.98 in the “My money (equity)” field, and $101.03 in the “Total saved so far” field in the slider window 502. FIG. 11F exemplarily illustrates the GUI 203i displaying the interactive graphical model 1104 rendered for the “Refinanced” mortgage type. The user can view the interactive graphical model 1104 of interest and principal for a refinanced mortgage payment along with the interactive graphical model 1103 of interest and principal for the current mortgage payment in the background as exemplarily illustrated in FIG. 11F by hatched lines. The slider window 502 displays the financial components of expenditure determined for the refinanced mortgage. For example, for Year 1 month 1 and 3.52% in the “refinanced interest rate” field, the asset management application 203 determines and displays $735.70 in the “Current principal payment” field, $839.87 in the “Current interest payment” field, $215,150.81 in the “My money (equity)” field, $447.87 in the “Refinance principal payment” field, $837.72 in the “Refinance interest payment” field, $214,862.98 in the “My money (equity)” field, and $63,969.49 in the “Total saved so far” field in the slider window 502.

FIG. 11G exemplarily illustrates the GUI 203i displaying a sub-tab “Compare Refinanced Quotes” under the tab “Home Owners”, to enable the user to compare the refinanced quotes in a professional manner, understand impact of different rates, points, and fees, make a quick informed decision, etc. The user enters mortgage related inputs associated with an asset under mortgage along with one or more refinanced quotes. For example, the user enters a 30 Year fixed type of mortgage and a $240,000 value in the “Loan amount” field. Under “Quote 1”, the user enters 3.52% in the “Interest rate” field, 2 in the “APR” field, 1 in the “Points” field, $250 in the “Appraisal fee” field, $2000 in the “Lender/Broker fee” field, and May 20, 2013 in the “Date of Quote” field. Under “Quote 2”, 3.52% in the “Interest rate” field, 2 in the “APR” field, 2 in the “Points” field, $350 in the “Appraisal fee” field, $1500 in the “Lender/Broker fee” field, and May 19, 2013 in the “Date of Quote” field. The asset management application 203 determines one or more financial components of expenditure based on the entered values. For example, the asset management application 203 determines and displays $2000 in the “$ Amount of points” field, $1350.49 in the “My mortgage payment” field, $186,173.56 in the “total interest 30 years” field, $486,173.56 in the “total cost 30 years” field, and $4250 in the “$ due to lender at close” field for “Quote 1” on the GUI 203i. Furthermore, the asset management application 203 determines and displays $4000 in the “$ Amount of points” field, $1350.49 in the “My mortgage payment” field, $186,173.56 in the “total interest 30 years” field, $486,173.56 in the “total cost 30 years” field, and $5850 in the “$ due to lender at close” field for “Quote 2” on the GUI 203i. The asset management application 203 also displays the difference amount between the values in fields “$ due to lender at close”. For example, the asset management application 203 displays $1600 More on the GUI 203i. The GUI 203i displays a hyperlinked option “how do points affect costs over time” to enable the user to understand the affect of points in breaking even.

FIG. 11H exemplarily illustrates the affect of points in a graphical manner. Points or “discount points” are a function of an interest rate assigned to a mortgage loan. Points are represented as a percent of the loan amount being applied for and are used to lower the interest rate on the mortgage. One point equals one percent of the loan amount, one-half point equals one-half percent of the loan amount, etc. A point will typically reduce an interest rate by one-quarter of one percent, for example, if a lender offers a 30 year fixed rate mortgage at 3.50 percent with no points then the lender may also offer 3.25 percent with one point. On a $200,000 mortgage, one point equals $2,000. The user clicks on the hyperlink “how do points affect costs over time” exemplarily illustrated in FIG. 11G and based on the user entered inputs associated with an asset, the asset management application 203 opens a pop up window 1105 displaying the user's saving in interest from points over time. The asset management application 203 dynamically renders an interactive graphical model 1105a enabling the user to visualize how long it would take for the savings of the user's lower monthly payments to recoup the $ paid upfront for the points to break even and how much the user would save over time in interest payments if the user buys points. The asset management application 203 displays values in the fields, for example, 1 in the “Points” field, $2000 in the “Cost of points” field, $28.18 in the “Monthly savings” field, and 5 years 10 months in the “Breakeven in” field for “Quote 1”, and 2 in the “Points” field, $4000 in the “Cost of points” field, $56.82 in the “Monthly savings” field, and 5 years 10 months in the “Breakeven in” field for “Quote 2” in the pop up window 1105. The user can move the slider wheel icon 503, to visualize the interest savings via the slider window 502 for respective quotes over a configurable period of time.

FIG. 12 exemplarily illustrates a screenshot of a graphical user interface (GUI) 203i provided by the asset management application 203 exemplarily illustrated in FIG. 2, displaying a flow chart of a mortgage process for enhancing a user's understanding. When the user clicks on the “Mortgage Process” tab on the GUI 203i, the asset management application 203 displays a process flow chart with check boxes that provide options, for example, “not started”, “started”, and “finished”, and a “Learn More” button that opens a pop up window to explain the enlisted points for each step of the process flow on the GUI 203i. The process flow chart comprises a “Get started” section, a “Find a mortgage professional” section, a “Get a mortgage quote” section, a “Select your lender” section, a “Locking your rate” section, an “Approval conditions” section, and a “Closing” section. In step 1 of the mortgage process, the “Get started” section lists the points that a user needs to know before entering into a mortgage, for example, basic concepts and definitions related to a mortgage, awareness regarding the down payments and closing costs, the credit capacity of the user, etc. In step 2 of the mortgage process, the “Find a mortgage professional” section allows the user to understand, for example, where to find an authorized mortgage professional, the amount of mortgage the user is qualified for, the difference in between pre-qualification and pre-approval, etc. In step 3 of the mortgage process, the “Get a mortgage quote” section allows the user to decide which mortgage plan to choose, get multiple quotes, understand how to compare multiple quotes, get an estimate on the lender and non-lender fees, etc. In step 4 of the mortgage process, the “Select your lender” section allows the user to understand how to select a lender based on the most competitive quote received, understand applying for a mortgage, know about the rules and regulations to be completed by the lender once the application for mortgage is through, how to get pre-approved, know the options post an application for mortgage, etc. The user then goes to step 5 defined by the “Locking your rate” section, where the user understands what is a lock or an interest rate guarantee, how interest rates vary day to day, lender lock guidelines, etc. In step 6 of the mortgage process, the “Approval conditions” section allows the user to understand the types of approval given by lenders such as a conditional approval; appraisal conditions, that is, the report validating the current market value of a subject property, loan documentation, etc. The user then reaches the final step 7, where the “Closing” section shows the user what to expect at the time of closing a loan application, how to review a settlement statement, how to sign documents, how to receive funding, etc.

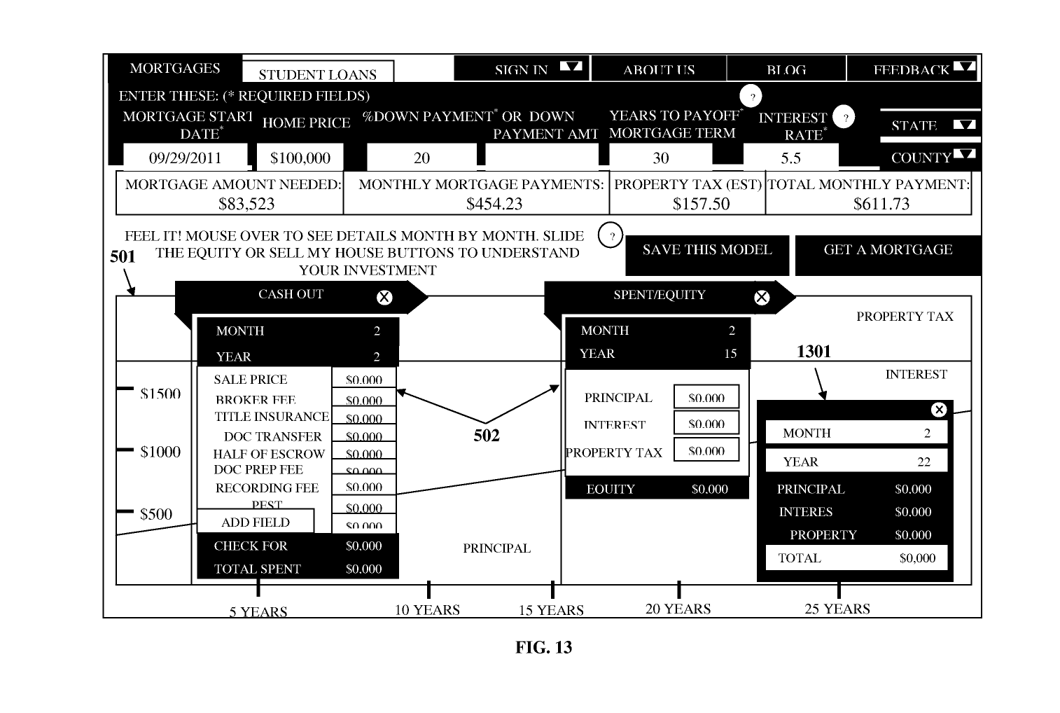

FIG. 13 exemplarily illustrates a screenshot of a graphical user interface (GUI) 203i provided by the asset management application 203 exemplarily illustrated in FIG. 2, for monitoring a user's assets. A user registers with the asset management application 203 via the GUI 203i by clicking on a “Sign in” link provided on the GUI 203i. The asset management application 203 registers users by receiving information, for example, user names, contact numbers, etc., which can be edited at regular intervals via the GUI 203i. When a user selects a “Sign in” option provided on the GUI 203i, a pop-up window appears on the GUI 203i to receive user information, for example, a first name, an electronic mail (email) address, a password, an email notification, an indication on a check box that provides an option to receive emails of offers and notices, an indication on a user agreement link, etc. The user agreement link directs the user to a web page on the GUI 203i that contains terms and conditions of a user agreement. After the user registers with the asset management application 203, the asset management application 203 requests the user to verify the user's email address by displaying a message, for example, “Email Address Verification. We are sending a verification email to complete the account sign up process. When you receive the email, click the link to activate your account.” on the GUI 203i. To activate the user's account on the asset management application 203, the user is required to click the link in their email. The asset management application 203 stores the user information in the database 204a exemplarily illustrated in FIG. 2.

The asset management application 203 provides input fields on the GUI 203i to receive inputs associated with an asset from the user. For example, the asset management application 203 provides input fields for a mortgage type, a mortgage start date, a home price, a percentage (%) down payment or a down payment amount, a mortgage term, that is, the number of years to pay off the mortgage loan, an interest rate, state, county, a property tax input, a tax bracket, etc., on the GUI 203i as exemplarily illustrated in FIG. 13, which are required to be filled in by the user. The user may enter the requested inputs associated with the asset in the respective input fields on the GUI 203i. The asset management application 203 prompts the user to fill in the input fields related to the home price, the percentage (%) down payment or the down payment amount, the mortgage term, and the interest rate. The asset management application 203 tethers the percentage (%) down payment and the down payment amount input fields, whereby if either one is populated or changed, the other is adjusted accordingly. For example, for a $100,000 home price, if a user enters “10” into the “% Down payment” input field, the asset management application 203 populates the “Down payment amount” input field with “10,000” and vice versa. The property tax, state, zip code, city, and/or county input fields may not be mandatory. The tax bracket, condominium (condo) and housing cooperative (coop) input fields may not be mandatory. In an embodiment, the state and the county input fields are dropdown fields where once the user selects a state, the asset management application 203 updates the respective counties in that state to allow the user to select the county he/she wishes to choose. If any of the required input fields are not populated, the asset management application 203 prompts the user to fill in the required input fields on the GUI 203i by displaying a message, for example, “Please enter the required fields”. When the user has entered the required fields, the message disappears.

The asset management application 203 also displays a hover “?” button on the GUI 203i. If a user hovers a pointer on a “?” button associated with an input field, a pop-up window appears with information about the input field and if the user moves their pointer off the “?” button, the window disappears. For example, if a user hovers a pointer on the “?” button next to the “Years to pay off” input field, the asset management application 203 displays a window showing standard mortgage terms, for example, 10, 15, 20, 30, 40. The asset management application 203 provides a “rates” button next to the interest rate input field on the GUI 203i to display current interest rates and general information bits on interest rates. The asset management application 203 displays interest rate information based on data stored in the database 204a that is updated periodically, for example, every month. The asset management application 203 provides an “X” button on the GUI 203i to allow the user to close a current window and navigate elsewhere.

The asset management application 203 determines one or more financial components of expenditure, for example, property taxes and payment amounts based on a mortgage amount required. The asset management application 203 determines property tax values based on predetermined formulae. In an embodiment, the asset management application 203 maintains loan overnight average interest rates, property tax rates in a lookup table of the database 204a. In an embodiment, the asset management application 203 determines the property tax based on the state, the city, the zip code, and/or the county. However, if a user selects a county with a non-existent property tax, the asset management application 203 displays a message, for example, “We are sorry, property tax is not available for this county currently.” In an embodiment, the asset management application 203 allows the user to enter in the property tax value via the GUI 203i. After the asset management application 203 determines the property tax, the asset management application 203 displays the determined values of the financial components, for example, a mortgage amount needed, monthly mortgage payments, a monthly property tax, and total monthly payment based on the inputs associated with an asset entered by the user in the input fields. The asset management application 203 determines some of the financial components of expenditure, for example, mortgage amount needed, monthly property tax, total monthly payment, etc., as disclosed in the detailed description of FIG. 1A.

If the user does not select the state and the county in an “Enter these” section on the GUI 203i, then the asset management application 203 does not display the monthly property tax on the GUI 203i. After determination of the financial components of expenditure for the user, the asset management application 203 renders an interactive graphical model 501 of the determined financial components of expenditure. The interactive graphical model 501 is an amortization graph that displays, for example, the property tax based on the state and county, principal, and interest payments over the length of the mortgage on the GUI 203i. When the user enters a home price, a down payment, a mortgage term, and an interest rate, the interactive graphical model 501 dynamically appears on the GUI 203i and displays the loan over time with amortization volumes for principal and interest, and number indicators. The interactive graphical model 501 dynamically updates the values where necessary.

As exemplarily illustrated in FIG. 13, the interactive graphical model 501 displays the property tax, the interest, and the principal in different colored volumes. If the user changes values for the mortgage amount, interest rate, etc., in the input fields on the GUI 203i, the volumes immediately adjust accordingly and the scale, x axis numbers, and y axis numbers adjust in the interactive graphical model 501. In an embodiment, when the asset management application 203 determines the property tax, a volume appears on the interactive graphical model 501 that represents property tax over time, that is, over the term of the loan. When the asset management application 203 determines the mortgage interest rate deduction information, the interactive graphical model 501 displays the effect of the mortgage interest rate and when the user changes any of the above described inputs, the asset management application 203 dynamically updates the changes to the interactive graphical model 501. When the user edits the parameters of the mortgage on the GUI 203i, the interactive graphical model 501 changes on the GUI 203i.

In an embodiment, the asset management application 203 allows the user to view a table of the data used to render the interactive graphical model 501 and the inputs including a summary on the GUI 203i. Furthermore, the asset management application 203 allows the user to download the table of the data used to render the interactive graphical model 501 and the inputs including a summary. If the user wants to add extra payments, the asset management application 203 allows the user to input amount of extra payments and frequency on the GUI 203i. The asset management application 203 dynamically updates the mortgage values and the interactive graphical models 501 including the computations of extra payments. The user may save the interactive graphical model 501 and name the interactive graphical model 501 on the GUI 203i. The asset management application 203 allows the user to save, for example, about five interactive graphical models 501, which facilitates comparison of the interactive graphical models 501. For example, the user may compare an interactive graphical model 501 rendered for a fixed rate mortgage with an interactive graphical model 501 rendered for an adjustable rate mortgage on the GUI 203i. The asset management application 203 provides access to the interactive graphical models 501 on the GUI 203i, for example, on a web page to allow the user to select and display an interactive graphical model 501.

In an embodiment, the asset management application 203 provides a tab on the GUI 203i to allow the user to select a mortgage end point value from the tab. If a user wants to have a mortgage paid off by a certain date, for example, retirement, etc., the user selects the tab on the GUI 203i. The asset management application 203 prompts the user to enter mortgage data, for example, a start date, an interest rate, etc., if the user has not entered the mortgage data already, and prompts the user to enter a potential date of termination, that is, end date, of the mortgage. The asset management application 203 then displays an interactive graphical model 501 of what mortgage payments would need to be achieved on that end date.

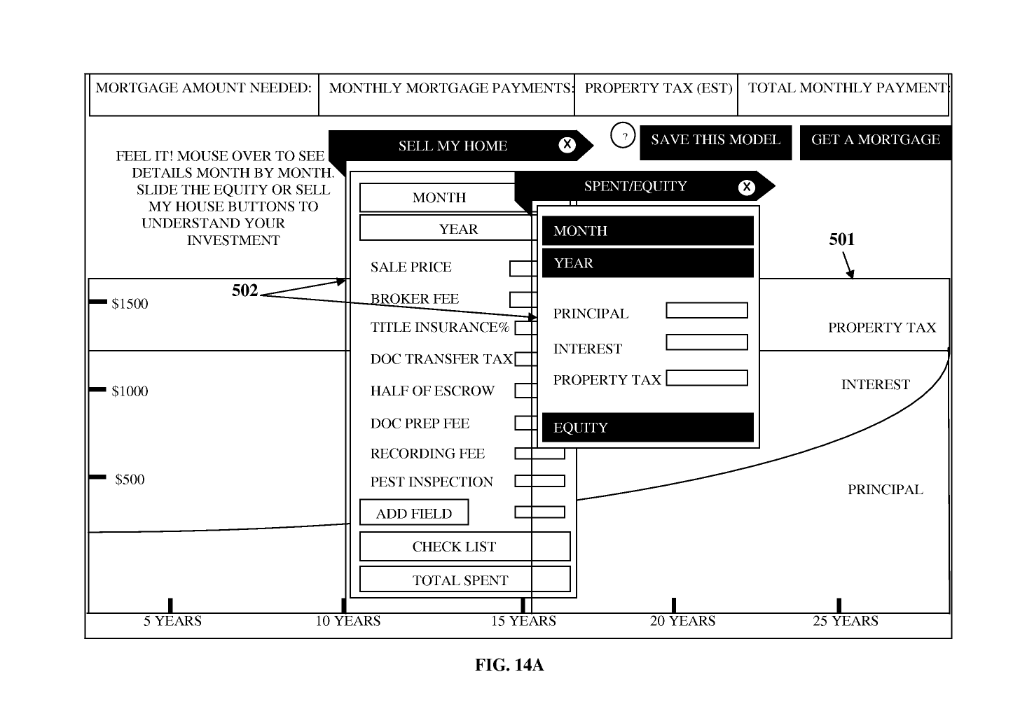

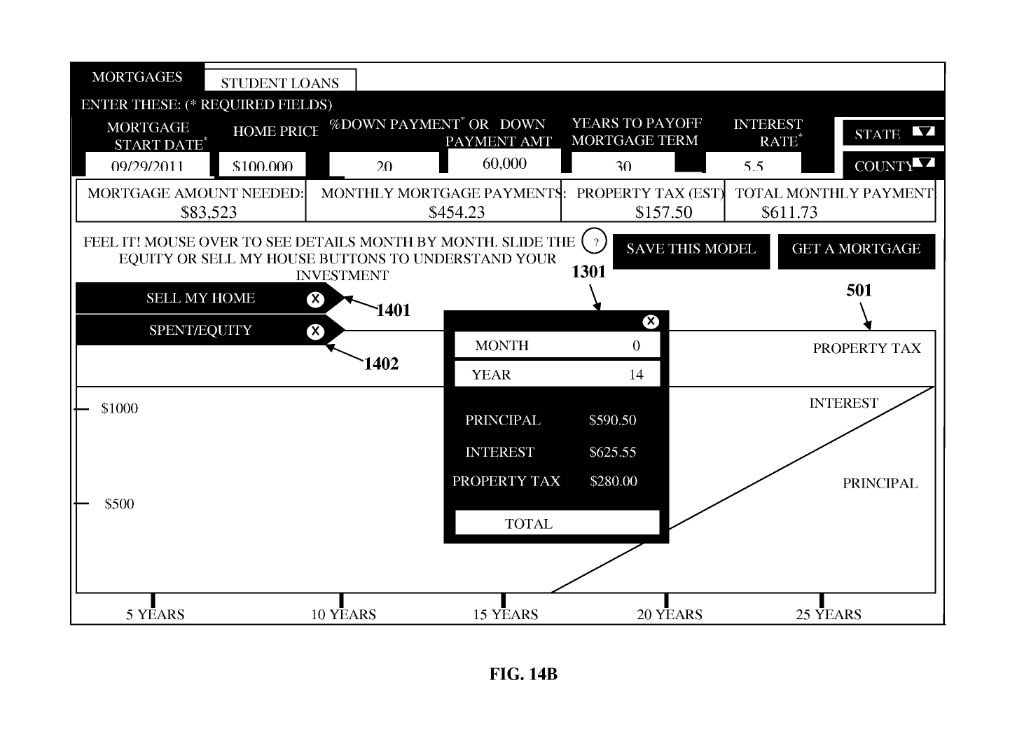

In an embodiment, in addition to fixed rate mortgages, the asset management application 203 allows computation of adjustable rate mortgages. The user selects from a different tab on the GUI 203i for adjustable rate mortgages. The asset management application 203 provides a different tab on the GUI 203i because different products are offered to users of reverse mortgages that are relevant to older users. The asset management application 203 prompts the user to input a zip code, a birth date, a spouse's birth date, what an existing mortgage is, for example, when the mortgage was obtained, what the interest rate is, etc., and how much the home is worth on the GUI 203i. The asset management application 203 also displays interactive graphical models 501 of existing mortgages on the GUI 203i. The asset management application 203 prompts the user to enter when he/she wants to obtain a reverse mortgage. The asset management application 203 updates home equity conversion mortgage (HECM) thresholds, for example, currently $625,000 and determines feasibility of the reverse mortgage. The asset management application 203 determines remaining mortgage left and options for lump sum payments, credit line, a home advance, etc. The user can select the lump sum, credit line, or home advance, or a combination thereof, on the GUI 203i. The asset management application 203 models the selections and displays payments out and mortgage details in an interactive graphical model 501 on the GUI 203i. The user may save the interactive graphical models 501 of each mortgage and utilize the interactable interface elements, for example, slider elements such as a slider wheel icon 503, a slider window 502, etc., floating windows 1301, etc., provided by the asset management application 203 to perform multiple actions, for example, model additional payments out on the GUI 203i as disclosed in the detailed description of FIGS. 14A-14B.

FIGS. 14A-14B exemplarily illustrate screenshots of a graphical user interface (GUI) 203i provided by the asset management application 203 exemplarily illustrated in FIG. 2, displaying interactable interface elements that enable a user to graphically visualize financial components of expenditure determined by the asset management application 203 for a particular mortgage value. The asset management application 203 displays the interactive graphical models 501 as exemplarily illustrated in FIGS. 14A-14B. The interactive graphical models 501 show property tax, interest, and principal in different colored volumes. If the user changes values for the determination inputs, for example, mortgage amount, interest rate, etc., the volumes dynamically adjust accordingly and the scale, x axis numbers, and y axis numbers adjust in the interactive graphical model 501. The user can access, configure, and make changes to the inputs associated with the asset on the GUI 203i using the interactable interface elements 203j provided by the asset management application 203. The interactable interface elements 203j comprise, for example, slider elements such as a slider wheel icon 503, a slider window 502, etc., floating windows 1301 exemplarily illustrated in FIG. 13, etc.

In an embodiment, a user activates a slider window 502 by clicking on an interactable slider element displayed on the GUI 203i. On activating the interactable slider element, the user can drag the slider window 502 across the mortgage to a particular month in an interactive graphical model 501. In an embodiment, the interactable slider element becomes a floating window 1301 that displays data. The interactable slider element becomes a floating window 1301 as soon as the interactable slider element is moved from its original position. As the interactable slider element slides across the interactive graphical model 501, the determined data changes depending on time defined, for example, by a year and a month. The slider window 502 displays an “X” button at the upper right corner that a user can click to close the slider window 502. If a user clicks on the “X” button, the interactable slider element goes back to its original position. As long as the user does not click on the “X”, the interactable slider element remains in its original position, and the slider window 502 remains open.

In an embodiment as exemplarily illustrated in FIGS. 14A-14B, the GUI 203i displays interactable slider elements labeled, for example, as “Sell my home” 1401, “Total Spent”, and “Equity” 1402 which originate, for example, on the left side of the interactive graphical model 501. If a user clicks on these interactable slider elements 1401, 1402, etc., and slides them to any point on the interactive graphical model 501, the interactable slider elements 1401, 1402, etc., transform into floating windows 1301 and display values for that point in time. The “Sell my home” slider window 502 displays pre-populated default values for many of the financial components of expenditure, for example, expenses of selling a house. These default values can be edited by the user. The “Sell my home” slider window 502 also displays a custom field for adding an additional category and an amount.

In an embodiment, on activating the “Sell my home” interactable slider element 1401, the slider window 502 of the “Sell my home” interactable slider element 1401 displays, for example, year and month; sale price as an input field where a user may input a sale price; a broker fee which displays a default value, for example, of 6% in an editable field, where a user can change the field to a value which can include a decimal value up to 2 decimal places; a title insurance percentage, which displays a default value of, for example, 0.036 which can be edited by the user; document transfer tax, which displays a default value of, for example, [sale price/500*0.55] which can be edited by the user; half of escrow, which displays a default value of, for example, 250 which can be edited by the user; a document preparation fee, which displays a default value of, for example, 125 which can be edited by the user; a recording fee which displays a default value of, for example, 75 which can be edited by the user; pest inspection which displays a default value of, for example, 200 which can be edited by the user; state tax, which displays a default value of, for example, 0.0123 which can be edited by the user; a custom field having a label of “Custom” in which the user can enter a value, etc., as exemplarily illustrated in FIG. 13. If the user moves the “Sell my home” interactable slider element 1401 over to any date in their mortgage term left to right, the user can view how much he/she will have after closing costs if he/she were to sell their home. The user can edit the assumptions, for example, amount of broker fee, sale price, etc., in the slider window 502.

In an embodiment, the asset management application 203 provides a “?” button on the “Sell my home” interactable slider element 1401. When the user hovers a pointer on the “?” button on the “Sell my home” interactable slider element 1401, a window appears with explanations for the “Sell my home” fields. When the user moves the “Sell my home” interactable slider element 1401 across the interactive graphical model 501 to a particular month, the “Sell my home” slider window 502 displays, for example, the year and the month, a total amount spent, an amount of check from a buyer, total profit or loss, etc. When the slider window 502 is displaying the amounts, the asset management application 203 provides an “Open” option on the slider window 502 to allow the user to open the slider window 502 and edit the computations.

The “Total Spent” and the “Equity” interactable slider element 1402 display the amount spent across all categories, for example, property tax, principal, interest, and how much equity the homeowner has in the property as of that date, depending on the point in time on the interactive graphical model 501 the user slides the “Total Spent” and the “Equity” interactable slider element 1402. The asset management application 203 also displays a floating window 1301 exemplarily illustrated in FIG. 13, that is activated when the user hovers a pointer over the interactive graphical model 501 and that shows at any point in time of what a payment will consist. On each month that the “Total Spent” and/or the “Equity” interactable slider element 1402 rests on the interactive graphical model 501, the slider window 502 of each of the “Total Spent” and/or the “Equity” interactable slider element 1402 displays, for example, the year and the month; principal=total principal to date; interest=total interest to date; property tax=total property tax to date, wherein if state and county is not populated, then the slider window 502 displays a message as “Not available”; total amount spent=principal+interest+property tax, wherein if the state and the county is not populated the total spent figure does not include property tax value; Equity=Down payment+sum of principal to date, wherein principal amount paid for every month prior to the date the interactable slider element 1402 is on is added, etc. The slider window 502 provides an exit button to allow a user to exit. On clicking the exit button, the asset management application 203 displays the “Total Spent” and/or the “Equity” interactable slider element 1402 in their original position. If a user moves the “Total Spent” and/or the “Equity” interactable slider element 1402 over to any date in the mortgage term left to right, the user can view how much equity he/she will have in their home, and how much he/she has spent in total, as well as the amount of property tax spent, interest spent, and principal spent, depending on what interactable slider element 1401 or 1402 is used or activated.

The asset management application 203 enables the user to save a copy of the interactive graphical models 501 in the user account. In an embodiment, if a user clicks on a “Save This Model” button provided on the GUI 203i, the asset management application 203 saves the values previously entered by the user for the mortgage computations to their user account. When the user clicks on the “Save This Model” button, the asset management application 203 prompts the user to enter a name for the interactive graphical model 501 with suggestions of a naming technique, for example, “45 High Ridge”. The asset management application 203 also provides instructions on the GUI 203i to locate the interactive graphical models 501. The asset management application 203 allows the user to access a web page using their account settings along with a username and a password where the user's interactive graphical models 501 are listed. The asset management application 203 identifies the interactive graphical models 501 by the date on which they were made, the name they were given in addition to the entries made by the user in the required input fields. In an embodiment, the asset management application 203 displays the interactive graphical models 501 in a chronological order, for example, with the most recent interactive graphical models 501 displayed first. In another embodiment, the asset management application 203 provides a Display choice option and a Delete choice option next to each interactive graphical model 501 on the GUI 203i. If the user chooses to delete an interactive graphical model 501, the asset management application 203 confirms whether the user wishes to delete the interactive graphical model 501, prior to deleting the interactive graphical model 501.

In an embodiment, the asset management application 203 also provides a hover “?” Button next to the “Save this Model” button on the GUI 203i. If a user hovers a pointer using a computer mouse over the “?” button next to the “Save this Model” button, a window appears on the GUI 203i that describes the features of model saving. However, if the user moves the pointer off the “?” button, the window disappears. If a user is not signed in and chooses to save an interactive graphical model 501, the asset management application 203 displays a message, for example, “Please sign up/sign in to save an interactive graphical model”. If a user is not signed in, the asset management application 203 saves the interactive graphical model 501 temporarily until the user signs up or signs in. If a user is not signed in, and after the user signs up or signs in, the asset management application 203 displays a link that recites, for example, “return to my interactive graphical model”, which provides access to the previously rendered interactive graphical model 501 and allows the user to save the interactive graphical model 501.

In an embodiment, when a user positions the pointer over an interactive graphical model 501 on the GUI 203i, the interactive graphical model 501 displays, for example, the following for any month of a mortgage: total payment by month, total interest by month, total principal by month, total property tax by month, etc. The asset management application 203 displays these financial components of expenditure if the user has entered a zip code on the GUI 203i. At the top of the list of financial components, the interactive graphical model 501 displays the date. If the user enters a date in the mortgage start date input field, the interactive graphical model 501 displays the mortgage start date. In an embodiment, the asset management application 203 provides a “Share” button on the interactive graphical model 501. When the user clicks the “Share” button, the asset management application 203 prompts the user to enter an email address of each of one or more other users and provides a field for the user to enter a note for emailing the interactive graphical model 501 to the other users.

In an embodiment, the asset management application 203 provides a “Get a mortgage” button on the GUI 203i. If the user clicks on the “Get a mortgage” button, the asset management application 203 displays a modal window that recites, for example, “To get mortgage quotes, indicate whether you'd like to be contacted by email or phone. You will be contacted within 24 hours.” The window displays a message, for example, “I would like to be contacted by email. I would like to be contacted by phone” with an input for a phone number, and an OK button. When the user enters the information, the asset management application 203 saves the following information, for example, a first name, an email address, a phone number if available, a mortgage amount needed, a home price, a mortgage term, an interest rate, a date of indication of interest, that is the date that the user clicked on the link, etc., into a spreadsheet or a form that can be exported to a spreadsheet.

In an embodiment, the asset management application 203 provides a “Find a mortgage” button on the GUI 203i. On clicking the “Find a mortgage” button, a window prompts the user to enter a phone number and a credit score range, which is passed to pre-selected banks that have agreed to participate. In an embodiment, the asset management application 203 displays available mortgage rates with the option to save an offer, contact a broker or a bank, and compare the offer. If the user saves the offer, the asset management application 203 saves the offer with contact information of the broker or the bank in a secure database 204a. In an embodiment, the asset management application 203 breaks down mortgage components into fees that can then be modeled in an interactive graphical model 501. A mortgage broker on their end can fill in parameters, which the asset management application 203 associates with the interactive graphical model 501 and allows users to compare with real numbers over time on their actual interactive graphical model 501. The mortgage broker can share quotes that are modeled in the asset management application 203 with the users and that can be saved by the user or the mortgage broker on the asset management application 203.

In another embodiment, the asset management application 203 provides an encoding mechanism to create a unique uniform resource locator (URL) for parameters of each interactive graphical model 501. The asset management application 203 creates the encoding mechanism to enable users to share interactive graphical models 501 via the respective URLs. The asset management application 203 provides a “Share” button with an input box for an email address and messages on the GUI 203i. The asset management application 203 maintains cookies that save user data, so that when a user returns to the GUI 203i of the asset management application 203 or refreshes the GUI 203i, the user populated values are saved. In an embodiment, the asset management application 203 also authenticates the user prior to providing access to the asset management application 203.

In an embodiment, the asset management application 203 allows a user to send an interactive graphical model 501 of a mortgage to a broker or a bank that either the broker or the bank has rendered via the GUI 203i of the asset management application 203, or that has been modeled of a different bank and a different broker's mortgage offer, including fees. In an embodiment, the asset management application 203 allows a bank or a broker to send an interactive graphical model 501 of a mortgage offer to the user via the network 202. The interactive graphical models 501 related to a mortgage that are sent and received by the user, the bank, and the broker, etc., contain multiple modeling interactable interface elements, for example, a “Total Spent” and an “Equity” interactable slider element 1402, a “Sell my home” interactable slider element 1401, etc. The asset management application 203 allows the user, the bank, and/or the broker to save and compare the interactive graphical models 501.

In an embodiment, the asset management application 203 provides multiple tools that enable computation of the estimated values of the financial components of total expenditure incurred by the user. For example, if the user wants to model a house sale, the asset management application 203 displays a window with default values for various closing costs and an input field for sale price. The user can edit the default values and input the proposed sale price. The user positions a home sale tool, for example, the “Sell my home” interactable slider element 1401 on the date the user wishes to sell his/her home and edits the sale price or default values at any point on the GUI 203i. The “Sell my home” slider window 502 displays, for any point in time on the term of the loan, the estimated amount the user would get paid after a sale, or the estimated amount the user owes after a sale. The user may then select to view how much equity he/she has at a point in time. The user positions an equity tool, for example, the “Total Spent” and/or the “Equity” interactable slider element 1402 on the date he/she wishes to view how much equity he/she has or will have. The “Total Spent” slider window 502 and/or the “Equity” slider window 502 display, for any point in time on the term of the loan, the equity the user has or will have in the home, and/or the total amount spent for any point in time on the term of the loan in various categories, for example, property tax, fees, etc. If the user wants to view how much he/she has spent or will spend at any point in time, the user positions the total spent tool on the date he/she wishes to view how much he/she has spent or will spend. The total spent tool displays, for any point in time on the term of the loan, the total amount spent for mortgage costs to date. The asset management application 203 enables the total spent tool to display, for any point in time on the term of the loan, the total amount spent for property tax, if available and for any point in time on the term of the loan, the total amount credited for mortgage interest deduction, if available and for any point in time on the term of the loan, the total amount spent on mortgage costs plus the property tax, minus the mortgage interest rate deduction. The asset management application 203 enables the total spent tool to display, for any point in time on the term of the loan, the total amount spent on condominium fees or housing cooperative fees, and related tax deductions.

In an embodiment, the asset management application 203 enables the user to select the amount spent per month tool. The user positions the amount spent per month tool on the date he/she wishes to view how much he/she has spent or will spend per month. The amount spent per month tool displays, for any month on the term of the loan, the amount per month in interest and principal, and also displays the property tax per month, if available, and the mortgage deduction per month, if available, and total payment per month, for example, principal+interest+property tax−mortgage loan deduction. If the user elects to view housing sale trend data for a region, the asset management application 203 incorporates housing sale trend data into the interactive graphical model 501 and the user can choose to save that particular interactive graphical model 501. The asset management application 203 saves the interactive graphical model 501 along with the input values and requests the user to name the interactive graphical model 501. The asset management application 203 provides an income tax deduction tool that allows the user to enter in basic information about W2 or tax information and to store the information. The user can view the amount of income going to social security, federal, state, etc. The income tax deduction tool allows users to enter a tax bracket and a tax filing status and automatically calculates mortgage interest deduction for first year and last year, and then displays the mortgage interest deduction for any given month. The value for the month changes when the slider wheel icon 503 is slid on the GUI 203i, as the value pertains to the amount of interest at any given point in time. The user can view the effect of different tax deductions on income on the GUI 203i. The asset management application 203 creates visualization of withholding the deduction selections.

In an embodiment, the asset management application 203 allows the user to save multiple copies of the interactive graphical models 501 which are displayed on the GUI 203i. If a user selects two or more interactive graphical models 501 to compare, the asset management application 203 displays both the interactive graphical models 501 on the GUI 203i, including variables and interactive graphical models 501. The user selects and positions the home sale tool on the date at which he/she wants to model a home sale. The user selects and positions the equity tool on the date at which he/she wants to view how much equity is or will be in the home. The user selects and positions the total spent tool on the date at which he/she wants to view how much he/she has spent or will spend on their home. The user may select a “Save a mortgage” or delete a mortgage on the GUI 203i. After the user has entered the mortgage parameters, if the user clicks on a “Get a mortgage” link on the GUI 203i, the asset management application 203 sends the parameters of the mortgage to a third party which returns a list of mortgage offers, and/or contacts. The user then selects one or more of the mortgage offers which can be modeled with mortgage details and interactive graphical models 501 by the asset management application 203. The user may then select the tools, for example, the home sale tool, the equity tool, and the total spent tool on the GUI 203i. On using the tools, the user selects the preferred mortgage offer and saves a copy of the preferred mortgage offer. The user then contacts the entity that originated the mortgage offer. In an embodiment, the asset management application 203 displays the user's existing mortgage and displays one or more refinancing offers for comparison via the GUI 203i. In an embodiment, the asset management application 203 determines a break-even point for providing the user with refinancing options. The break-even point is a point at which a user recoups his/her expenditure through savings. The user can position the “Sell my home” interactable slider element 1401, the “Equity” interactable slider element 1402, and/or the “Total spent” interactable slider element 1402 on a corresponding interactive graphical model 501 to compare across mortgages and refinances.

In an embodiment, the asset management application 203 provides a student loan tool that allows the user to enter parameters of student loan offers, for example, interest rate, term, etc. If the user selects a start date of a loan that is in the past, the asset management application 203 confirms that these loans exist and displays an interactive graphical model 501 of payment over time. The asset management application 203 allows the user to enter parameters for more than one loan and view them together in terms of interest rate and term, with total payments for each month, the loan and the interest to which the payment amounts. The asset management application 203 also determines the amount of income needed at what stage to support living expenses and loans in different geographic regions along with information about when the user can refinance a loan and the process. The asset management application 203 provides student loan related content and allows the user to create scenarios on student loan debt, for example, larger payments, different interest rates, and bulk payments on the GUI 203i.

In an embodiment, the asset management application 203 determines the monthly mortgage amount that the user is required to pay based on the mortgage needed. For example, the asset management application 203 displays a window related to determining tax payment on a house sale. The asset management application 203 prompts the user to enter details pertaining to, for example, whether the house is a primary residence for at least 2 years, whether the user is filing a single return or a joint return, whether the start date of the mortgage is the time of the house purchase, etc. The asset management application 203 determines the amount of time from the start of the mortgage. If the duration is two or more years, if the home is a primary residence for 2 or more years, and if the user is filing a single return, the asset management application 203 determines, for example, up to $250,000 of gain as tax exempt. If the duration is two or more years, if the home is a primary residence for two or more years, and if the user is filing a joint return, the asset management application 203 determines, for example, up to $500,000 of gain as tax exempt. If the home is not a primary residence or the user has not had a house for two or more years, the asset management application 203 determines no tax exempt gain. The asset management application 203 displays the tax exempt value and a non-tax exempt value, if any, on the GUI 203i. The asset management application 203 provides full property tax data on a zip code level. When the user enters the zip code, the asset management application 203 provides access to the property tax for that particular zip code. If the user has entered a zip code, the asset management application 203 displays a window that prompts the user to enter home details, for example, number of bedrooms, bathrooms, etc.

In an embodiment, the asset management application 203 displays appreciation/depreciation rates of past homes for sale in a zip code and the appreciation/depreciation predictions for home prices in the zip code on the GUI 203i. If the user has not entered a zip code, the asset management application 203 notifies the user that he/she will not be able to view the home price trend data. If the user has entered a zip code, the asset management application 203 displays property tax fluctuations in the past on an interactive graphical model 501. If the user has not entered the zip code, the asset management application 203 informs the user that if he/she enters a zip code, the user can view the property tax cost fluctuations. The asset management application 203 displays the property tax and the price increase as volume on an interactive graphical model 501 as follows: If the user has entered a zip code, the property tax increases and is shown as a volume on the main interactive graphical model 501 to show the user what increases he/she may pay over time. The asset management application 203 displays a prediction of an increase in home value, and an increase in property tax on the main interactive graphical model 501. The user can adjust the predictions in the interactive graphical model 501 by entering a different percentage increase or decrease over time, or by entering actual property tax values on the GUI 203i. The user can remove or hide these computations on the GUI 203i. The asset management application 203 provides a notice of homes put up on sale in the neighborhood, their location, the number of bedrooms, etc., and the price the homes were offered for, and what was originally offered, on the GUI 203i to the user. The asset management application 203 also provides a notice of brokers who sold houses in the neighborhood, the price the homes were offered for, and the price the homes were sold for, on the GUI 203i to the user.

The asset management application 203 therefore allows a user to determine tax components or savings from home ownership and also from sale; provides zip code level granularity on property tax; allows the user to view local trends on the GUI 203i in order to better predict what the sale price may be in the event of a sale; allows the user to view houses in the neighborhood that are for sale and that have sold, and to view a list of brokers handling transactions to get an insight into possible sales prices; allows the user to view local information that may affect property value such as zoning issues, community board information, etc.; allows the user to enter basic information about student loan offers and to perform scenarios on student loan debt; allows the user to enter in basic information about W2 or tax information; and creates visualization of withholding deduction selections.

Consider an example where a user utilizes the asset management application 203 disclosed herein to monitor the user's assets. The asset management application 203 presents the user with an option of selecting either a fixed rate mortgage or an adjustable rate mortgage. In this example, the user selects an adjustable rate mortgage. The user enters a mortgage start date, a home price, a percentage down payment or an amount of down payment, a term, starting interest rate, months between adjustment, expected adjustments, interest rate cap, etc., in the input fields on the GUI 203i. The asset management application 203 displays the mortgage amount needed and the monthly mortgage payment. The user may then enter actual property tax or may select a region to obtain an estimated property tax by zip code or state and county on the GUI 203i. The asset management application 203 displays the property tax amount on the GUI 203i. The user may then enter a tax bracket, a state, and a city for mortgage interest rate deduction. The asset management application 203 displays the mortgage interest rate deduction amount. An interactive graphical model 501 dynamically appears on the GUI 203i when the user enters at least the home price, the down payment, the term, the starting interest rate, the months between adjustment, the expected adjustments, and the interest rate cap, showing the loan over time with amortization volumes for principal and interest, and number indicators. In an embodiment, when the user enters the property tax, a volume appears on the interactive graphical model 501 that represents property tax over time, that is, the term of the loan.

When the user enters mortgage interest rate deduction information, the interactive graphical model 501 displays the effect of the mortgage interest rate. When a user changes any of the above inputs, the interactive graphical model 501 dynamically updates on the GUI 203i. In an embodiment, the user can view a table of the data used to render the interactive graphical model 501 and the inputs including a summary on the GUI 203i. The user can download the table of the data used to render the interactive graphical model 501 and the inputs including a summary on the user device 201a, 201b, 201c, or 201d. The user may then select that he/she wants to add extra payments. The asset management application 203 allows the user to input an amount of extra payments and frequency. The asset management application 203 dynamically updates the mortgage values and the interactive graphical model 501 including computations of extra payments. The user may then select that he/she wants to model a house sale. The asset management application 203 displays a window with default values for various closing costs and an input field for sale price. The user can edit the default values.

The user may then input the proposed sale price on the GUI 203i. The user positions the home sale tool on the date he/she wishes to sell their home. The user can edit the sale price or default values at any point on the GUI 203i. The home sale tool displays, for any point in time on the term of the loan, the estimated amount the user would get paid after a sale, or the estimated amount the user would owe after a sale. The user may then select that he/she wants to view how much equity he/she has at a point in time. The user may then position the equity tool on the date he/she wishes to view how much equity he/she has or will have. The equity tool displays, for any point in time on the term of the loan, the equity the user has or will have in the home. The user may then select that he/she wants to view how much he/she has spent or will spend at any point in time. The user may position the total spent tool on the date he/she wishes to view how much he/she has spent or will spend. The total spent tool displays, for any point in time on the term of the loan, the total amount spent for mortgage costs to date. The total spent tool displays, for any point in time on the term of the loan, the total amount spent for property tax, if available. The total spent tool displays, for any point in time on the term of the loan, the total amount credited for mortgage interest deduction, if available. The total spent tool displays, for any point in time on the term of the loan, the total amount spent on mortgage costs plus property tax, minus mortgage interest rate deduction. The user may then select the amount spent per month tool. The user positions the amount spent per month tool on the date he/she wishes to view how much he/she spends or spent per month. The amount spent per month tool displays, for any month on the term of the loan, the amount per month in interest and principal, and also displays property tax per month, if available, and mortgage deduction per month, if available, and total payment per month, that is, principal+interest+property tax−mortgage loan deduction.

The user may then elect to view housing sale trend data for a region. In an embodiment, the asset management application 203 incorporates housing sale trend data into the mortgage model. The user may then elect to save a mortgage model. The asset management application 203 saves input values entered by the user. The asset management application 203 displays an input window for the user to name the mortgage model. The asset management application 203 can save multiple mortgage models for the user. The asset management application 203 displays the user's mortgage models on a web page on the GUI 203i. The user may then select two interactive graphical models 501 to compare. The asset management application 203 displays both the interactive graphical models 501 on the GUI 203i, including variables and interactive graphical models 501. The user may then select the home sale tool. The user may position the home sale tool on the date at which he/she wants to model a home sale. The user may then select the equity tool. The user may position the equity tool on the date at which he/she wants to view how much equity is or will be in the home. The user may then select the total spent tool. The user positions the total spent tool to the date at which he/she wants to view how much he/she has spent or will spend on their home. The user may then select the “save a mortgage” web page or delete a mortgage. After the user has entered mortgage parameters, he/she may select that he/she wants to get a mortgage. The asset management application 203 sends parameters of the mortgage to a third party that returns a list of mortgage offers, and/or contacts. The user may select one or more of the mortgage offers. The offers are modeled with mortgage details and interactive graphical models 501. The user may then select to use the home sale tool, the equity tool, or the total spent tool. The user saves a mortgage offer. The asset management application 203 saves the mortgage offer with details and/or contact information. The user contacts the company or individual that originated the mortgage offer. Furthermore, the asset management application 203 allows the user to send emails, alerts, etc., containing an interactive graphical model 501 of a mortgage to a broker or a bank via the network 202. The broker or the bank may access the emails, alerts, etc., containing the interactive graphical model 501 and transmit emails, alerts, etc., containing an interactive graphical model 501 of an offer to the user for access by the user. The user may receive the offer on the asset management application 203, access, and store the offer in the user account.

Consider an example where a user who is applying for or is under a mortgage loan, wishes to monitor and manage his/her assets using the asset management application 203 exemplarily illustrated in FIG. 2. The user accesses the asset management application 203, views the home page on the GUI 203i, and registers on the asset management 203 by entering an email ID and a password. After activating the user account and logging into the asset management application 203, the user enters mortgage information, for example, an indication of a fixed rate mortgage loan or an adjustable rate mortgage loan, parameters defining a term of loan such as a loan start date and a loan end date, a price of an asset, down payment, a term of the fixed rate mortgage loan or the adjustable rate mortgage loan, an interest rate for the fixed rate mortgage loan or the adjustable rate mortgage loan, an amount of asset tax, a tax bracket, state of the asset, city of the asset, county of the asset, fees of the asset, the condominium fees of a property asset or the housing cooperative fees of the property asset, tax information, and prospective financial parameters, etc. As exemplarily illustrated in FIG. 5A, the user populates values in the mortgage information fields, for example, $300,000 in the “Home price” field, 20% in the “% Down payment” field, 3.52% in the “Interest rate” field, 30-year fixed in the “Type of Mortgage” field, $0 in the “Annual property tax” field, etc. The asset management application 203 determines one or more financial components of expenditure based on the mortgage information entered by the user, for example, an amount of loan required, a monthly loan payment, a payment over the configurable duration of time, an amount of asset tax, an amount of an interest rate deduction for a loan, an amount of tax deduction from tax deductible housing cooperative fees, an amount of equity available to the user at a point in the configurable duration of time, an amount of the equity spent by the user at a point in the configurable duration of time, a break-even point, an amount of income needed at a configurable stage in the configurable duration of time, loans available in different geographical locations, time of refinancing of the loan, etc.

The user views the determined financial components of expenditure, for example, a $1080.39 “mortgage payment”+a $0 “Mortgage interest”+a $0 “Monthly property tax”+a $0 “Monthly expenses”=a $1080.39 “My monthly payment”, a $148939.41 “Total interest for 30 years”, a $448,940.40 “Total cost for 30 years”, etc. The user views a dynamically rendered interactive graphical model 501 based on the mortgage information entered and one or more financial components of expenditure determined by the asset management application 203 of the user's mortgage over the configurable term of the mortgage on the GUI 203i. The interactive graphical model 501 displays one or more financial components of expenditure, for example, amortization, equity, total spent, etc. The user can move the interactable interface elements 203j positioned on the dynamically rendered interactive graphical model 501 across the configurable duration of time and view how the values for amortization, equity, total spent, etc., change at any given point in time. The user can select a feature on the GUI 203i to understand the effects of selling their property asset, view the estimate amount that he/she can get from a sale, the estimate real estate broker fee, for example, by entering the state in which the property asset is for sale, and view the closing costs and how much a user would earn or lose from the sale.

When the user enters the mortgage information for an adjustable rate mortgage, for example a 5/1 ARM, a 7/1 ARM, as exemplarily illustrated in FIG. 10A, then the user can view a dynamically rendered interactive graphical model 501 of the adjustable rate mortgage over a configurable duration of time on the GUI 203i. As used herein, the term “5/1 ARM” refers to a type of adjustable rate mortgage or ARM, also referred to as “hybrid” mortgage, where the interest rate remains fixed for the first 5 years and then turns into an ARM that adjusts annually or once per year. Also, as used herein, the term “7/1 ARM” refers to a type of adjustable rate mortgage or ARM, also referred to as “hybrid” mortgage, where the interest rate remains fixed for the first 7 years and then turns into an ARM that adjusts annually or once per year. The adjustable rate mortgage interactive graphical model 1001 or 1003 exemplarily illustrated in FIGS. 10B-10C has a toggle that can toggle between what would happen if the index to which the ARM was tied remained stable or increased to the maximum terms of the loan, providing a best case scenario and a worst case scenario, as exemplarily illustrated in FIGS. 10B-10C. The user can see both the stable and maximum rate interactive graphical models 1003 and 1001 over time with an outline of the other interactive graphical model 1003 or 1001 to which the user can toggle to. The user slides an interactable interface element, for example, slider elements such as a slider wheel icon 503, a slider window 502, etc., across time to see how the determined financial components of expenditure, for example, interest rate, equity, principal, and interest value, etc., change over time for any given point in time for both stable and maximum rates.

The user can save the mortgage information, a mortgage scenario, a mortgage quote, or a comparison scenario in an account in the database 204a exemplarily illustrated in FIG. 2, and/or send the saved information to other users, financial entities etc., over the network 202, via an email, via the asset management application 203, etc. A recipient user can receive the mortgage information, the mortgage scenario, the mortgage quote, or the comparison scenario via a link or the asset management application 203, open the mortgage scenario, view the mortgage information, and save the mortgage information as exemplarily illustrated in FIGS. 8-9. The user can retrieve the saved mortgage scenario, the mortgage quote, or the comparison scenario at a later date, select them, and open them in a web page. The user can select more than one scenario or quote, select compare, and then open the scenario or the quote as a comparison scenario.

The user enters current mortgage information, for example, an original loan amount, a date of the loan, a type of mortgage, a term of the mortgage, an interest rate, a current home value, etc., on the GUI 203i. The asset management application 203 determines the remaining loan amount and displays the determined remaining loan amount on the GUI 203i. The user can enter terms of a refinancing, for example, closing costs, an interest rate, etc., on the GUI 203i. The asset management application 203 displays which one of the monthly payments and the total interest amounts, etc., is more to enable the user to make a decision, and displays an interactive graphical model 1103 or 1104 as exemplarily illustrated in FIGS. 11E-11F, showing both the current mortgage over time and the refinanced mortgage over time. The user can toggle back and forth between the interactive graphical model 1103 rendered for the current mortgage and interactive graphical model 1104 rendered for the refinanced mortgage. Elements of both the current mortgage and the refinanced mortgage appear on the GUI 203i at all times superimposed on each other, with the one which the user selects for viewing in the foreground, as exemplarily illustrated in FIGS. 11E-11F. Using the interactable interface elements, for example, the slider elements such as a slider wheel icon 503, a slider window 502, etc., the user can slide across the interactive graphical model 1103 or 1104 over a configurable duration of time and view one or more financial components of expenditure, for example, a principal amount, an interest amount, an equity amount, a total spent and how much the user can save at any point in the configurable duration of time.

The user can enter the inputs associated with an asset for one or more mortgage quotes, for example, a type of mortgage, an interest rate, lender fees or non-lender fees, etc., on the GUI 203i. The asset management application 203 compares the quotes, for example, by determining one or more financial components of expenditure, for example, an interest, difference in monthly payment, effect of points, etc. The asset management application 203 displays the dynamically rendered interactive graphical model 1103 or 1104 along with the interactable interface elements 203j positioned on the dynamically rendered interactive graphical model 1103 or 1104 to provide an interactive graph for a user to slide to a point where break-even is for points. The GUI 203i displays costs of each loan in relation to the other and additional details, for example, monthly savings, interest savings, etc., as exemplarily illustrated in FIG. 11H.

The asset management application 203 can be used by financial entities, for example, a mortgage professional, a broker, a financial advisor, etc. The users from financial entities can send the mortgage scenarios, mortgage quotes, or comparison scenarios to their customer users, for example, over the network 202, via email, or the asset management application 203. The customer users can open the received mortgage scenarios, mortgage quotes, or comparison scenarios, save them, compare them, or send to other users, financial entities, etc., over the network 202. The users can configure alerts to be received from one or more of the financial entities, for example, based on events using the asset management application 203. The customer users can receive alerts about their saved interactive graphical models 1103 and 1104, for example, if users have a current mortgage, they can receive an alert about when interest rates are low enough to refinance, an alert about a mortgage professional from whom the user has been receiving advice, etc. The financial entities can configure alerts to be received from the users using the asset management application 203. For example, a mortgage professional can receive an alert from a user for closing a meeting through the asset management application 203. The financial information and the asset information can also be communicated external to the asset management application 203, for example, another company, etc., and can be distributed in the same way to the users of the asset management application 203. The user can access the asset management application 203 over the network 202, via web, mobile, downloadable software application versions of the asset management application 203, etc.

Consider an example where the asset management application 203 is utilized by a user who is applying for or has taken an educational loan also referred to as a student loan. The user accesses the asset management application 203 via the network 202, views the home page on the GUI 203i, and registers for the asset management application 203 by entering an email id and a password. After activating the user account and logging into the asset management application 203, the user enters inputs associated with the asset, for example, academic details including the university in which the user has secured an admission, the term of study, the living costs and tuition costs, etc., a selection of a fixed rate educational loan or an adjustable rate educational loan, an educational loan start date, an educational loan end date, a down payment, a term of the fixed rate educational loan or the adjustable rate educational loan, an interest rate for the fixed rate educational loan or the adjustable rate educational loan, prospective financial parameters, etc. The user populates educational loan information fields, for example, a $value for education costs, a % value for % Down payment, a % value for Interest rate, a value for Type of educational loan, $value for education tax, etc., on the GUI 203i.

The asset management application 203 determines one or more financial components of expenditure based on the inputs associated with the asset entered by the user, for example, an amount of educational loan required, a monthly educational loan payment, a payment over the configurable duration of time, an amount of an interest rate deduction for an educational loan, an amount of tax deduction, education cess or tax benefits, an amount of equity available to the user at a point in the configurable duration of time, an amount of the equity spent by the user at a point in the configurable duration of time, a break-even point, an amount of income needed at a configurable stage in the configurable duration of time to repay the educational loan, educational loans available in different geographical locations, time of refinancing of the educational loan, etc. The user views the determined financial components of expenditure, for example, a monthly educational loan payment, an educational loan interest, monthly expenses, total interest for the tenure of the educational loan, total cost for the tenure of the educational loan, etc.

The user views a dynamically rendered interactive graphical model based on the inputs associated with the asset entered and one or more financial components of expenditure determined by the asset management application 203 of the user's educational loan over the configurable term of the loan on the GUI 203i. The user can move the interactable interface elements 203j positioned on the dynamically rendered interactive graphical model across the configurable duration of time and view how the values for amortization, total spent, etc., change at any given point in time. When the user enters inputs associated with the asset for an adjustable rate educational loan on the GUI 203i, the user can view a dynamically rendered interactive graphical model of the adjustable rate educational loan over the configurable duration of time on the GUI 203i. The adjustable rate educational loan interactive graphical model has a toggle functionality that can toggle between what would happen if the index the adjustable rate educational loan was tied to remains stable or increases to the maximum terms of the educational loan, providing a best case scenario and a worst case scenario. The user can view both the stable and maximum rate interactive graphical models over time with an outline of the other interactive graphical model to which the user can toggle. The user slides an interactable interface element, for example, the slider elements such as a slider wheel icon 503, a slider window 502, etc., across time to view how the determined financial components of expenditure, for example, interest rate, principal, and interest value, etc., change over time for any given point in time for both stable and maximum rate.

The user can save the educational loan information, an educational loan scenario, an educational loan quote, or a comparison scenario in an account in the database 204a and/or send the educational loan scenario to other users, financial entities etc., over the network 202, via an email, via the asset management application 203, etc. A recipient user can receive the educational loan scenario, the educational loan quote, or the comparison scenario via a link or the asset management application 203, open the link, view the educational loan information, and save the educational loan information. The user can retrieve the saved educational loan scenario, the educational loan quote, or the comparison scenario at a later date, select the educational loan information, and open educational loan information in a web page on the GUI 203i. The user can select more than one scenario or quote, select compare, and then open the scenario or the quote as a comparison scenario.

The user enters current educational information, for example, an original educational loan amount, a date of the educational loan, a type of the educational loan, a term of the educational loan, an interest rate, etc., on the GUI 203i. The asset management application 203 determines the remaining educational loan amount and the displays the determined remaining educational loan amount on the GUI 203i. The user can enter terms of a refinancing, for example, closing costs, an interest rate, etc., on the GUI 203i. The asset management application 203 displays which one of the monthly payments and the total interest amounts, etc., is more to enable the user to make a decision, and displays an interactive graphical model showing both the current educational loan over the configurable duration of time and the refinanced educational loan over the configurable duration of time. The user can toggle back and forth between the interactive graphical model rendered for the current educational loan and the interactive graphical model rendered for the refinanced educational loan. Elements of both the current educational loan and the refinanced educational loan appear on the GUI 203i at all times superimposed on each other, with the one which the user selects for viewing in the foreground. Using the interactable interface elements, for example, the slider elements such as a slider wheel icon 503, a slider window 502, etc., the user can slide across the interactive graphical model over the configurable duration of time and view one or more financial components of expenditure, for example, a principal amount, an interest amount, a total spent and how much the user can save at any point in the configurable duration of time.

The user can enter the inputs for one or more educational loan quotes, for example, a type of educational loan, an interest rate, lender/non-lender fees, etc., on the GUI 203i. The asset management application 203 compares the quotes, for example, by determining one or more financial components of expenditure, for example, an interest, difference in monthly payment, effect of points, etc. The asset management application 203 displays the dynamically rendered interactive graphical model along with the interactable interface elements 203j positioned on the dynamically rendered interactive graphical model to provide an interactive graph for a user to slide to a point where break-even is for points. The GUI 203i displays costs of each loan in relation to the other and additional details, for example, monthly savings, interest savings, etc.

The asset management application 203 can be used by financial entities, for example, an educational loan professional, a broker, a financial advisor, etc. The users from financial entities can send the educational loan scenarios, the educational loan quotes, or the comparison scenarios to their customer users, for example, over the network 202, via email, or the asset management application 203. The customer users can open the received educational loan scenarios, educational loan quotes, or comparison scenarios, save them, compare them, or send to other users, financial entities etc., over the network 202. The users can configure alerts to be received from one or more of the financial entities, for example, based on events using the asset management application 203. The customer users can receive alerts about their saved interactive graphical models, for example, if users have a current educational loan, they can receive an alert about when interest rates are low enough to refinance, an alert about an educational loan professional from whom the user has been receiving advice, etc. The financial entities can configure alerts to be received from the users using the asset management application 203. For example, an educational loan professional can receive an alert from a user for closing a meeting through the asset management application 203.

It will be readily apparent that the various methods, algorithms, and computer programs disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a similar device. Non-transitory computer readable media comprise all computer readable media, for example, non-volatile media, volatile media, and transmission media, except for a transitory, propagating signal. Non-volatile media comprise, for example, optical discs or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to a processor, etc. Common forms of computer readable media comprise, for example, a floppy disk, a flexible disk, a hard disk, magnetic tape, a laser disc, a Blu-ray Disc®, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

The computer programs that implement the methods and algorithms disclosed herein may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of programming languages that can be used comprise C, C++, C#, Java®, Fortran, Ruby, Pascal, Perl®, Python®, Visual Basic®, hypertext preprocessor (PHP), JavaScript®, MySQL®, etc. Other object-oriented, functional, scripting, and/or logical programming languages may also be used. The computer program codes or software programs may be stored on or in one or more mediums as object code. Various aspects of the method and system disclosed herein may be implemented in a non-programmed environment comprising documents created, for example, in a hypertext markup language (HTML), an extensible markup language (XML), or other format that render aspects of the GUI or perform other functions, when viewed in a visual area or a window of a browser program. Various aspects of the method and system disclosed herein may be implemented as programmed elements, or non-programmed elements, or any suitable combination thereof. The computer program product disclosed herein comprises computer executable instructions embodied in a non-transitory computer readable storage medium, wherein the computer program product comprises one or more computer program codes for implementing the processes of various embodiments.

Where databases are described such as the database 204a, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment comprising one or more computers that are in communication with one or more devices via a network. The computers may communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices may comprise processors, for example, the Intel® processors, Advanced Micro Devices (AMD®) processors, UltraSPARC® processors, hp® processors, International Business Machines (IBM®) processors, RISC based computer processors of ARM Holdings, Motorola® processors, etc., that are adapted to communicate with the computers. In an embodiment, each of the computers is equipped with a network communication device, for example, a network interface card, a modem, or other network connection device suitable for connecting to a network. Each of the computers and the devices executes an operating system, for example, the Linux® operating system, the Unix® operating system, any version of the Microsoft® Windows® operating system, the Mac OS of Apple Inc., the IBM® OS/2, the Android® OS, the Blackberry® OS, the Solaris operating system developed by Sun Microsystems, Inc., or any other operating system. Handheld devices execute operating systems, for example, the Android operating system, the Windows Phone™ operating system of Microsoft Corporation, the BlackBerry® operating system of Research in Motion Limited, the iOS operating system of Apple Inc., the Symbian® operating system of Symbian Foundation Limited, etc. While the operating system may differ depending on the type of computer, the operating system will continue to provide the appropriate communications protocols to establish communication links with the network. Any number and type of machines may be in communication with the computers.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

We claim:

1. A computer implemented method for monitoring and managing assets of a user, comprising:
providing an asset management application executable by at least one processor configured to monitor and manage said assets of said user, wherein said asset management application is accessible by a user device via a graphical user interface provided by said asset management application;
providing a plurality of interactable interface elements on said graphical user interface by said asset management application, said interactable interface elements configured to enable configuration and access of asset information and computations on said graphical user interface via said user device;
receiving inputs associated with an asset from said user device by said asset management application via said graphical user interface, wherein said inputs comprise provisions of one of an adjustable rate loan on said asset and a fixed rate loan on said asset;
determining one or more of a plurality of financial components of expenditure over a configurable duration of time by said asset management application based on one or more of: one or more of said received inputs associated with said asset and a geographical location of one of said asset and said user; and
dynamically rendering one or more interactive graphical models of said determined one or more of said financial components of said expenditure by said asset management application, wherein said dynamically rendered one or more interactive graphical models of said determined one or more of said financial components of said expenditure are configurably accessible and modifiable on said graphical user interface via said user device using one or more of said interactable interface elements.

2. The computer implemented method of claim 1, further comprising:
receiving at least one input on said dynamically rendered one or more interactive graphical models of said determined one or more of said financial components of said expenditure from said user device by said asset management application via said graphical user interface; and
dynamically updating said determined one or more of said financial components of said expenditure based on said received at least one input by said asset management application.

3. The computer implemented method of claim 1, further comprising:
tracking changes made to said inputs associated with said asset on said graphical user interface via said user device by said asset management application over said configurable duration of time;
redetermining said one or more of said financial components of said expenditure by said asset management application based on said tracked changes; and
dynamically updating said tracked changes and said redetermined one or more of said financial components of said expenditure to said dynamically rendered one or more interactive graphical models by said asset management application.

4. The computer implemented method of claim 1, wherein said inputs associated with said asset comprise a selection of one of said fixed rate loan and said adjustable rate loan, a loan start date, a loan end date, a price of said asset, a down payment, a term of said one of said fixed rate loan and said adjustable rate loan, an interest rate for said one of said fixed rate loan and said adjustable rate loan, an amount of asset tax, a tax bracket, state of said asset, city of said asset, county of said asset, fees of said asset, one of condominium fees of a property asset and housing cooperative fees of said property asset, tax information, and prospective financial parameters.

5. The computer implemented method of claim 1, wherein said financial components of said expenditure comprise an amount of loan required, a monthly loan payment, a payment over said configurable duration of time, an amount of asset tax, an amount of an interest rate deduction for a loan, an amount of tax deduction from tax deductable housing cooperative fees, an amount of equity available to said user at a point in said configurable duration of time, an amount of said equity spent by said user at a point in said configurable duration of time, a break-even point, an amount of income needed at a configurable stage in said configurable duration of time to enable said user to repay said loan within a term of said loan, a fixed rate loan payment over said term of said loan, an adjustable rate loan payment over said term of said loan, loans available in different geographical locations, and time of refinancing of said loan.

6. The computer implemented method of claim 1, further comprising:
receiving loan quotes received by said user from one or more external sources, by said asset management application via said graphical user interface;
receiving selections of one or more of said received loan quotes from said user device by said asset management application via said graphical user interface;
determining one or more of said financial components of said expenditure for said one or more of said received loan quotes by said asset management application based on said received selections; and
dynamically rendering an interactive graphical model of each of said determined one or more of said financial components of said expenditure for each of said one or more of said received loan quotes by said asset management application for performing a comparative analysis of said determined one or more of said financial components of said expenditure for said one or more of said received loan quotes.

7. The computer implemented method of claim 1, further comprising performing a comparative analysis of associated said determined one or more of said financial components of said expenditure by said asset management application over said configurable duration of time using said dynamically rendered one or more interactive graphical models of said associated determined one or more of said financial components of said expenditure and dynamically rendering a comparative analytical report based on said comparative analysis by said asset management application.

8. The computer implemented method of claim 1, further comprising determining an estimate amount for selling said asset at a configurable point in time selected via said user device using said one or more of said interactable interface elements positioned on said dynamically rendered one or more interactive graphical models of said determined one or more of said financial components of said expenditure by said asset management application.

9. The computer implemented method of claim 1, further comprising categorizing said determined one or more of said financial components of said expenditure by said asset management application based on said geographical location.

10. The computer implemented method of claim 1, wherein said interactable interface elements positioned on associated said dynamically rendered one or more interactive graphical models of said determined one or more of said financial components of said expenditure are configured to simultaneously displace over said configurable duration of time on said graphical user interface for performing a comparative analysis of said determined one or more of said financial components of said expenditure.

11. The computer implemented method of claim 1, further comprising toggling display of said dynamically rendered one or more interactive graphical models of said determined one or more of said financial components of said expenditure on said graphical user interface by said asset management application based on a selectable index associated with each of said determined one or more of said financial components of said expenditure.

12. The computer implemented method of claim 1, further comprising storing user information, advisory information, said received inputs associated with said asset, said determined one or more of said financial components of said expenditure, and said dynamically rendered one or more interactive graphical models of said determined one or more of said financial components of said expenditure by said asset management application in a database, and facilitating retrieval of said user information, said advisory information, said received inputs associated with said asset, said determined one or more of said financial components of said expenditure, and said dynamically rendered one or more interactive graphical models of said determined one or more of said financial components of said expenditure by said asset management application from said database.

13. The computer implemented method of claim 1, further comprising facilitating communication of one or more financial scenarios between said user and one or more of: one or more financial entities and other users by said asset management application via a network.

14. The computer implemented method of claim 1, further comprising transmitting one or more notifications on said asset information and supplementary financial information to said user device by said asset management application via one or more of said graphical user interface and a network.

15. The computer implemented method of claim 1, further comprising generating alerts by said asset management application based on events associated with said received inputs associated with said asset, said determined one or more of said financial components of said expenditure, and said dynamically rendered one or more interactive graphical models of said determined one or more of said financial components of said expenditure stored in said database, wherein said asset management application is further configured to transmit said generated alerts to said user device via one or more of said graphical user interface and a network.

16. A computer implemented method for monitoring and managing assets of a user, comprising:
providing an asset management application executable by at least one processor configured to monitor and manage said assets of said user, wherein said asset management application is accessible by a user device via a graphical user interface provided by said asset management application;
providing a plurality of interactable interface elements on said graphical user interface by said asset management application, said interactable interface elements configured to enable configuration and access of asset information and computations on said graphical user interface via said user device;
receiving inputs associated with an asset from said user device by said asset management application via said graphical user interface;
determining one or more financial outcomes of a sale of said asset at a configurable point in time by said asset management application based on one or more of: one or more of said received inputs associated with said asset and a geographical location of said asset;
dynamically rendering one or more interactive graphical models of said determined one or more financial outcomes of said sale of said asset by said asset management application, wherein said dynamically rendered one or more interactive graphical models of said determined one or more financial outcomes of said sale of said asset are configurably accessible and modifiable on said graphical user interface via said user device using one or more of said interactable interface elements;
receiving at least one input on said dynamically rendered one or more interactive graphical models of said determined one or more financial outcomes of said sale of said asset from said user device by said asset management application via said graphical user interface; and
dynamically updating said determined one or more financial outcomes of said sale of said asset based on said received at least one input by said asset management application.

17. A computer implemented method for monitoring and managing assets of a user, comprising:
providing an asset management application executable by at least one processor configured to monitor and manage said assets of said user, wherein said asset management application is accessible by a user device via a graphical user interface provided by said asset management application;
providing a plurality of interactable interface elements on said graphical user interface by said asset management application, said interactable interface elements configured to enable configuration and access of asset information and computations on said graphical user interface via said user device;
receiving inputs associated with an asset from said user device by said asset management application via said graphical user interface;
determining one or more of a plurality of financial components of expenditure over a configurable duration of time by said asset management application based on one or more of: one or more of said received inputs associated with said asset and a geographical location of one of said asset and said user;
dynamically rendering one or more interactive graphical models of said determined one or more of said financial components of said expenditure by said asset management application, wherein said dynamically rendered one or more interactive graphical models of said determined one or more of said financial components of said expenditure are configurably accessible and modifiable on said graphical user interface via said user device using one or more of said interactable interface elements; and
facilitating communication of said dynamically rendered one or more interactive graphical models of said determined one or more of said financial components of said expenditure and updates thereof between said user and one or more of: one or more financial entities and other users by said asset management application via a network.

18. The computer implemented method of claim 17, wherein said inputs associated with said asset comprise a selection of one of a fixed rate loan and an adjustable rate loan, a loan start date, a loan end date, a price of said asset, a down payment, a term of said one of said fixed rate loan and said adjustable rate loan, an interest rate for said one of said fixed rate loan and said adjustable rate loan, an amount of asset tax, a tax bracket, state of said asset, city of said asset, county of said asset, fees of said asset, one of condominium fees of a property asset and housing cooperative fees of said property asset, tax information, and prospective financial parameters.

19. The computer implemented method of claim 17, wherein said financial components of said expenditure comprise an amount of loan required, a monthly loan payment, a payment over said configurable duration of time, an amount of asset tax, an amount of an interest rate deduction for a loan, an amount of tax deduction from tax deductable housing cooperative fees, an amount of equity available to said user at a point in said configurable duration of time, an amount of said equity spent by said user at a point in said configurable duration of time, a break-even point, an amount of income needed at a configurable stage in said configurable duration of time to enable said user to repay said loan within a term of said loan, a fixed rate loan payment over said term of said loan, an adjustable rate loan payment over said term of said loan, loans available in different geographical locations, and time of refinancing of said loan.

20. A computer implemented system for monitoring and managing assets of a user, comprising:
at least one processor;
a non-transitory computer readable storage medium communicatively coupled to said at least one processor, said non-transitory computer readable storage medium configured to store an asset management application, said at least one processor configured to execute said asset management application; and
said asset management application comprising:
a graphical user interface comprising a plurality of interactable interface elements configured to enable configuration and access of asset information and computations via a user device;
a data reception module configured to receive inputs associated with an asset from said user device via said graphical user interface, wherein said inputs comprise provisions of one of an adjustable rate loan on said asset and a fixed rate loan on said asset;
a financial component determination module configured to determine one or more of a plurality of financial components of expenditure over a configurable duration of time based on one or more of: one or more of said received inputs associated with said asset and a geographical location of one of said asset and said user; and
an interactive graphical model rendering module configured to dynamically render one or more interactive graphical models of said determined one or more of said financial components of said expenditure, wherein said dynamically rendered one or more interactive graphical models of said determined one or more of said financial components of said expenditure are configurably accessible and modifiable on said graphical user interface via said user device using one or more of said interactable interface elements.

21. The computer implemented system of claim 20, wherein said data reception module is further configured to receive at least one input on said dynamically rendered one or more interactive graphical models of said determined one or more of said financial components of said expenditure from said user device via said graphical user interface, and wherein said financial component determination module is further configured to dynamically update said determined one or more of said financial components of said expenditure based on said received at least one input.

22. The computer implemented system of claim 20, wherein said asset management application further comprises:
a tracking module configured to track changes made to said inputs associated with said asset on said graphical user interface via said user device over said configurable duration of time;
said financial component determination module further configured to redetermine said one or more of said financial components of said expenditure based on said tracked changes; and
said interactive graphical model rendering module further configured to dynamically update said tracked changes and said redetermined one or more of said financial components of said expenditure to said dynamically rendered one or more interactive graphical models.

23. The computer implemented system of claim 20, wherein said inputs associated with said asset comprise a selection of one of said fixed rate loan and said adjustable rate loan, a loan start date, a loan end date, a price of said asset, a down payment, a term of said one of said fixed rate loan and said adjustable rate loan, an interest rate for said one of said fixed rate loan and said adjustable rate loan, an amount of asset tax, a tax bracket, state of said asset, city of said asset, county of said asset, fees of said asset, one of condominium fees of a property asset and housing cooperative fees of said property asset, tax information, and prospective financial parameters.

24. The computer implemented system of claim 20, wherein said financial components of said expenditure comprise an amount of loan required, a monthly loan payment, a payment over said configurable duration of time, an amount of asset tax, an amount of an interest rate deduction for a loan, an amount of tax deduction from tax deductable housing cooperative fees, an amount of equity available to said user at a point in said configurable duration of time, an amount of said equity spent by said user at a point in said configurable duration of time, a break-even point, an amount of income needed at a configurable stage in said configurable duration of time to enable said user to repay said loan within a term of said loan, a fixed rate loan payment over said term of said loan, an adjustable rate loan payment over said term of said loan, loans available in different geographical locations, and time of refinancing of said loan.

25. The computer implemented system of claim 20, wherein said data reception module is further configured to perform:
receiving loan quotes received by said user from one or more external sources via said graphical user interface; and
receiving selections of one or more of said received loan quotes from said user device via said graphical user interface, wherein said financial component determination module is further configured to determine one or more of said financial components of said expenditure for said one or more of said received loan quotes based on said received selections, and wherein said interactive graphical model rendering module is further configured to dynamically render an interactive graphical model of each of said determined one or more of said financial components of said expenditure for each of said one or more of said received loan quotes for performing a comparative analysis of said determined one or more of said financial components of said expenditure for said one or more of said received loan quotes.

26. The computer implemented system of claim 20, wherein said asset management application further comprises a comparison module configured to perform a comparative analysis of associated said determined one or more of said financial components of said expenditure over said configurable duration of time using said dynamically rendered one or more interactive graphical models of said associated determined one or more of said financial components of said expenditure and to dynamically render a comparative analytical report based on said comparative analysis.

27. The computer implemented system of claim 20, wherein said financial component determination module is further configured to determine an estimate amount for selling said asset at a configurable point in time selected via said user device using said one or more of said interactable interface elements positioned on said dynamically rendered one or more interactive graphical models of said determined one or more of said financial components of said expenditure.

28. The computer implemented system of claim 20, wherein said financial component determination module is further configured to determine one or more financial outcomes of a sale of said asset at a configurable point in time based on one or more of: one or more of said received inputs associated with said asset and a geographical location of said asset, and wherein said interactive graphical model rendering module is further configured to dynamically render one or more interactive graphical models of said determined one or more financial outcomes of said sale of said asset, and wherein said dynamically rendered one or more interactive graphical models of said determined one or more financial outcomes of said sale of said asset are configurably accessible and modifiable on said graphical user interface via said user device using one or more of said interactable interface elements.

29. The computer implemented system of claim 28, wherein said data reception module is further configured to receive at least one input on said dynamically rendered one or more interactive graphical models of said determined one or more financial outcomes of said sale of said asset from said user device via said graphical user interface, and wherein said financial component determination module is further configured to dynamically update said determined one or more financial outcomes of said sale of said asset based on said received at least one input.

30. The computer implemented system of claim 20, wherein said asset management application further comprises a categorization engine configured to categorize said determined one or more of said financial components of said expenditure based on said geographical location.

31. The computer implemented system of claim 20, wherein said interactable interface elements positioned on associated said dynamically rendered one or more interactive graphical models of said determined one or more of said financial components of said expenditure are configured to simultaneously displace over said configurable duration of time on said graphical user interface for performing a comparative analysis of said determined one or more of said financial components of said expenditure.

32. The computer implemented system of claim 20, wherein said interactive graphical model rendering module is further configured to toggle display of said dynamically rendered one or more interactive graphical models of said determined one or more of said financial components of said expenditure on said graphical user interface based on a selectable index associated with each of said determined one or more of said financial components of said expenditure.

33. The computer implemented system of claim 20, further comprising a database in communication with said asset management application, wherein said database is configured to store user information, advisory information, said received inputs associated with said asset, said determined one or more of said financial components of said expenditure, and said dynamically rendered one or more interactive graphical models of said determined one or more of said financial components of said expenditure, and to facilitate retrieval of said user information, said advisory information, said received inputs associated with said asset, said determined one or more of said financial components of said expenditure, and said dynamically rendered one or more interactive graphical models of said determined one or more of said financial components of said expenditure.

34. The computer implemented system of claim 20, wherein said asset management application further comprises a communication module configured to facilitate communication of one or more financial scenarios between said user and one or more of: one or more financial entities and other users via a network.

35. The computer implemented system of claim 34, wherein said communication module is further configured to facilitate communication of said dynamically rendered one or more interactive graphical models of said determined one or more of said financial components of said expenditure and updates thereof between said user and said one or more of: said one or more financial entities and said other users via said network.

36. The computer implemented system of claim 20, wherein said asset management application further comprises a communication module configured to transmit one or more notifications on said asset information and supplementary financial information to said user device via one or more of said graphical user interface and a network.

37. The computer implemented system of claim 20, wherein said asset management application further comprises an alerting module configured to generate alerts based on events associated with said received inputs associated with said asset, said determined one or more of said financial components of said expenditure, and said dynamically rendered one or more interactive graphical models of said determined one or more of said financial components of said expenditure stored in a database, wherein said alerting module is further configured to transmit said generated alerts to said user device via one or more of said graphical user interface and a network.

38. The computer implemented system of claim 20, wherein said asset management application is one of implemented on a web based platform and configured as a software application downloadable on said user device.

39. A computer program product comprising a non-transitory computer readable storage medium, said non-transitory computer readable storage medium storing computer program codes that comprise instructions executable by at least one processor, said computer program codes comprising:
a first computer program code for receiving inputs associated with an asset from a user device via a graphical user interface, wherein said inputs comprise provisions of one of an adjustable rate loan on said asset and a fixed rate loan on said asset;
a second computer program code for determining one or more of a plurality of financial components of expenditure over a configurable duration of time based on one or more of: one or more of said received inputs associated with said asset and a geographical location of one of said asset and a user; and
a third computer program code for dynamically rendering one or more interactive graphical models of said determined one or more of said financial components of said expenditure, wherein said dynamically rendered one or more interactive graphical models of said determined one or more of said financial components of said expenditure are configurably accessible and modifiable on said graphical user interface via said user device using one or more of a plurality of interactable interface elements provided on said graphical user interface.

40. The computer program product of claim 39, wherein said inputs associated with said asset comprises a selection of one of said fixed rate loan and said adjustable rate loan, a loan start date, a loan end date, a price of said asset, a down payment, a term of said one of said fixed rate loan and said adjustable rate loan, an interest rate for said one of said fixed rate loan and said adjustable rate loan, an amount of asset tax, a tax bracket, state of said asset, city of said asset, county of said asset, fees of said asset, one of condominium fees of a property asset and housing cooperative fees of said property asset, tax information, and prospective financial parameters.

41. The computer program product of claim 39, wherein said financial components of said expenditure comprise an amount of loan required, a monthly loan payment, a payment over said configurable duration of time, an amount of asset tax, an amount of an interest rate deduction for a loan, an amount of tax deduction from tax deductable housing cooperative fees, an amount of equity available to said user at a point in said configurable duration of time, an amount of said equity spent by said user at a point in said configurable duration of time, a break-even point, an amount of income needed at a configurable stage in said configurable duration of time to enable said user to repay said loan within said term of said loan, a fixed rate loan payment over said term of said loan, an adjustable rate loan payment over said term of said loan, loans available in different geographical locations, and time of refinancing of said loan.

42. The computer program product of claim 39, further comprising:
a fourth computer program code for determining one or more financial outcomes of a sale of said asset at a configurable point in time based on one or more of: one or more of said received inputs associated with said asset and said geographical location of said asset;
a fifth computer program code for dynamically rendering one or more interactive graphical models of said determined one or more financial outcomes of said sale of said asset;
a sixth computer program code for receiving at least one input on said dynamically rendered one or more interactive graphical models of said determined one or more financial outcomes of said sale of said asset from said user device via said graphical user interface; and
a seventh computer program code for dynamically updating said determined one or more financial outcomes of said sale of said asset based on said received at least one input.

43. The computer program product of claim 39, further comprising an eighth computer program code for facilitating communication of said dynamically rendered one or more interactive graphical models of said determined one or more of said financial components of said expenditure and updates thereof between said user and one or more of: one or more financial entities and other users via a network.
